(19) United States
(12) Patent Application Publication
(10) Pub. No.: US 2009/0297752 A1
(43) Pub. Date: Dec. 3, 2009

(54) POLYESTER RESIN, POLYESTER RESIN COMPOSITION THEREFROM AND USE THEREOF

(75) Inventors: Keiichiro Togawa, Ohtsu-shi (JP); Yoshinao Matsui, Osaka-shi (JP); Kosuke Uotani, Ohtsu-shi (JP); Atsushi Hara, Tsuruga-shi (JP); Hiroyuki Mitsunaga, Tsuruga-shi (JP); Takahiro Nakajima, Ohtsu-shi (JP); Naoki Watanabe, Ohtsu-shi (JP); Toshio Owari, Iwakuni-shi (JP); Yoshitaka Eto, Ohtsu-shi (JP)

Correspondence Address: KENYON & KENYON LLP, 1500 K STREET N.W., SUITE 700, WASHINGTON, DC, 20005, US

(73) Assignee: TOYO BOSEKI KABUSHIKI KAISHA, Osaka (JP)

(21) Appl. No.: 12/063,387

(22) PCT Filed: Aug. 9, 2005
(86) PCT No.: PCT/JP2005/014547

§ 371 Date: Jul. 16, 2009

(51) Int. Cl. B32B 1/00; C08G 63/00; B29C 45/00; B29C 43/02; B29C 47/00

(52) U.S. Cl. 428/36.92; 528/286; 528/285; 528/283; 264/328.1; 264/319; 264/176.1

(57) ABSTRACT

A polyester resin that can be beneficially employed as one finding application in deactivation of polycondensation catalysts for polyester production and suppression of forming of acetaldehyde and other aldehydes and cyclic ester oligomers at molding stage. In particular, there is provided a polyester resin composed mainly of an aromatic dicarboxylic acid component and a glycol component wherein a phosphorus compound is incorporated through copolymerization or blending in an amount of 100 to 10,000 ppm in terms of phosphorus element, characterized in that the contents of Zn element, Fe element, Ni element and Cr element are not greater than specified values.

### TECHNICAL FIELD

The present invention relates to a polyester resin usable for deactivating a polycondensation catalyst used at polyester production and usable for suppressing production of aldehydes such as acetaldehyde and cyclic ester oligomers at molding stage, a polyester resin composition containing the polyester resin, and its use.

### BACKGROUND ART

Polyesters containing ethylene terephthalate as a main repeating unit (hereinafter, sometimes referred to as PET or PET resin) have been employed as materials for containers of carbonated beverages, juice, mineral water or the like owing to their characteristics such as excellent transparency, mechanical strength, heat resistance, and gas barrier property, and their spread is remarkable and mass production in continuous polymerization manner has been carried out in plants. In their uses, beverages sterilized at a high temperature are thermally packed in bottles made of polyesters or beverages are sterilized at a high temperature after packing and in the case of bottles made of common polyesters, shrinkage and deformation are caused at thermal packing treatment stage and it is a problem. As a method for improving the heat resistance of the bottles made of polyesters, methods of heightening crystallinity by heat treatment of mouth parts of the bottles and thermally fixing stretched bottles have been proposed. Particularly, if the crystallinity of the mouth parts is insufficient or the variation of the crystallinity is significant, the tight sealing property with caps is worsened to possibly cause content leakage.

In particular, in the case of beverages such as juice beverages, oolong tea and mineral water for which packing under heating is required, a method for crystallizing preformed or formed mouth parts of bottles by heat treatment are common (reference to Japanese Patent Application JP S55-79237 (A) and JP S58-110221 (A)). With respect to such a method, that is, a method for improving heat resistance by heat treatment of mouth parts and shoulder parts, the time and temperature for crystallization treatment greatly affect the productivity and PET which can be treated at a low temperature within a short time and has a high crystallization speed is preferable. On the other hand, with respect to trunk parts, it is required to keep transparent even if heat treatment is conducted at molding stage in order to avoid worsening of color tone of the contents in bottles, and thus contradictory characteristics are required for the mouth parts and trunk parts.

Further, to improve the heat resistance in the trunk parts of bottles, a heat treatment method by increasing the temperature of stretch blow molds to a high temperature has been employed (Japanese Patent Publication S59-6216(B)). However, if molding of a large number of bottles has been continued by using same molds, the bottles are whitened and deteriorated in the transparency along with long time operation and only bottles with little product value are produced. It is found that such a phenomenon is caused because fouling matter derived from PET adheres to the mold surface and accordingly stains the molds and the stains of the mold are transferred to the surfaces of bottles. Particularly, in recent years, along with tendency of making bottles compact, the molding speed is accelerated, shortening the melting period at injection molding stage, shortening the heating time for crystallization of mouth parts and staining of molds become big issues in terms of the productivity, and conventional PET cannot be satisfactory and solutions for the issues are thus desired.

Further, the polyesters contain acetaldehyde (hereinafter, sometimes referred to as AA for short) as a byproduct. In the case the aldehyde content in the polyesters is high, the acetaldehyde content in materials such as containers and other wrappings obtained by molding them is also so high to affect taste and smell of beverages packed in those containers. Recently, containers made of polyesters composed mainly of polyethylene terephthalate have been used as containers for low flavor beverages such as mineral water and oolong tea. In the case of such beverages, generally these beverages are thermally packed or sterilized by heating after packing and therefore, it becomes important more and more to lower the content of aldehydes in beverage containers. On the other hand, with respect to metal cans for beverages, for the purposes of process simplification, sanitary, and environmental problem prevention, methods for manufacturing cans from metal sheets whose inner faces are coated with polyester film containing ethylene terephthalate as a main repeating unit have been employed. In this case, the contents are heated and sterilized at a high temperature after packing, and it is understood that use of films with low acetaldehyde content is essential to improve the taste and smell of contents.

Because of these reasons, various countermeasures have been employed for lowering the acetaldehyde content and cyclic ester oligomer content in conventional polyesters. Example of these countermeasures that have been proposed include a method for decreasing oligomers and aldehydes by carrying out solid-phase polymerization of polyester prepolymers, which are obtained by melt polymerization, under reduced pressure or inert gas flow (Patent Document 1), a method for crystallization and solid-phase polymerization of polyester prepolymers after moisture adjustment to a water content of 2000 ppm or higher (Patent Document 2), a method for thermally treating polyester particles under reduced pressure or inert gas flow after treatment with hot water at 50 to 200° C. (Patent Document 3), a method for heat treatment at a temperature of melting point or lower in inert gas atmosphere (Patent Document 4), and a method for extraction and washing treatment with water or organic solvent before or after solid-phase polymerization (Patent Document 5). However, even in the case of molded articles using polyesters obtained by these methods, it cannot be said that oligomers and acetaldehydes are decreased to a satisfactory level and the problems are not solved.

As methods for further solving such problems are disclosed a method of deactivating catalysts by bringing polyethylene terephthalate into contact with water (Patent Document 6) and PET obtained by deactivating catalysts by water treatment (Patent Document 7).

However, it is understood that such a catalyst deactivation method by contact treatment with water is effective only for polyesters produced by using a germanium compound as a polycondensation catalyst but scarcely or not effective for polyesters produced by using an antimony compound, a titanium compound, or an aluminum compound as a catalyst. That is, a water contact treatment method for polyesters produced by using a polycondensation catalyst other than a germanium compound is impossible to suppress increase of the AA content or the content of cyclic ester oligomers at molding stage and there still remain the following problems; a problem that the characteristics of molded articles such as the taste and smell of contents are scarcely improved, a problem that nothing but only heat resistant molded articles with worsened transparency are obtained since staining of molds is not improved in the case of continuous and long time molding, and also a problem that since apparatus and drying apparatus are needed for the above-mentioned treatment, it costs for extra facility investment and treatment, and results in initial cost up and worsening of commercial profit.

Further, a method for deactivation of a polycondensation catalyst by kneading phosphorus compound-containing thermoplastic resin with PET is disclosed (Patent Document 8). However, in the case of producing phosphorus compound-containing thermoplastic resin using a widely employed polymerization can made of SUS 304, there is a problem that a metal element is eluted from the polymerization can to the phosphorus compound-containing thermoplastic resin and it has been made apparent that the eluted metal element becomes crystallization nucleating agent of PET or a thermal decomposition promoting agent or a discoloration promoting agent and accordingly not only decreases the transparency of molded articles obtained by mixing and using the resin with PET but also causes effects on taste preservation and color tone. As described, there is a problem that it is difficult to obtain molded articles excellent in transparency and taste preservation, and it has been desired to solve the problem.

Patent Document 1: JP S55-89330(A)

Patent Document 2: JP S59-219328(A)

Patent Document 3: JP S56-55426(A)

Patent Document 4: JP H2-298512(A)

Patent Document 5: JP S55-13715(A)

Patent Document 6: JP H3-47830(A)

Patent Document 7: JP H3-72524(A)

Patent Document 8: JP H10-251393(A)

### BRIEF DESCRIPTION OF THE DRAWINGS

FIG. 1: A top view of a stepped molded plate used in Examples.

FIG. 2: A side view of the stepped molded plate of FIG. 1.

### DISCLOSURE OF THE INVENTION

### Problems to be Solved by the Invention

The present invention aims to solve the problems of the above-mentioned conventional methods and provide a polyester resin usable for solving problems of forming of acetaldehyde and aldehydes and forming of cyclic ester oligomers at molding stage, and a polyester resin composition excellent in transparency and taste preservation, having proper crystallization speed, free from a problem of worsening transparency due to mold stains at continuous molding stage, and usable for efficiently producing hollow molded articles excellent in size stability on heating, and uses of a polyester molded articles excellent in the transparency, taste preservation and size stability on heating.

Inventors of the present invention have made investigations to accomplish the above-mentioned aim and consequently have completed the invention.

The present invention is as follows.

(1) A polyester resin mainly consisting of an aromatic dicarboxylic acid component and a glycol component and copolymerized or mixed with a phosphorus compound in an amount of 100 to 10000 ppm in terms of phosphorus element, wherein the contents of Zn element, Fe element, Ni element, and Cr element satisfy at least one of the following formulas (A) to (D);

Cr≦10 ppm (A),

Fe≦30 ppm (B),

Ni≦5 ppm (C), and

Zn≦5 ppm (D).

(2) A polyester resin mainly consisting of an aromatic dicarboxylic acid component and a glycol component and copolymerized or mixed with a phosphorus compound in an amount of 100 to 10000 ppm in terms of phosphorus element, wherein the contents of free aromatic dicarboxylic acid derived from the polyester is 10 ppm or lower, the content of free glycol is 1500 ppm or lower, the content of free aromatic dicarboxylic acid monoglycol ester is 50 ppm or lower, and the content of free aromatic dicarboxylic acid diglycol ester is 100 ppm or lower.
(3) The polyester resin as described in (1) or (2), wherein the content of aldehydes is 150 ppm or lower.
(4) The polyester resin as described in any one of (1) to (3), providing a molded article of a thickness of 4 mm with haze of 40% or lower by injection molding at 290° C.
(5) The polyester resin as described in any one of (1) to (4), wherein the phosphorus compound is at least one of compound selected from a group consisting of phosphoric acid-based compounds, phosphonic acid-based compounds, phosphinic acid-based compounds, phosphorous acid-based compounds, phosphonous acid-based compounds, phosphinous acid-based compounds.
(6) The polyester resin as described in any one of (1) to (5), wherein 85 to 100% by mole of the aromatic dicarboxylic acid component is terephthalic acid.
(7) The polyester resin as described in any one of (1) to (5), wherein 20 to 100% by mole of the aromatic dicarboxylic acid component is naphthalene dicarboxylic acid.
(8) The polyester resin as described in any one of claims 1 to 7, wherein the contents of copolymerized dialkylene glycol and trialkylene glycol are 10% by mole or lower and 2% by mole or lower, respectively, relative to the composing glycol component.
(9) The polyester resin as described in any one of (1) to (8), wherein the content of water is 500 to 10000 ppm.
(10) The polyester resin as described in any one of (1) to (9), wherein the polycondensation catalyst is at least one compound selected from a group consisting of antimony compounds and germanium compounds.
(11) A polyester resin composition containing, as main components, the polyester resin (1) as described in any one of (1) to (10) and a polyester resin (2) mainly consisting of an aromatic dicarboxylic acid component and a glycol component, wherein in the case the content of a cyclic ester oligomer of a molded article obtained by injection molding of the composition is defined as Aₜ ppm and the content of a cyclic ester oligomer of the polyester resin composition before the injection molding is defined as A₀ ppm, Aₜ−A₀ is less than 500 ppm.
(12) A polyester resin composition containing, as main components, the polyester resin (1) as described in any one of (1) to (10) and a polyester resin (2) mainly consisting of an aromatic dicarboxylic acid component and an ethylene glycol component, wherein in the case the content of a cyclic trimer of a molded article obtained by injection molding of the composition is defined as Aₜ ppm and the content of a cyclic trimer of the polyester resin composition before the injection molding is defined as A₀ ppm, Aₜ−A₀ is less than 500 ppm.
(13) A polyester resin composition containing, as main components, the polyester resin (1) as described in any one of (1) to (10) and a polyester resin (2) mainly consisting of an aromatic dicarboxylic acid component and an ethylene glycol component, wherein in the case the content of acetaldehyde of a molded article obtained by injection molding of the composition is defined as Bₜ ppm and the content of acetaldehyde of the polyester resin composition before the injection molding is defined as B₀ ppm, Bₜ−B₀ is 1 to 30 ppm.
(14) The polyester resin composition as described in any one of (11) to (13) containing the polyester resin (1) described in (10) and a polyester resin (2) containing a compound containing at least one element selected from a group consisting of Al element, Ti element, Mn element, Co element, Zn element, Sn element, and Pb element, and if necessary, an antimony compound and/or a germanium compound.
(15) The polyester resin composition as described in any one of (11) to (14), providing a molded article of a thickness of 5 mm with haze of 30% or lower by injection molding.
(16) A polyester resin composition containing, as main components, a polyester resin (1) mainly consisting of an aromatic dicarboxylic acid component and a glycol component and copolymerized or mixed with a phosphorus compound in an amount of 100 to 5000 ppm in terms of phosphorus element, and a polyester resin (2) mainly consisting of an aromatic dicarboxylic acid component and an ethylene glycol component, wherein in the case the content of cyclic trimer of a molded article obtained by injection molding of the composition is defined as Aₜ ppm and the content of cyclic trimer of the polyester resin composition before the injection molding is defined as A₀ ppm, Aₜ−A₀ is less than 500 ppm.
(17) A polyester resin composition containing, as main components, a polyester resin (1) mainly consisting of an aromatic dicarboxylic acid component and a glycol component and copolymerized or mixed with a phosphorus compound in an amount of 100 to 5000 ppm in terms of phosphorus element, and a polyester resin (2) mainly consisting of an aromatic dicarboxylic acid component and an ethylene glycol component, wherein in the case the content of acetaldehyde of a molded article obtained by injection molding of the composition is defined as Bₜ ppm and the content of acetaldehyde of the polyester resin composition before the injection molding is defined as B₀ ppm, Bₜ−B₀ is from 1 to 30 ppm.
(18) A polyester resin composition containing, as main components, a polyester resin (1) mainly consisting of an aromatic dicarboxylic acid component and a glycol component, copolymerized or mixed with a phosphorus compound in an amount of 100 to 5000 ppm in terms of phosphorus element, and containing, as a polycondensation catalyst, at least one compound of Sb metal compounds and Ge metal compounds, and a polyester resin (2) mainly consisting of an aromatic dicarboxylic acid component and an ethylene glycol component and containing, as a polycondensation catalyst, at least one compound of Ti metal compounds and Al metal compounds.
(19) A polyester molded article obtained by melt-molding the polyester resin composition described in (11) to (18).
(20) A polyester molded article, wherein the polyester molded article as described in (19) is one of a hollow molded article, a sheet-like substance, or a stretched film obtained by stretching the sheet-like substance in at least one direction.
(21) A coated substance obtained by melt-molding the polyester resin composition described in any one of (11) to (18) on a substrate.
(22) A method for producing a polyester molded article by injection molding, compression molding, or extrusion molding of the polyester resin composition as described in any one of (11) to (18).

### EFFECTS OF THE INVENTION

The polyester is preferably employed as a polyester resin usable for deactivating a polycondensation catalyst for polyester production and suppressing the forming of aldehydes such as acetaldehyde and cyclic ester oligomers at molding stage. Particularly, the polyester resin composition of the present invention is a polyester resin composition excellent in transparency and taste preservation, free from a problem such as worsening of the transparency by mold stains at continuous molding stage, and usable for efficiently producing hollow molded articles excellent in heat resistant size stability, and in the present invention, a molded article provided with the above-mentioned characteristics can be obtained.

### BEST MODE FOR CARRYING OUT THE INVENTION

Hereinafter, embodiments of a polyester resin, a polyester resin composition containing the resin, and use of the composition will be described practically.

### (Polyester Resin (1))

A polyester resin (1) of the present invention mainly consists of an aromatic dicarboxylic acid component and a glycol component, is copolymerized or mixed with a phosphorus compound in an amount of 100 to 10000 ppm in terms of phosphorus element, and is used for deactivating a catalyst used for polycondensation of a polyester resin (2).

The phosphorous compound used for the polyester resin (1) of the invention may be phosphoric acid-containing compounds, phosphonic acid-containing compounds, phosphinic acid-containing compounds, phosphorous acid-containing compounds, phosphonous acid-containing compounds, phosphinous acid-containing compounds.

Practical examples of the phosphoric acid-containing compounds are phosphoric acid, dimethyl phosphate, diethyl phosphate, dipropyl phosphate, dibutyl phosphate, diamyl phosphate, dihexyl phosphate, trimethyl phosphate, triethyl phosphate, tripropyl phosphate, tributyl phosphate, triamyl phosphate, trihexyl phosphate, and esters of phosphoric acid and alkylene glycol.

Practical examples of the phosphonic acid-containing compounds are methylphosphonic acid, dimethyl methylphosphonate, diphenyl methylphosphonate, phenylphosphonic acid, dimethyl phenylphosphonate, diphenyl phenylphosphonate, dimethyl benzylphosphonate, diethyl benzylphosphonate, triethyl phosphonoacetate, tributyl phosphonoacetate, tri(hydroxyethyl) phosphonoacetate, tri(hydroxypropyl) phosphonoacetate, and tri(hydroxybutyl) phosphonoacetate.

Practical examples of the phosphinic acid-containing compounds, are diphenylphosphinic acid, methyl diphenylphosphinate, phenyl diphenylphosphinate, phenylphosphinic acid, methyl phenylphosphinate, phenyl phenylphosphinate, 2-carboxyethyl-methylphosphinic acid, 2-carboxyethyl-ethylphosphinic acid, 2-carboxyethyl-propylphosphinic acid, 2-carboxyethyl-phenylphosphinic acid, 2-carboxyethyl-m-tolylphosphinic acid, 2-carboxyethyl-p-tolylphosphinic acid, 2-carboxyethyl-xylylphosphinic acid, 2-carboxyethyl-benzylphosphinic acid, 2-carboxyethyl-m-ethylbenzylphosphinic acid, 2-carboxymethyl-methylphosphinic acid, 2-carboxymethyl-ethylphosphinic acid, 2-carboxyethyl-propylphosphinic acid, 2-carboxymethyl-phenylphosphinic acid, 2-carboxymethyl-m-tolylphosphinic acid, 2-carboxymethyl-p-tolylphosphinic acid, 2-carboxymethyl-xylylphosphinic acid, 2-carboxymethyl-benzylphosphinic acid, 2-carboxyethyl-m-ethylbenzylphosphinic acid, and ring acid anhydrides thereof and methyl esters, ethyl esters, propyl esters, butyl esters, ethylene glycol esters, propione glycol esters, and butane diol esters thereof.

Practical examples of the phosphorous acid-containing compounds are phosphorous acid, dimethyl phosphite, diethyl phosphite, dipropyl phosphite, dibutyl phosphite, diamyl phosphite, dihexyl phosphite, trimethyl phosphite, triethyl phosphite, triphenylphosphite, tris(2,4-di-tert-butylphenyl) phosphite, tetrakis(2,4-di-tert-butylphenyl) 4,4′-biphenylenediphosphite, and esters of phosphorous acid and alkylene glycol.

Practical examples of the phosphonous acid-containing compounds are methylphosphonous acid, methylphosphonous acid dimethyl ester, methylphosphonous acid diphenyl ester, phenylphosphonous acid, phenylphosphonous acid dimethyl ester, and phenylphosphonous acid diphenyl ester.

As other phosphorus compounds, phosphorus compounds other than those used in the following polyester resin (2) are also usable.

In the case the polyester resin composition of the present invention is use for uses of heat resistant molded articles and stretched molded articles, the polyester resin (1) of the present invention is a thermoplastic polyester produced mainly from an aromatic dicarboxylic acid component and a glycol component and may be polyester containing 70% by mole or higher of the aromatic dicarboxylic acid component based on acid components, preferably 85% by mole or higher of the aromatic dicarboxylic acid component relative to acid components, more preferably 90% by mole or higher of the aromatic dicarboxylic acid component relative to acid components, furthermore preferably 93% by mole or higher of the aromatic dicarboxylic acid component relative to acid components, and even more preferably 95% by mole or higher of the aromatic dicarboxylic acid component relative to acid components, which is copolymerized or mixed with the above-mentioned phosphorus compound.

Examples of a main dicarboxylic acid component composing the polyester resin (1) of the present invention are aromatic dicarboxylic acids such as terephthalic acid, 2,6-naphthalenedicarboxylic acid, diphenyl-4,4′-dicarboxylic acid, and diphenoxyethanedicarboxylic acid and their functional derivatives; oxyacids such as p-oxybenzoic acid and oxycaproic acid and their functional derivatives; aliphatic dicarboxylic acids such as adipic acid, sebacic acid, succinic acid, lactic acid, glycolic acid, and glutaric acid and their functional derivatives.

Examples of the glycol component composing the polyester resin (1) of the present invention are aliphatic glycols such as ethylene glycol, 1,3-trimethylene glycol, and tetramethylene glycol and alicyclic glycols such as cyclohexanedimethanol.

Examples of a dicarboxylic acid as a copolymerization component used in the case the above-mentioned polyesters are copolymers are aromatic dicarboxylic acids such as terephthalic acid, isophthalic acid, diphenyl-4,4′-dicarboxylic acid, diphenoxyethanedicarboxylic acid, 4,4′-diphenyl ether dicarboxylic acid, and 4,4′-diphenyl ketone dicarboxylic acid and their functional derivatives; oxyacids such as p-oxybenzoic acid, oxycaproic acid, and 3-hydroxybutyric acid and their functional derivatives; aliphatic dicarboxylic acids such as adipic acid, sebacic acid, succinic acid, glutaric acid, dimer acid, glycolic acid, and malic acid, and their functional derivatives; alicyclic dicarboxylic acid such as hexahydroterephthalic acid, hexahydroisophthalic acid, and cyclohexanedicarboxylic acid, and their functional derivatives; and lactones such as caprolactone and valerolactone.

Examples of a glycol as a copolymerization component used in the case the above-mentioned polyesters are copolymers are aliphatic glycols such as diethylene glycol, 1,3-trimethylene glycol, tetramethylene glycol, pentamethylene glycol, hexamethylene glycol, octamethylene glycol, decamethylene glycol, 2-ethyl-2-butyl-1,3-propanediol, neopentyl glycol, and dimer glycol; alicyclic glycols such as 1,2-cyclohexanediol, 1,4-cyclohexanediol, 1,1-cyclohexanedimethylol, 1,4-cyclohexanedimethylol, and 2,5-norbornanedimethylol; aromatic glycols such as xylylene glycol, 4,4′-dihydroxybiphenyl, 2,2-bis(4′-β-hydroxyethoxyphenyl)propane, bis(4-hydroxyphenyl)sulfone, bisphenol A alkylene oxide adducts; and polyalkylene glycol such as polyethylene glycol and polybutylene glycol.

Examples of a polyfunctional compound as a copolymerization component used in the case the above-mentioned polyesters are copolymers are, as an acid component, trimellitic acid and pyromellitic acid; as a glycol component, glycerin and pentaerythritol. Use amounts of these copolymerization components should be proper for the polyesters to substantially maintain to be linear. Further, a monofunctional compound such as benzoic acid and naphthoic acid may be copolymerized.

One preferable example of the polyester resin (1) of the present invention may be polyesters composed of ethylene terephthalate as a main component unit, preferably copolymer polyesters containing 80% by mole or higher of ethylene terephthalate unit and as a copolymerization component, isophthalic acid, 2,6-naphthalenedicarboxylic acid, and 1,4-cyclohexanedimethanol, furthermore preferably polyesters containing 90% by mole or higher of ethylene terephthalate unit, and even more preferably polyesters containing 95% by mole or higher of ethylene terephthalate unit, and copolymerized or mixed with the above-mentioned phosphorus compound.

Another preferable example of the polyester resin (1) of the present invention may be polyesters composed of ethylene-2,6-naphthalate as a main component unit, preferably polyesters containing 80% by mole or higher of ethylene-2,6-naphthalate unit, furthermore preferably polyesters containing 90% by mole or higher of ethylene-2,6-naphthalate unit, and even more preferably polyesters containing 95% by mole or higher of ethylene-2,6-naphthalate unit, and copolymerized or mixed with the above-mentioned phosphorus compound.

Further, another preferable example of the polyester resin of the present invention may be polyesters composed of 1,3-propylene terephthalate as a main component unit, preferably polyesters containing 80% by mole or higher of 1,3-propylene terephthalate unit, furthermore preferably polyesters containing 90% by mole or higher of 1,3-propylene terephthalate unit, and even more preferably polyesters containing 95% by mole or higher of 1,3-propylene terephthalate unit, and copolymerized or mixed with the above-mentioned phosphorus compound.

Further, another preferable example of the polyester resin (1) of the present invention may be polyesters composed of butylene terephthalate as a main component unit, preferably polyesters containing 80% by mole or higher of butylene terephthalate unit, furthermore preferably polyesters containing 90% by mole or higher of butylene terephthalate unit, and even more preferably polyesters containing 95% by mole or higher of butylene terephthalate unit, and copolymerized or mixed with the above-mentioned phosphorus compound.

The polyester resin (1) copolymerized or mixed with the phosphorus compound, according to the present invention, can be produced by a method of adding the phosphorus compound upon polycondensation and carrying out copolymerization or a method of kneading the polyester resin and at least one compound selected from the above-mentioned phosphorus compounds by an extruder, e.g. a biaxial extruder, but not limited thereto.

In the case of the copolymerization method, for example, a copolymer polyester composed of terephthalic acid, ethylene glycol, and phosphorus compound can be produced by the following method.

The copolymer polyester can be synthesized by any arbitrary method employed for producing polyesters by polycondensation of esterification reaction products or transesterification reaction products of terephthalic acid and/or its ester formable derivatives with ethylene glycol. In this case, the transesterification reaction, esterification reaction and melt-polycondensation reaction may be carried out in one step or separately in multi-steps. They may be carried out by a batch type reaction apparatus or a continuous type reaction apparatus.

The above-mentioned phosphorus compound may be added at polyester production stage, however, the addition timing may be in an arbitrary stage from the initial stage of the esterification step or transesterification step to the late stage of initial condensation, and it is preferable to add at a timing from the late stage of the esterification step or transesterification step to the initial stage of the initial condensation in terms of suppression of side reaction such as acetaldehyde formation or corrosion of a reaction apparatus.

In the case of production by esterification reaction, a slurry containing from 1.02 to 2.0 mole, preferably from 1.03 to 1.4 mole, of ethylene glycol relative to 1 mole of terephthalic acid is prepared and subjected to esterification reaction.

Preferable production conditions in the case of esterification reaction are as follows. That is, esterification reaction is carried out at 230 to 250° C. and normal pressure to pressurized pressure for 0.5 to 5 hours to achieve esterification reaction ratio of at least 90% and preferably 95% or higher. Next, the phosphorus compound is added and first stage polycondensation is carried out at 240 to 255° C., preferably 240 to 250° C., and more preferably 240 to 248° C. and 300 to 0.1 Torr for 0.5 to 2 hours, and further polycondensation is carried out at 250 to 280° C., preferably 250 to 278° C., and more preferably 250 to 275° C. and 10 to 0.1 Torr and preferably 5 to 0.1 Torr to an aimed polymerization degree. Particularly, it is important to carry out the polycondensation reaction in the first stage at 250° C. or lower in order to accomplish the aim of the present invention.

Further, in the case of production by transesterification reaction, a solution containing 1.1 to 2.0 mole, preferably 1.2 to 1.5 mole, of ethylene glycol relative to 1 mole of dimethyl terephthalate is prepared and subjected to transesterification reaction. The temperature of the transesterification reaction is from 180 to 270° C. and preferably from 200 to 250° C. As a transesterification catalyst are employed fatty acid salts and carbonate salts of Zn, Cd, Mg, Mn, Co, Ca, Ba or the like and oxides of Pb, Zn, Sb, Ge or the like. Lower condensates with molecular weight of about 200 to 500 can be obtained by these transesterification reactions. The condensates are then subjected to polycondensation reaction as described above.

As terephthalic acid and ethylene glycol, which are the above-mentioned starting raw materials, not only virgin terephthalic acid derived from paraxylene and ethylene glycol derived from ethylene but also recycled raw materials such as terephthalic acid, bishydroxyethyl terephthalate, and ethylene glycol recovered by chemical recycling method such as methanol decomposition or ethylene glycol decomposition of used PET bottles may be used for at least a portion of the starting materials. Needless to say, the above-mentioned recycled raw materials have to be refined to be pure or high grade depending on the use purposes.

As the polycondensation catalyst is employed one or more metal compound selected from a group consisting of lithium, sodium, potassium, rubidium, cesium, beryllium, magnesium, calcium, strontium, indium, thallium, germanium, tin, lead, bismuth, scandium, yttrium, niobium, zirconium, hafnium, vanadium, chromium, manganese, iron, cobalt, nickel, copper, zinc, ruthenium, rhodium, palladium, tellurium, tantalum, tungsten, gallium, aluminum, antimony, germanium, titanium, silicon, and silver, and antimony compounds, germanium compounds, and tungsten compounds, whose catalytic action are not deactivated by the above-mentioned phosphorus compound are optimum and particularly at least one compound selected from a group consisting of antimony compounds and germanium compounds is preferable.

Practical examples of Sb compounds are antimony trioxide, antimony acetate, antimony tartarate, antimony potassium tartarate, antimony oxychloride, antimony glycolate, diantimony pentoxide, and triphenyl antimony. The Sb compounds are added in a proper amount to adjust the remaining Sb amount in the produced polymer to be in a range of 50 to 300 ppm, preferably 55 to 200 ppm, and more preferably 60 to 150 ppm.

Practical examples of Ge compounds are amorphous germanium dioxide, crystalline germanium dioxide, germanium tetraoxide, germanium hydroxide, germanium oxalate, germanium chloride, germanium tetraethoxide, germanium tetra-n-butoxide, and germanium phosphite. In the case of using the Ge compounds, the use amount is in a range of 10 to 100 ppm, preferably 11 to 50 ppm, and more preferably 11 to 15 ppm as the remaining Ge amount in the polyester (1)

The polyester resin obtained by polycondensation as described above is transported in melted state from a final melt-polycondensation reactor to a nozzle and for example, the melt polyester is formed into chips with a column-like, spherical, block-like, or plate-like shape by a method of extruding the melt polyester through a dice fine pore into water and cutting it in water or a method of extruding it in strand shape in air through a dice fine pore and chipping the strand while cooling it with cooling water. At that time, it is required to keep the temperature of the polyester resin in the melted state to the nozzle as low as possible and to shorten the retention time as much as possible in order to obtain the polyester resin (1) of the present invention.

Further, it is preferable to use cooling water satisfying at least one of the followings (1) to (4) as the cooling water used for chipping the above-mentioned melted polycondensed polyester and more preferable to use water satisfying all of the following formulas (1) to (4).

Na≦1.0 (ppm) (1),

Mg≦1.0 (ppm) (2),

Si≦2.0 (ppm) (3), and

Ca≦1.0 (ppm) (4).

The sodium content (Na) in cooling water is preferably Na≦0.5 ppm and more preferably Na≦0.1 ppm. The magnesium content (Mg) in cooling water is preferably Mg≦0.5 ppm and more preferably Mg≦0.1 ppm. Further, the silicon content (Si) in cooling water is preferably Si≦0.5 ppm and more preferably Si≦0.3 ppm. Further, the calcium content (Ca) in cooling water is preferably Ca≦0.5 ppm and more preferably Ca≦0.1 ppm.

To decrease sodium, magnesium, calcium, and silicon in the above-mentioned cooling water, an apparatus for removing sodium, magnesium, calcium, and silicon is installed in at least one or more places in the process of sending industrial water to the chip cooling step. Further, to remove granular silicon dioxide and clay minerals such as aluminosilicates, a filter is installed. As the apparatus for removing sodium, magnesium, calcium, and silicon, an ion exchange apparatus, an ultrafiltration apparatus, and a reverse osmosis membrane apparatus can be exemplified.

In the case of a method of mixing the phosphorus compound to the polyester resin, it can be done by a method of melting and kneading the polyester resin consisting of only above-mentioned aromatic dicarboxylic acid component and glycol component with the above-mentioned phosphorus compound by a biaxial extruder, and chipping the mixture, a method of immersing the polyester resin granules in an aqueous or organic solvent solution of the phosphorus compound, or a method of depositing the solution to the surface.

The polyester resin (1) of the present invention is a polyester resin mainly consisting of an aromatic dicarboxylic acid component and a glycol component and copolymerized or mixed with a phosphorus compound in an amount of 100 to 10000 ppm in terms of phosphorus element, and is characterized in that the contents of Zn element, Fe element, Ni element, and Cr element satisfy at least one of the following formulas (A) to (D);

Cr≦10 ppm (5),

Fe≦30 ppm (6),

Ni≦5 ppm (7), and

Zn≦5 ppm (8).

The polyester resin (1) of the present invention is a polyester resin containing a phosphorus compound in an amount of preferably 200 to 8000 ppm and more preferably 300 to 6000 ppm in terms of phosphorus element. If the phosphorus element in the polyester resin (1) is less than 100 ppm, the deactivation of the catalyst contained in the polyester resin (2) is suppressed, formation of cyclic ester oligomers and aldehydes at molding stage cannot be suppressed, and it results in a problem that the contents of the aldehydes and the contents of cyclic oligomers such as cyclic trimers in an obtained molded article become very high. Further, the compatibility with the polyester resin (2) is also decreased to increase the haze of the obtained molded article. Further, if it exceeds 10000 ppm, the polymerization speed is increased, gelation sometimes occurs, and it sometimes results in a problem of impossibility of normal production.

Further, the Cr element content in the polyester resin (1) is, in terms of Cr element, preferably 8 ppm or lower, more preferably 6 ppm or lower, furthermore preferably 4 ppm or lower, and even more preferably 1 ppm or lower. The Fe element content is, in terms of Fe element, preferably 25 ppm or lower, more preferably 20 ppm or lower, furthermore preferably 10 ppm or lower, and even more preferably 5 ppm or lower. The Ni element content is, in terms of Ni element, preferably 3 ppm or lower, more preferably 2 ppm or lower, and even more preferably 1 ppm or lower. The Zn element content is, in terms of Zn element, preferably 4 ppm or lower, more preferably 3 ppm or lower, furthermore preferably 2 ppm or lower, and even more preferably 1 ppm or lower. Further, it is most preferable that the above-mentioned formulas (5) to (8) are all satisfied. The lower limit values of the above-mentioned metal element contents are preferably 0.001 ppm and more preferably 0.01 ppm in terms of economy.

Additionally, in the case at least one of the above-mentioned metal element contents exceeds the above-mentioned upper limit value, there sometimes occur problems that the color tone of the polyester resin (1) becomes bad: the aldehyde content is increased: the transparency of a molded article produced from a polyester resin composition containing it in combination with the polyester resin (2) is worsened: the colorization of the molded article becomes significant: and further the taste preservation is worsened. Therefore, it is preferable to satisfy all of the above-mentioned formulas.

A method of satisfying the contents of Zn element, Fe element, Ni element, and Cr element in the polyester resin (1) as the above-mentioned formulas (5) to (8) is employing, as reactors and stirrers for carrying out esterification reaction and polycondensation reaction, reactors made of a material having at least high temperature corrosion resistant of SUS 316, SUS 316L, SUS 317, SUS 317 L, and Hastelloy, preferably made of SUS 316L, SUS 317, SUS 317 L, Hastelloy, and glass-lined one, and most preferably reactors and stirrers made of SUS 317, SUS 317 L, and Hastelloy. Particularly, as a reactor for causing reaction of the phosphorus compound at 230° C. or higher, it is required to use such a reactor. In the case of using a reactor made of a metal material which is generally employed for polycondensation of PET, a large quantity of Cr metal ad Fe metal are eluted and therefore it is not preferable.

In the case of a method of adding the phosphorus compound to the polyester resin, methods to be employed are a method of melting and kneading the polyester resin and the above-mentioned phosphorus compound by a biaxial extruder and chipping the melted mixture, a method of immersing the polyester resin granules in an aqueous or organic solvent solution of the phosphorus compound, or a method of depositing the solution to the surface and in this case, it is also required to use a biaxial extruder comprising a screw and barrel made of a material having corrosion resistance of SUS 316 or higher, preferably SUS 316L, SUS 317, SUS 317L, and Hastelloy.

The polyester resin (1) of the present invention mainly consists of an aromatic dicarboxylic acid component and a glycol component and copolymerized or mixed with a phosphorus compound in an amount of 100 to 10000 ppm in terms of phosphorus element, and is characterized in that the content of free aromatic dicarboxylic acid derived from the polyester is 10 ppm or lower, the content of free glycol is 1500 ppm or lower, the content of free aromatic dicarboxylic acid monoglycol ester is 50 ppm or lower, and the content of free aromatic dicarboxylic acid diglycol ester is 100 ppm or lower.

The content of free aromatic dicarboxylic acid is preferably 8 ppm or lower and more preferably 5 ppm or lower; the content of free glycol is preferably 1000 ppm or lower and more preferably 800 ppm or lower; the content of free aromatic dicarboxylic acid monoglycol ester is preferably 30 ppm or lower and more preferably 20 ppm or lower; and the content of free aromatic dicarboxylic acid diglycol ester is preferably 90 ppm or lower and more preferably 80 ppm or lower. If the content of free aromatic dicarboxylic acid derived from the polyester exceeds 10 ppm, the content of free glycol exceeds 1500 ppm, the content of free aromatic dicarboxylic acid monoglycol ester exceeds 50 ppm, and the content of free aromatic dicarboxylic acid diglycol ester exceeds 100 ppm, the taste preservation of the contents in a molded article obtained by molding the polyester resin composition containing together with the polyester resin (2) is considerably worsened to result in a problem. It is supposed that these free low molecular weight compounds are eluted although in a very trace amount to the contents from the material such as a polyester container obtained by molding the following polyester resin composition to consequently affect the taste or the like of the contents.

Herein, in the case the polyester resin (1) is a polyester resin containing ethylene terephthalate as a main repeating unit, the above-mentioned aromatic dicarboxylic acid is terephthalic acid (hereinafter, sometimes referred to as TPA), the above-mentioned glycol is ethylene glycol (hereinafter, sometimes referred to as EG) and diethylene glycol (hereinafter, sometimes referred to as DEG), the aromatic dicarboxylic acid monoglycol ester is monohydroxyethyl terephthalate (hereinafter, sometimes referred to as MHET), and the aromatic dicarboxylic acid diglycol ester is bishydroxyethyl terephthalate (hereinafter, sometimes referred to as BHET). The total of the contents of the free ethylene glycol and the free diethylene glycol is defined as a content of free glycol content. The lower limits of the contents of above-mentioned free TPA, EG, MHET, and BHET are respectively 1 ppm, 2 ppm, 5 ppm, and 5 ppm and even if the lower limits are further lowered, it cannot be expected to improve the taste of the contents.

Further, when the polyester resin (1) is a polyester resin containing ethylene naphthalate as a main repeating unit, the above-mentioned aromatic dicarboxylic acid is naphthalene dicarboxylic acid, the above-mentioned glycol is ethylene glycol and diethylene glycol, the above-mentioned aromatic dicarboxylic acid monoglycol ester is 2,6-monohydroxyethyl naphthalate, and the aromatic dicarboxylic acid diglycol ester is 2,6-bishydroxyethyl naphthalate.

A method for adjusting the contents of the above-mentioned free monomers and linear oligomers in the polyester resin (1) of the present invention to the above-mentioned contents or lower may be a method of keeping the temperature of a polyester resin melted and polycondensed as low as possible with keeping the melted state and shortening the retention time as much as possible from the final melting and polycondensation reactor to the nozzle, a method of heating and crystallizing a melted and polycondensed polymer having IV of 0.40 dl/g or higher at a temperature up to 150° C. under reduced pressure or inert gas circulation condition immediately after chipping, a method of solid phase-polymerizing a melted and polycondensed prepolymer having IV of 0.40 to 0.60 dl/g, a method of melting and extruding a polyester under reduced pressure or inert gas circulation condition by a bent type extruder, and a method of heat treating a phosphorus-containing polyester resin with water or an organic solvent such as chloroform, and these methods may be employed in combination.

The polyester resin (1) of the present invention is a polyester resin mainly consisting of an aromatic dicarboxylic acid component and a glycol component and copolymerized or mixed with a phosphorus compound in an amount of 100 to 10000 ppm in terms of phosphorus element, and characterized in that the aldehyde content is 150 ppm or lower. The aldehyde content is preferably 100 ppm or lower and more preferably 50 ppm or lower.

If the aldehyde content is 150 ppm or lower, there occurs no problem of the taste preservation for contents packed in a molded article such as a hollow molded article obtained by molding the polyester resin composition containing the polyester resin (2) in combination. If the aldehyde content exceeds 150 ppm, the taste preservation for contents packed in a molded article is considerably worsened to result in a problem. The lower limit of the aldehyde content is 1 ppm, preferably 2 ppm, and more preferably 3 ppm in terms of the economy.

Herein, if the polyester resin (1) is a polyester containing ethylene glycol as a main component of the glycol component, e.g. a polyester containing ethylene terephthalate as a main component unit or a polyester containing ethylene-2,6-naphthalate as a main component, aldehydes are acetaldehyde and formaldehyde: if the polyester resin (1) is a polyester containing 1,3-propylene terephthalate as a main component unit, aldehydes are allyl aldehyde: and if the polyester resin is a polyester containing butylene terephthalate as a main component unit, aldehydes are butanal. However, if the polyester resin is a polyester containing butylene terephthalate as a main component unit, the above-mentioned aldehydes are often detected as tetrahydrofuran.

Methods of adjusting the content of aldehydes of the polyester resin (1) of the present invention to be 150 ppm or lower are a method of solid-phase polymerization of a solution polymerized polyester prepolymer having IV of 0.30 to 0.60, a method of heat treating a polyester having a predetermined IV in condition in which IV is not substantially changed or scarcely increased under inert gas atmosphere or reduced pressure, a method of heat treating a polyester at 50 to 180° C. under inert gas atmosphere or reduced pressure, a method of melting and extruding a polyester under reduced pressure or inert gas circulation by a bent type extruder, a method of heat treating a phosphorus-containing polyester resin with water or an organic solvent such as chloroform, and a method of precipitating a polyester by re-precipitation from a solution obtained by dissolving the polyester in a solvent, and these methods can be employed alone or properly combined.

If it is desired to provide a molded article made of the polyester resin composition of the present invention with an ultraviolet ray interception property, it is preferable to use a polyester resin (1) consisting of acid components consisting of 20% by mole to 100% by mole of naphthalenedicarboxylic acid and 0% by mole to 80% by mole of other carboxylic acids, a glycol component, and a phosphorus compound in an amount of 100-10000 ppm in terms of phosphorus element. The copolymerization ratio of naphthalenedicarboxylic acid in the polyester resin (1) is preferably 30% by mole to 100% by mole and more preferably 40% by mole to 100% by mole. If the ratio of naphthalenedicarboxylic acid is less than 20% by mole, the ultraviolet ray interception property tends to be decreased and therefore, it is not preferable.

If the phosphorus element is in the polyester resin (1) is lower than 100 ppm, the compatibility with the polyester resin (2) tends to be decreased and haze tends to be increased. Further, if it exceeds 10000 ppm, the polymerization speed becomes fast and gelation may sometimes occur to make normal production impossible.

Herein, examples of naphthalenedicarboxylic acid may be 2,6-naphthalenedicarboxylic acid, 2,5-naphthalenedicarboxylic acid and 2,3-naphthalenedicarboxylic acid; preferably 2,6-naphthalenedicarboxylic acid and 2,5-naphthalenedicarboxylic acid; and most preferably 2,6-naphthalenedicarboxylic acid.

The polyester resin (1) of the present invention is a polyester resin which can be used for deactivating a catalyst used for producing the polyester resin (2) and simultaneously providing heat resistance, oxygen barrier property, and ultraviolet ray shutting property.

The content of dialkylene glycol and the content of trialkylene glycol copolymerized in the polyester resin (1) of the present invention are respectively 10.0% by mole or lower and 2.0% by mole or lower; preferably 8.0% by mole or lower and 1.5% by mole or lower; more preferably 6.0% by mole or lower and 1.0% by mole or lower; and even more preferably 5.0% by mole or lower and 0.5% by mole or lower relative to the glycol component composing the polyester. If the content of dialkylene glycol exceeds 10.0% by mole, the heat stability, heat oxidation stability, and color tone are worsened, and, upon drying and molding the polyester resin composition containing the polyester resin (2) in combination, the molecular weight decreases significantly, the content of the aldehydes is increased, and discoloration becomes significant and therefore, it is not preferable.

Further, if the content of trialkylene glycol exceeds 2% by mole, the heat stability, heat oxidation stability, and color tone are also worsened, and upon drying and molding the polyester resin composition containing the polyester resin (2) in combination, the molecular weight decreases significantly, the content of the aldehydes is increased, and discoloration becomes significant and therefore, it is not preferable.

The lower limit values of the content of dialkylene glycol and the content of trialkylene glycol are 0.5% by mole and 0.1% by mole, respectively, and even if the contents are lower further below these lower limit values, no effect can be caused and rather, in terms of economy, there occurs a problem that the esterification reaction temperature has to be decreased much and the reaction has to be carried out for a long time.

Dialkylene glycol copolymerized in a polyester means, for example, in the case of a polyester containing ethylene terephthalate as a main component unit, diethylene glycol (hereinafter, referred to as DEG) copolymerized in the polyester among diethylene glycols produced as byproducts from the glycol, that is ethylene glycol, upon production; in the case of a polyester containing 3-propylene terephthalate as a main component unit, di(1,3-propylene glycol) copolymerized in the polyester among di(1,3-propylene glycol) (or bis(3-hydroxypropyl)ether) produced as byproducts from the glycol, that is 1,3-propylene glycol, upon production. Further, trialkylene glycol copolymerized in a polyester similarly means, for example, in the case of a polyester containing ethylene terephthalate as a main component unit, triethylene glycol (hereinafter, referred to as TEG) copolymerized in the polyester among triethylene glycols produced as byproducts upon production; in the case of a polyester containing 1,3-propylene terephthalate as a main component unit, tri(1,3-propylene glycol) copolymerized in the polyester among tri(1,3-propylene glycol) (or tris(3-hydroxypropyl)ether) produced as byproducts upon production.

In the production of the polyester resin (1) of the present invention, as a method for suppressing the dialkylene glycol content and trialkylene glycol content in the range of the present invention is employed a basic nitrogen compound. The basic nitrogen compound may be any of aliphatic, alicyclic, aromatic and heterocyclic nitrogen compounds. Practical examples are triethylamine, tributylamine, dimethylaniline, dimethylaniline, pyridine, quinoline, dimethylbenzylamine, piperidine, tetraethylammonium hydroxide, tetrabutylammonium hydroxide, triethylbenzylammonium hydroxide, imidazole, and imidazoline. These compounds may be used in form of radicals or in form of salts of lower fatty acids or TPA. Addition of these basic nitrogen compounds to a reaction system can be properly selected in an arbitrary stage by completion of the initial polycondensation reaction and these basic nitrogen compounds may be used alone or two or more of them in combination. The addition amount of these basic nitrogen compounds is 0.01 to 1% by mole, preferably 0.05 to 0.7% by mole, and more preferably 0.1 to 0.5% by mole relative to the polyester.

It is also effective to keep the reaction temperature around 230° C. until the esterification ratio becomes 60% or higher in an initial stage of the esterification reaction.

The polyester resin (1) of the present invention is a polyester resin characterized in that the water content is 500 to 10000 ppm. The water content is preferably 800 to 9000 ppm and more preferably 1000 to 8000 ppm. The phosphorus compound in the polyester resin (1) can deactivate the polycondensation catalyst of the polyester resin (2) and at the same time fluidity is improved upon melting due to the effect of water existing in an amount of 500 to 10000 ppm in the polyester resin (1), so that production of aldehydes and cyclic ester oligomers can be suppressed at melt molding stage.

If the water content exceeds 10000 ppm, the intrinsic viscosity of the obtained molded article is so much decreased as to worsen the transparency and mechanical strength. If it is lower than 500 ppm, in the case of molding a hollow molded article by continuous molding, staining of a mold become rather acute and also the transparency and appearance of the obtained hollow molded article are worsened to result in a problem.

The water content of the polyester resin (1) can be adjusted within the above-mentioned range of the water content by various methods, for example, a method of immersing chips in water and dewatering the water adhering to the surfaces, a method of leaving the polyester resin under atmospheric air with high humidity, a method of supplying water equivalent to the above-mentioned water content to the polyester before molding, a method of completing the drying at the time when the water content becomes a predetermined value and carrying out melt molding, and a method of decreasing the water content in the polymer to below 500 ppm once by drying and adjusting the water content to be 500 to 10000 ppm by the moisture adjustment. The drying conditions differ in accordance with the copolymerized components and their amounts; however, they are generally at a temperature condition of 70 to 170° C.

The water content within the above-mentioned range of the present invention is high as compared with water content in a common resin before molding, and therefore, in consideration of the balance between hydrolysis and heat decomposition, it is required to be careful about the molding conditions. There, a melt molding method of the polyester resin of the present invention is preferable carried out under condition that the ratio (Y/X)×100 (%) (hereinafter, referred to as IV retention ratio) of the intrinsic viscosity X (dl/g) of the polyester resin composition before molding and the intrinsic viscosity Y (dl/g) (actually measured value) of the intrinsic viscosity of the molded article is adjusted to be 90% or higher. By selecting the water content and the melt molding condition that the IV retention ratio is 90% or higher, preferably 92% or higher, the content of aldehydes in the molded article, such as acetaldehyde, can be reduced without substantially deteriorating the mechanical strength and the transparency thereof to achieve the aim of the present invention. If the IV retention ratio is less than 90%, the silver streaks tend to be formed at molding stage; the acetaldehyde amount increases in the molded article before the thermal decomposition reaction; or molecular weight is decreased to an extent that the melt molding cannot be carried out properly due to excess hydrolysis reaction and accordingly it sometimes becomes impossible to obtain a satisfactory molded article. Actual molding condition differs in accordance with a molding apparatus or an extruder and therefore it cannot be defined in general and should be adjusted individually. For example, if the intrinsic viscosity Y of a molded article is low, the condition should be proper to set the melt viscosity of resins at respective molding temperatures to be in balance with the pressure/speed of the injection or extrusion and keep sufficient melting state by shortening the retention time of the polyester resin in a cylinder of a molding apparatus or an extruder, or by lowering the melting temperature in consideration of the transparency or mechanical characteristics or the condition should be proper to avoid high shearing by suppressing screw rotation speed or changing the screw shape.

The intrinsic viscosity of the polyester resin (1) of the present invention is desirable to be in a range of 0.40 to 1.20 dl/g, preferably 0.50 to 1.00 dl/g, more preferably 0.60 to 0.90 dl/g, and even more preferably 0.65 to 0.85 dl/g.

If the intrinsic viscosity is 0.60 dl/g or higher, a method of polymerizing a polymer, which is obtained by melt polycondensation, in solid-phase state is preferable.

If the intrinsic viscosity is less than 0.40 dl/g, the transparency of the obtained molded article is worsened and the mechanical strength cannot satisfy a range for practical use and therefore it is a problem. Further, if it exceeds 1.20 dl/g, kneading becomes incomplete upon molding the composition containing the polyester resin (2) in combination and thus it becomes impossible to obtain a molded article with a uniform quality.

The shape of chips of the polyester resin (1) of the present invention may by cylinder type, block type, spherical, or flat plate-like shape. Their average particle diameter is generally in a range of 1.0 to 4 mm, preferably 1.0 to 3.5 mm, and more preferably 1.0 to 3.0 mm. For example, in the case of the cylinder type, those with a length of 1.0 to 4 mm and a diameter of 1.0 to 4 mm are practically usable. In the case of spherical particles, those with the maximum particle diameter 1.1 to 2.0 times as large as the average particle diameter and the minimum particle diameter at least 0.7 times as large as the average particle diameter are practically usable. The average weight of the chips is in a range of 2 to 40 mg per a chip for practical use. Further, if it is required to improve the solid-phase polymerization speed or efficiently decrease the content of aldehydes, it is also preferable to adjust the average weight of chips to be 1 to 5 mg per a chip.

Further, in a step of making chips of the melted polycondensed polymer, a solid-phase polymerization step, and a step of transporting melted polycondensed polymer chips or solid-phase polymerized chips in the production process of the polyester resin (1), granules and powders rather much smaller than the chips with a size set upon granulation may be generated. Herein, such fine granules and powders are called as fines.

Such fines have a characteristic of promoting crystallization of a molded article of the polyester resin composition and it is important to control the fine content of the polyester resin (1) to be 1% by weight or less, preferably 0.7% by weight or less, more preferably 0.5% by weight or less, and even more preferably 0.1% by weight or less. If the fine content exceeds 1% by weight, there occur various problems that the transparency of a molded article obtained by molding the composition containing the polyester resin (2) in combination is worsened and that the crystallization speed becomes high and is very quickly fluctuated and accordingly it becomes impossible to obtain a polyester resin composition and a polyester molded article achieving the aims of the invention. Further upon mixing the polyester resin (2) and using the polyester resin composition, the mixing ratio fluctuation becomes significant and it results in a problem that the characteristics of an obtained molded article are fluctuated significantly. The lower limit value of the fine content in the polyester resin (1) is about 10 ppm or lower and to lower the value further causes a problem in terms of the economy.

A method of lowering the fine content of the polyester resin (1) to 1% by weight or lower may be a method involving the steps of discharging a melted polymer copolymerized with a phosphorus compound or a melted polymer kneaded with a phosphorus compound to water at about 5 to about 60° C. and simultaneously cutting the polymer in water by a cutter to obtain chips, removing the water adhering to the chips, and successively crystallizing and drying the chips by an installable crystallization apparatus by which no shear force or impact force is applied to the chips, or a method of involving a sieving step and a fine removing step by air current additionally to those steps, or a method involving a step of chipping melted polymer by a strand cutter after discharge to water at about 10 to 60° C. and highly densely transporting the chips after the fine removal in the same manner as described above.

Herein, fines means fine powders of polyesters passed through a sieve obtained by spreading a metal mesh with a nominal size of 1.7 mm according to JIS-Z8801 and the contents of the fines can be measured by the following measurement method.

The polyester resin (1) of the present invention is a polyester resin characterized in that the haze of a molded article with a thickness of 4 mm obtained by injection molding is 40% or lower. The haze of the molded article is preferably 20% or lower, more preferably 10% or lower, and even more preferably 5% or lower. If the above-mentioned haze exceeds 40%, there occur various problems that the molded article obtained by molding a composition containing the polyester resin (2) in combination is worsened and that the crystallization speed becomes fast. The lower limit value of the haze is 1% and even if it is further decreased, it scarcely causes any effect.

A method of obtaining the polyester resin (1) giving a molded article with a haze of 40% or lower may be, for example, a method of using a Ge compound as a polycondensation catalyst, a method of controlling, in the case of using a Sb compound, the addition amount of the Sb compound by adjusting the remaining Sb amount less than 190 ppm, a method of satisfying the above-mentioned formulas (5) to (8) for the contents of metal elements such as Cr eluting out of a reaction apparatus, a method of maintaining the temperature at 285° C. or lower upon polycondensation and suppressing thermal decomposition upon polycondensation as much as possible, and a method of employing a facility in which crystallization is suppressed before molding or solid-phase polymerization, or impact force to the chips is suppressed as much as possible upon drying, and these methods may be properly combined; however, the method should not be limited to these exemplified methods.

It is, however, required to change the cylinder temperature of an injection molding apparatus for molding the polyester resin (1) of the present invention in accordance with the melting point of the polyester resin (1) employed. Practically, as described in the measurement method (14), for the polyester resin (1) containing mainly a PET type polyester, a PBT type polyester resin, or A PPT type polyester resin, or for the polyester resin (1) containing mainly PEN type polyester resin, the set values of cylinder temperatures are 290° C. or 300° C., respectively.

Further, conventionally known various kinds of additives such as an ultraviolet absorbent, an antioxidant, an oxygen trapping agent, a lubricant added from outside and a lubricant internally precipitated during the reaction, a release agent, a nucleating agent, a stabilizer, an antistatic agent, a bluing agent, a dye, a pigment and so forth can be used in combination to an extent that the physical properties such as polymer color and hydrolysis are not deteriorated.

### (Polyester Resin (2))

The polyester resin (2) is a thermoplastic polyester to be produced mainly from an aromatic dicarboxylic acid component and a glycol component and may be polyesters containing 55% by mole or higher of the aromatic dicarboxylic acid unit relative to acid components, preferably 70% by mole or higher of the aromatic dicarboxylic acid unit relative to acid components, more preferably 80% by mole or higher of the aromatic dicarboxylic acid unit relative to acid components, and even more preferably 90% by mole or higher of the aromatic dicarboxylic acid unit relative to acid components.

Examples of a dicarboxylic acid component composing the polyester resin (2) of the present invention are aromatic dicarboxylic acids such as terephthalic acid, 2,6-naphthalenedicarboxylic acid, diphenyl-4,4′-dicarboxylic acid, and diphenoxyethanedicarboxylic acid and their functional derivatives.

Examples of the glycol component composing the polyester resin (2) of the present invention are aliphatic glycols such as ethylene glycol, 1,3-trimethylene glycol, and tetramethylene glycol and alicyclic glycols such as cyclohexanedimethanol.

Examples of a dicarboxylic acid as a copolymerization component used in the case the above-mentioned polyesters are copolymers are aromatic dicarboxylic acids such as isophthalic acid, diphenyl-4,4′-dicarboxylic acid, diphenoxyethanedicarboxylic acid, 4,4′-diphenyl ether dicarboxylic acid, and 4,4′-diphenyl ketone dicarboxylic acid and their functional derivatives; oxyacids such as p-oxybenzoic acid, oxycaproic acid, and 3-hydroxybutyric acid and their functional derivatives; aliphatic dicarboxylic acids such as adipic acid, sebacic acid, succinic acid, glutaric acid, and dimer acid and their functional derivatives; alicyclic dicarboxylic acid such as hexahydroterephthalic acid, hexahydroisophthalic acid, and cyclohexanedicarboxylic acid, and their functional derivatives.

Examples of a glycol as a copolymerization component used in the case the above-mentioned polyesters are copolymers are aliphatic glycols such as diethylene glycol, 1,3-trimethylene glycol, tetramethylene glycol, pentamethylene glycol, hexamethylene glycol, octamethylene glycol, decamethylene glycol, 2-ethyl-2-butyl-1,3-propanediol, neopentyl glycol, and dimer glycol; alicyclic glycols such as 1,2-cyclohexanediol, 1,4-cyclohexanediol, 1,1-cyclohexanedimethylol, 1,4-cyclohexanedimethylol, and 2,5-norbornanedimethylol; aromatic glycols such as xylylene glycol, 4,4′-dihydroxybiphenyl, 2,2-bis(4′-β-hydroxyethoxyphenyl)propane, bis(4-hydroxyphenyl)sulfone, bisphenol A alkylene oxide adducts; and polyalkylene glycol such as polyethylene glycol and polybutylene glycol.

Examples of a polyfunctional compound as a copolymerization component used in the case the above-mentioned polyesters are copolymers are, as an acid component, trimellitic acid and pyromellitic acid; as a glycol component, glycerin and pentaerythritol. Use amounts of these copolymerization components should be proper for the polyesters to substantially maintain to be linear. Further, a monofunctional compound such as benzoic acid and naphthoic acid may be copolymerized.

One preferable example of the polyester resin (2) of the present invention is polyesters composed of ethylene terephthalate as a main component unit and preferably copolymer polyesters containing 55% by mole or higher, more preferably 70% by mole or higher, of ethylene terephthalate unit and also containing isophthalic acid or 1,4-cyclohexanedimethanol as a copolymerization component, and particularly preferably polyester containing 90% by mole or higher of ethylene terephthalate.

Examples of these polyesters are polyethylene terephthalate (hereinafter, referred to as PET), poly(ethylene terephthalate-ethylene isophthalate) copolymers, poly(ethylene terephthalate-1,4-cyclohexanedimethylene isophthalate) copolymers, poly(ethylene terephthalate-dioxyethylene terephthalate) copolymers, poly(ethylene terephthalate-1,3-propylene terephthalate) copolymers, and poly(ethylene terephthalate-ethylene cyclohexylenedicarboxylate) copolymers.

Another preferable example of the polyester resin (2) of the present invention is polyesters containing ethylene-2,6-naphthalate as a main component unit and preferably 55% by mole or more of ethylene-2,6-naphthalate unit, more preferably 70% by mole or more of ethylene-2,6-naphthalate unit, and particularly preferably 90% by mole or more of ethylene-2,6-naphthalate unit.

Examples of these thermoplastic polyesters are polyethylene-2,6-naphthalate (PEN), poly(ethylene-2,6-naphthalate-ethylene terephthalate) copolymers, poly(ethylene-2,6-naphthalate-ethylene isophthalate) copolymers, and poly(ethylene-2,6-naphthalate-dioxyethylene naphthalate) copolymers.

Another preferable example of the polyester resin (2) of the present invention is polyesters containing 1,3-propylene terephthalate as a main component unit and preferably 55% by mole or more, preferably 70% by mole or more, of 1,3-propylene terephthalate unit, and particularly preferably 90% by mole or more of 1,3-propylene terephthalate unit.

Examples of these polyesters are polypropylene-terephthalate (PTT), poly(1,3-propylene-terenaphthalate-1,3-propylene terephthalate) copolymers, and poly(1,3-propylene-terenaphthalate-1,4-cyclohexanedimethylene terephthalate) copolymers.

Further another preferable example of the polyester resin (2) of the present invention is polyesters containing butylene terephthalate as a main component unit and preferably 55% by mole or more, preferably 70% by mole or more, of butylene terephthalate unit, and particularly preferably 90% by mole or more of butylene terephthalate unit.

Examples of these polyesters are polybutylene-terephthalate (PBT), poly(butylene-terenaphthalate-butylene isophthalate) copolymers, poly(butylene-terenaphthalate-1,4-cyclohexanedimethylene terephthalate) copolymers, poly(butylene-terenaphthalate-1,3-propylene terephthalate) copolymers, and poly(butylene-terenaphthalate-butylene cyclohexylenedicarboxylate) copolymers.

The polyester resin (2) of the present invention can be produced basically by a conventionally known melt polycondensation method or a solid-phase polymerization method of prepolymer produced by this method. The melt polycondensation method may be carried out in one stage or dividedly in multi-stages. These methods may be carried out by batch type reaction apparatus or continuous reaction apparatus. The melt polycondensation step and the solid-phase polymerization step may be carried out continuously or dividedly.

Hereinafter, one example of a preferable continuous production method of the polyester resin (2) of the present invention will be described while exemplifying polyethylene terephthalate (PET), however, the method should not be limited to the example. That is, the polyester is produced by a direct esterification method involving esterifying terephthalic acid, ethylene glycol, and if necessary, another copolymerizable component by direct reaction and removing water by distillation and successively carrying out polycondensation of the reaction product under reduced pressure in the presence of a polycondensation catalyst, or an transesterification method by reacting dimethyl terephthalate, ethylene glycol, and if necessary, another copolymerizable component and removing methyl alcohol by distillation and carrying out polycondensation under reduced pressure in the presence of a polycondensation catalyst. Further in order to increase the intrinsic viscosity or decrease the acetaldehyde content and lower cyclic trimer content for heat resistant containers for low flavor beverages and inner face films for metal cans for beverages, the polyester obtained by melting and polycondensing in the above-mentioned manner is successively polymerized by solid-phase polymerization.

As dimethyl terephthalate, terephthalic acid, or ethylene glycol as the above-mentioned starting raw materials, not only virgin terephthalic acid and terephthalate derived from paraxylene and ethylene glycol derived from ethylene but also recycled raw materials such as dimethyl terephthalateterephthalic acid, bishydroxyethyl terephthalate, and ethylene glycol recovered by chemical recycling method such as methanol decomposition or ethylene glycol decomposition of used PET bottles may be used for at least a portion of the starting materials. Needless to say, the above-mentioned recycled raw materials have to be refined to be pure or high grade depending on the use purposes.

The polycondensation reaction is carried out using a polycondensation catalyst. As the polycondensation catalyst are preferably employed mainly at least one compound selected from compounds containing at least one element selected from a group consisting of Ti, Al, Mn, Fe, Co, Zn, Nb, Mo, Cd, In, Sn, Ta, and Pb and if necessary at least one compound selected from second metal compounds such as Sb compounds and/or Ge compounds. It is particularly preferable to employ mainly at least one compound selected from compounds containing at least one element of Ti and Al and if necessary at least one compound selected from second metal compounds such as Sb compounds and/or Ge compounds.

These compounds are added in form of powders, aqueous solutions, ethylene glycol solutions, and ethylene glycol slurries to a reaction system.

Practical examples of Ti compounds are tetraalkyl titanate such as tetraethyl titanate, tetraisopropyl titanate, tetra-n-propyl titanate, and tetra-n-butyl titanate and their partially hydrolyzed products, titanium acetate, oxalic acid titanyl compounds such as titanyl oxalate, titanyl ammonium oxalate, titanyl sodium oxalate, titanyl potassium oxalate, titanyl calcium oxalate, titanyl strontium oxalate, titanium trimellitate, titanium sulfate, titanium chloride, hydrolyzed products of titanium halides, titanium bromide, titanium fluoride, potassium hexafluorotitanate, ammonium hexafluorotitanate, cobalt hexafluorotitanate, manganese hexafluorotitanate, titanium acetylacetonate, compounded oxides containing titanium together with silicon and zirconium, reaction products of titanium alkoxides and phosphorus compounds, and reaction products obtained by reacting reaction products of titanium alkoxides with aromatic polycarboxylic acids or their anhydrides and phosphorus compounds. The Ti compound is added in a proper amount to adjust the remaining Ti amount in the produced polymer in a range of 0.1 to 50 ppm.

Practical examples of Al compound may include carboxylic acid salts such as aluminum formate, aluminum acetate, basic aluminum acetate, aluminum propionate, aluminum oxalate, aluminum acrylate, aluminum laurate, aluminum stearate, aluminum benzoate, aluminum trichloroacetate, aluminum lactate, aluminum citrate, aluminum tartrate, and aluminum salicylate; inorganic acid salts such as aluminum chloride, aluminum hydroxide, aluminum hydroxide chloride, polyaluminum chloride, aluminum nitrate, aluminum sulfate, aluminum carbonate, aluminum phosphate, and aluminum phosphonate; aluminum alkoxides such as aluminum methoxide, aluminum ethoxide, aluminum n-propoxide, aluminum iso-propoxide, aluminum n-butoxide, and aluminum tert-butoxide; aluminum chelate compounds such as aluminum acetylacetonate, aluminum acetylacetate, aluminum ethylacetoacetate, and aluminum ethylacetoacetate di-iso-propoxide; organoaluminum compounds such as trimethylaluminum and triethylaluminum and their partial hydrolyzates thereof; aluminum oxide. Among them, carboxylic acid salts, inorganic acid salts, and chelating compounds are preferable and particularly basic aluminum acetate, aluminum chloride, aluminum hydroxide, aluminum hydroxide chloride, and aluminum acetylacetonate are particularly preferable. The Al compound is added in a proper amount to adjust the remaining Al amount in the produced polymer in a range of 5 to 200 ppm.

In the production method of the polyester resin (2) of the present invention, an alkali metal compound or an alkaline earth metal compound may be used in combination. As the alkali metal and alkaline earth metal, one or more metals selected from Li, Na, K, Rb, Cs, Be, Mg, Ca, Sr, and Ba are preferable, and alkali metals and their compounds are more preferable. In the case an alkali metal or it compound is used, particularly, use of Li, Na, and K is preferable. Examples of compounds of alkali metals and alkaline earth metals may include metal salts of acid, alkoxides such as methoxide, ethoxide, n-propoxide, iso-propoxide, n-butoxide, and tert-butoxide, chelate compounds such as acetylacetonate, and hydrides, oxides, and hydroxides. Acid which comprise metal salts of acid include; saturated aliphatic carboxylic acid such as formic acid, acetic acid, propionic acid, butyric acid, and oxalic acid; unsaturated aliphatic carboxylic acid such as acrylic acid and methacrylic acid; aromatic carboxylic acid such as benzoic acid; halogen-containing carboxylic acid such as trichloroacetic acid; hydroxycarboxylic acid such as lactic acid, citric acid, and salicylic acid; inorganic acid such as carbonic acid, sulfuric acid, nitric acid, phosphoric acid, phosphonic acid, hydrogen carbonate, hydrogen phosphate, hydrogen sulfide, sulfurous acid, thiosulfuric acid, hydrochloric acid, hydrobromic acid, chloric acid, and bromic acid; organic sulfonic acid such as 1-propanesulfonic acid, 1-pentanesulfonic acid, and naphthalenesulfonic acid; organic sulfuric acid such as laurylsulfuric acid.

The above-mentioned alkali metal compounds or alkaline earth metal compounds may be added in form of powders, aqueous solutions, and ethylene glycol solutions to a reaction system. The alkali metal compound or alkaline earth metal compound may be added in a proper amount to adjust these elements remaining in the produced polymer in a range of 1 to 100 ppm.

The polycondensation catalyst of the present invention is preferable to be used in combination with a phosphorus compound.

The P compound used in the invention is preferably at least one phosphorus compound selected from a group consisting of phosphonic acid-containing compounds, phosphinic acid-containing compounds, phosphine oxide-containing compounds, phosphorous acid-containing compounds, phosphonous acid-containing compounds, and phosphine-containing compounds. Upon polymerization of the polyester, use of these phosphorus compounds improves the effect of catalyst activity and thermal stability of the polyester. Among these compounds, if phosphonic acid-containing compounds are used, the effect of improving the catalyst activity and the effect of improving the thermal stability are significant and therefore the compounds are preferable. Among these compounds, if compounds having aromatic cyclic structures are used, the effect of improving the catalyst activity and the effect of improving the thermal stability are significant and therefore the compounds are preferable.

The phosphonic acid compounds, phosphinic acid compounds, phosphine oxide compounds, phosphonous acid compounds, phosphinous acid compounds, and phosphine compounds in the present inventions are the compounds having the structures defined by the following formulas (Formula 1) to (Formula 6)

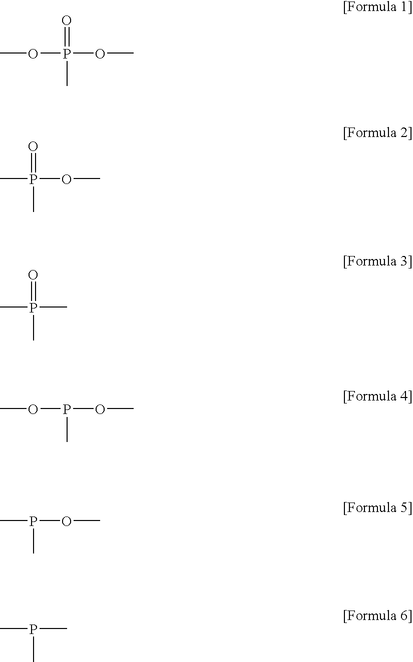

The phosphonic acid compounds used in the present inventions may include dimethyl methylphosphonate, diphenyl methylphosphonate, dimethyl phenylphosphonate, diethyl phenylphosphonate, diphenyl phenylphosphonate, dimethyl benzylphosphonate, and diethyl benzylphosphonate. The phosphinic acid compounds in the present inventions may include diphenylphosphinic acid, methyl diphenylphosphinate, phenyl diphenylphosphinate, phenylphosphinic acid, methyl phenylphosphinate, and phenyl phenylphosphinate. The phosphine oxide compounds in the present inventions may include diphenylphosphine oxide, methyldiphenylphosphine oxide, and triphenylphosphine oxide.

As phosphorus compounds in the present inventions among the phosphinic acid compounds, phosphine compounds, phosphonous acid compounds, phosphinous acid compounds, and phosphine compounds, the following compounds defined by the following formulas (Formula 7) to (Formula 12) are preferable.

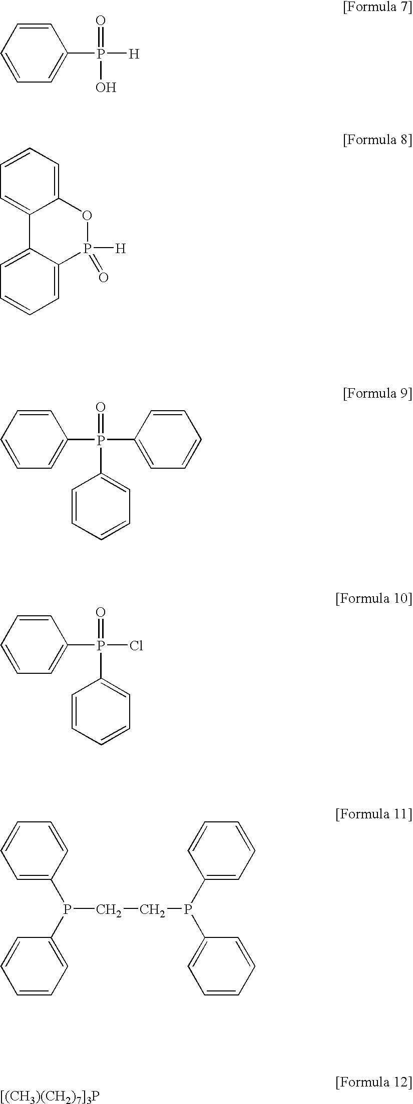

Among the above-mentioned phosphorus compounds, use of compounds having aromatic ring structure is preferable, since the effect of the physical property improvement and the effect of the catalytic activity improvement become considerably significant.

Also, use of the compounds defined by the following general formulas (Formula 13) and (Formula 15) is preferable as the phosphorus compounds of the invention, since the effect of the physical property improvement and the effect of the catalytic activity improvement become particularly significant.

P(═O)R¹(OR²)(OR³) [Formula 13]

P(═O)R¹R⁴(OR²) [Formula 14]

P(═O)R¹R⁵R⁶ [Formula 15]

(In the formulas (Formula 13) to (Formula 15), R¹, R⁴, R⁵, and R⁶ independently denote hydrogen, a hydrocarbon group of 1 to 50 carbon atoms, or a hydrocarbon group of 1 to 50 carbon atoms containing hydroxyl, a halogen group, an alkoxyl group, or an amino group. R² and R³ independently denote hydrogen, a hydrocarbon group of 1 to 50 carbon atoms, or a hydrocarbon group of 1 to 50 carbon atoms containing hydroxyl group or an alkoxyl group. Herein, hydrocarbon group may include alicyclic structure such as cyclohexyl and aromatic ring structure such as phenyl and naphthyl.)

The phosphorus compounds of the present inventions are particularly preferable to be compounds having aromatic ring structure for R¹, R⁴, R⁵, and R⁶ in the above-mentioned formulas (Formula 13) to (Formula 15).

The phosphorus compounds of the present inventions may include dimethyl methylphosphonate, diphenyl methylphosphonate, dimethyl phenylphosphonate, diethyl phenylphosphonate, diphenyl phenylphosphonate, dimethyl benzylphosphonate, diethyl benzylphosphonate, diphenylphosphinic acid, methyl diphenylphosphinate, phenyl diphenylphosphinate, phenylphosphinic acid, methyl phenylphosphinate, phenyl phenylphosphinate, diphenylphosphine oxide, methyldiphenylphosphine oxide, and triphenylphosphine oxide. Among them, dimethyl phenylphosphonate and diethyl benzylphosphonate are particularly preferable.

Among the above-mentioned phosphorus compounds, as a phosphorus compound used in the invention, phosphorus compounds having phenol part in the molecule are particularly preferable to be used. Examples of the phosphorus compounds having phenol part in the molecule are not particularly limited if the compounds are phosphorus compounds having phenol structure; however, it is preferable to employ one or more compounds selected from a group consisting of phosphonic acid-containing compounds, phosphinic acid-containing compounds, phosphine oxide-containing compounds, phosphorous acid-containing compounds, phosphonous acid-containing compounds, and phosphine-containing compounds, which have a phenol part in the molecule since use of these compounds significantly improves the catalytic activity. Among them, it is furthermore preferable to employ one or more compounds of phosphonic acid-containing compounds having a phenol part in a same molecule since use of them particularly significantly improves the catalytic activity.

Examples of the phosphorus compounds having phenol part in the molecule, employed in the invention, are preferably compounds defined by following general formulas (16) to (18) since use of these compounds particularly improves the catalytic activity.

P(═O)R¹(OR²)(OR³) [Formula 16]

P(═O)R¹R⁴(OR²) [Formula 17]

P(═O)R¹R⁵R⁶ [Formula 18]

(In the formulas (16) to (18), R¹ denotes a hydrocarbon group of 1 to 50 carbon atoms containing a phenol part or a hydrocarbon group of 1 to 50 carbon atoms containing a substituent group such as hydroxyl, halogen, alkoxyl, or amino group and also a phenol part; R⁴, R⁵, and R⁶ independently denote hydrogen, a hydrocarbon group of 1 to 50 carbon atoms, or a hydrocarbon group of 1 to 50 carbon atoms containing a substituent group such as hydroxyl, halogen, alkoxyl, or amino group; R² and R³ independently denote hydrogen, a hydrocarbon group of 1 to 50 carbon atoms, or a hydrocarbon group of 1 to 50 carbon atoms containing a substituent group such as hydroxyl or alkoxyl group; provided that the hydrocarbon group may include a branched structure, an alicyclic structure such as cyclohexyl, and an aromatic cyclic structure such as phenyl and naphthyl; and terminals of R² and R⁴ may be bonded with each other).

Examples of the phosphorus compounds having phenol portion within molecule of the present inventions may include p-hydroxyphenylphosphonic acid, dimethyl p-hydroxyphenylphosphonate, diethyl p-hydroxyphenylphosphonate, diphenyl p-hydroxyphenylphosphonate, bis(p-hydroxyphenyl)phosphonic acid, methyl bis(p-hydroxyphenyl)phosphonate, phenyl bis(p-hydroxyphenyl)phosphonate, p-hydroxyphenylphenylphosphinic acid, methyl p-hydroxyphenylphenylphosphinate, phenyl p-hydroxyphenylphenylphosphinate, p-hydroxyphenylphosphinic acid, methyl p-hydroxyphenylphosphinate, phenyl p-hydroxyphenylphosphinate, bis(p-hydroxyphenyl)phosphine oxide, tris(p-hydroxyphenyl)phosphine oxide, bis(p-hydroxyphenyl)methylphosphine oxide, and compounds defined by the following formulae (Formula 19) to (Formula 22). Among them, compounds defined by the following formula (Formula 21) and dimethyl p-hydroxyphenylphosphonate are particularly preferable.

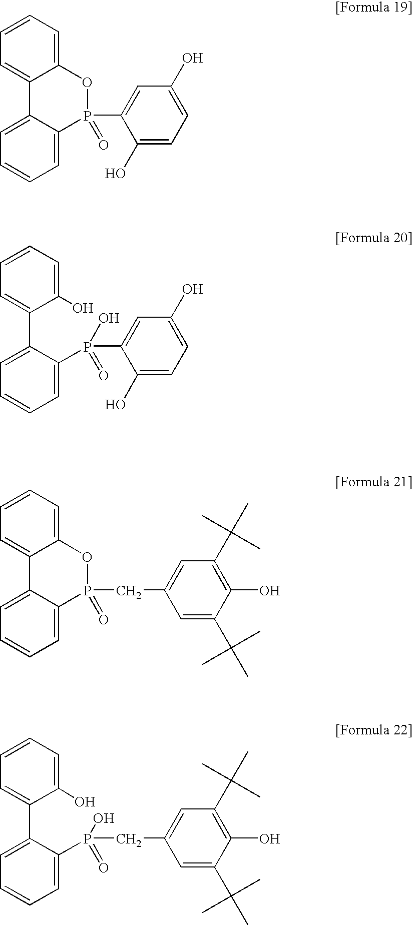

Usable compounds defined by the formula (Formula 21) may include SANKO-220 (manufactured by SANKO Co., Ltd.).

Addition of these phosphorus compounds having a phenol part in a simple molecule at the time of polymerization of the polyester improves the catalyst activity of the polycondensation catalyst and improves the thermal stability of the polymerized polyester.

Among the above-mentioned phosphorus compounds, metal salts of phosphorus are particularly preferable to be added as the phosphorus compound. Metal salts of phosphorus are not particularly limited and metal salts of phosphonic acid-containing compounds are preferable since they significantly improve the catalytic activity. The metal salts of phosphorus may include mono-metal salts, di-metal salts, and tri-metal salts.

Further, among the above-mentioned phosphorus compounds, if those which contain an element selected from Li, Na, K, Be, Mg, Sr, Ba, Mn, Ni, Cu, and Zn for metal parts of the metal salts are used, the effect of improving the catalytic activity is significant and therefore, they are preferable. Among them, Li, Na, and Mg are particularly preferable.

As a metal salt of phosphorus used in the invention, use of at least one compound selected from compounds defined by a following general formula (23) is preferable since the effect of improving the catalytic activity is significant.

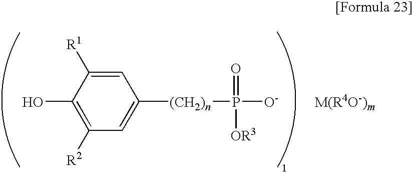

(In the formula (23), R¹ denotes hydrogen, a hydrocarbon group of 1 to 50 carbon atoms, or a hydrocarbon group of 1 to 50 carbon atoms containing hydroxyl, halogen, alkoxyl, or amino group; R² denotes hydrogen, a hydrocarbon group of 1 to 50 carbon atoms, or a hydrocarbon group of 1 to 50 carbon atoms containing hydroxyl or alkoxyl group; R³ denotes hydrogen, a hydrocarbon group of 1 to 50 carbon atoms, or a hydrocarbon group of 1 to 50 carbon atoms containing hydroxyl, alkoxyl, or carbonyl group; l denotes an integer of 1 or higher; m denotes 0 or an integer of 1 or higher; l+m is 4 or lower; M denotes a metal cation with (l+m) valence; n denotes an integer of 1 or higher; and the hydrocarbon group may include an alicyclic structure such as cyclohexyl, a branched structure, and an aromatic cyclic structure such as phenyl and naphthyl).

Examples of the above-mentioned R¹ may be phenyl, 1-naphthyl, 2-naphthyl, 9-anthryl, 4-biphenyl, and 2-biphenyl. Examples of the above-mentioned R² may be hydrogen, methyl, ethyl, propyl, isopropyl, n-butyl, sec-butyl, tert-butyl, along chain aliphatic group, phenyl, naphthyl, substituted phenyl and naphthyl groups, and —CH₂CH₂OH group. Examples of R³O⁻ may be hydroxide ion, alcoholate ion, acetate ion, and acetylacetone ion.

Among the compounds defined by the above-mentioned general formula (23), at least one selected from compounds defined by a following general formula (24) is preferable to be used.

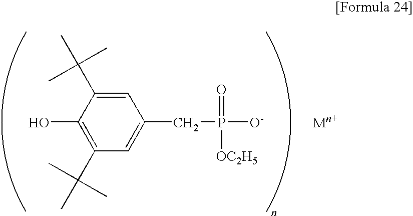

(In the formula (24), R¹ denotes hydrogen, a hydrocarbon group of 1 to 50 carbon atoms, or a hydrocarbon group of 1 to 50 carbon atoms containing hydroxyl, halogen, alkoxyl, or amino group; R³ denotes hydrogen, a hydrocarbon group of 1 to 50 carbon atoms, or a hydrocarbon group of 1 to 50 carbon atoms containing hydroxyl or alkoxyl group; l denotes an integer of 1 or higher; m denotes 0 or an integer of 1 or higher; l+m is 4 or lower; M denotes a metal cation with (l+m) valence; and the hydrocarbon group may include an alicyclic structure such as cyclohexyl, a branched structure, and an aromatic cyclic structure such as phenyl and naphthyl).

Examples of the above-mentioned R¹ may be phenyl, 1-naphthyl, 2-naphthyl, 9-anthryl, 4-biphenyl, and 2-biphenyl. Examples of R³O⁻ may be hydroxide ion, alcoholate ion, acetate ion, and acetylacetone ion.

If compounds having an aromatic cyclic structure are used among the above-mentioned phosphorus compounds, they can significantly improve the catalytic activity and therefore they are preferable.

Among the compounds defined by the above-mentioned formula (24), if those which have a metal selected from Li, Na, K, Be, Mg, Sr, Ba, Mn, Ni, Cu, and Zn for M are employed, the effect of improving the catalytic activity becomes significant and therefore they are preferable. Among them, Li, Na, and Mg are particularly preferable.

Examples of metal salts of phosphorus used in the invention are lithium [ethyl (1-naphthyl)methylphosphonate], sodium [ethyl (1-naphthyl)methylphosphonate], magnesium bis[ethyl (1-naphthyl)methylphosphonate], potassium [ethyl (2-naphthyl)methylphosphonate], magnesium bis[ethyl (2-naphthyl)methylphosphonate], lithium [ethyl benzylphosphonate], sodium [ethyl benzylphosphonate], magnesium bis[ethyl benzylphosphonate], beryllium bis[ethyl benzylphosphonate], strontium bis[ethyl benzylphosphonate], manganese bis[ethyl benzylphosphonate], sodium benzylphosphonate, magnesium bis[benzylphosphonate], sodium [ethyl (9-anthryl)methylphosphonate], magnesium bis[ethyl (9-anthryl)methylphosphonate], sodium [ethyl 4-hydroxybenzylphosphonate], magnesium bis[ethyl 4-hydroxybenzylphosphonate], sodium [phenyl 4-chlorobenzylphosphonate], magnesium bis[ethyl 4-chlorobenzylphosphonate], sodium [methyl 4-aminobenzylphosphonate], magnesium bis[methyl 4-aminobenzylphosphonate], sodium phenylphosphonate, magnesium bis[ethyl phenylphosphonate], and zinc bis[ethyl phenylphosphonate]. Among them, lithium [ethyl (1-naphthyl)methylphosphonate], sodium [ethyl (1-naphthyl)methylphosphonate], magnesium bis[ethyl (1-naphthyl)methylphosphonate], lithium [ethyl benzylphosphonate], sodium [ethyl benzylphosphonate], magnesium bis[ethyl benzylphosphonate], sodium benzylphosphonate, and magnesium bis[benzylphosphonate] are particularly preferable.

Among the above-mentioned phosphorus compounds, as the phosphorus compound, at least one compound selected from specified metal salt compounds of phosphorus defined by a following general formula (25) is particularly preferable to be used.

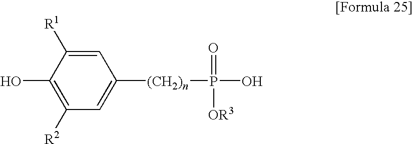

(In the formula (25), R¹ and R² independently denote hydrogen or a hydrocarbon group of 1 to 30 carbon atoms; R³ denotes hydrogen, a hydrocarbon group of 1 to 50 carbon atoms, or a hydrocarbon group of 1 to 50 carbon atoms containing hydroxyl or alkoxyl group; R⁴ denotes hydrogen, a hydrocarbon group of 1 to 50 carbon atoms, or a hydrocarbon group of 1 to 50 carbon atoms containing hydroxyl, alkoxyl, or carbonyl group; R⁴O⁻ denotes hydroxide ion, alcoholate ion, acetate ion, and acetylacetone ion; l denotes an integer of 1 or higher; m denotes 0 or an integer of 1 or higher; l+m is 4 or lower; M denotes a metal cation with (l+m) valence; n denotes an integer of 1 or higher; and the hydrocarbon group may include an alicyclic structure such as cyclohexyl, a branched structure, and an aromatic cyclic structure such as phenyl and naphthyl).

At least one compound selected from compounds defined by the following general formula (Formula 26) is particularly preferable among these compounds.

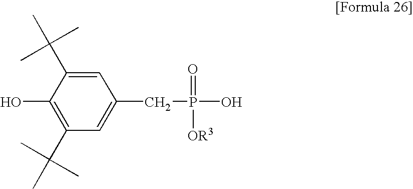

(In the formula (26), Mⁿ⁺ denotes a metal cation of n valence and n denotes 1, 2, 3, or 4).

Among the compounds defined by above-mentioned formula (25) or (26), if those which contain an element selected from Li, Na, K, Be, Mg, Sr, Ba, Mn, Ni, Cu, and Zn for M are used, the effect of improving the catalytic activity is significant and therefore, they are preferable. Among them, Li, Na, and Mg are particularly preferable.

Examples of specified metal salt compounds of phosphorus used in the invention may be lithium [ethyl 3,5-di-tert-butyl-4-hydroxybenzylphosphate], sodium [ethyl 3,5-di-tert-butyl-4-hydroxybenzylphosphate], sodium [3,5-di-tert-butyl-4-hydroxybenzylphosphate], potassium [ethyl 3,5-di-tert-butyl-4-hydroxybenzylphosphate], magnesium bis[ethyl 3,5-di-tert-butyl-4-hydroxybenzylphosphate], magnesium bis[3,5-di-tert-butyl-4-hydroxybenzylphosphate], beryllium bis[methyl 3,5-di-tert-butyl-4-hydroxybenzylphosphate], strontium bis[ethyl 3,5-di-tert-butyl-4-hydroxybenzylphosphate], barium bis[phenyl 3,5-di-tert-butyl-4-hydroxybenzylphosphate], manganese bis[ethyl 3,5-di-tert-butyl-4-hydroxybenzylphosphate], nickel bis[ethyl 3,5-di-tert-butyl-4-hydroxybenzylphosphate], copper bis[ethyl 3,5-di-tert-butyl-4-hydroxybenzylphosphate], and zinc bis[ethyl 3,5-di-tert-butyl-4-hydroxybenzylphosphate]. Among them, lithium [ethyl 3,5-di-tert-butyl-4-hydroxybenzylphosphate], sodium [ethyl 3,5-di-tert-butyl-4-hydroxybenzylphosphate], and magnesium bis[ethyl 3,5-di-tert-butyl-4-hydroxybenzylphosphate] are particularly preferable.

Among the above-mentioned phosphorus compounds, phosphorus compounds having at least one P—OH bond are particularly preferable used as the phosphorus compound in the present invention. Phosphorus compounds having at least one P—OH bond are not particularly limited as long as they are phosphorus compounds having at least one P—OH bond in a molecule. Among these phosphorus compounds, if the phosphorus compounds having at least one P—OH bond are used, the effect of improving the catalytic activity is significant and therefore, they are preferable.

Among these phosphorus compounds, if the phosphorus compounds having an aromatic ring structure are used, the effect of improving the catalytic activity is significant and therefore, they are preferable.

As a phosphorus compound having at least one P—OH bond used in the invention, at least one compound selected from compounds defined by a following general formula (27) is used, the effect of improving the catalytic activity is significant and therefore, it is preferable.

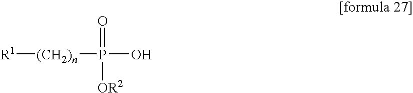

(In the formula (Formula 27), R¹ denotes hydrogen, a hydrocarbon group of 1 to 50 carbon atoms, or a hydrocarbon group of 1 to 50 carbon atoms containing hydroxyl group, a halogen group, an alkoxyl group, or an amino group. R² denotes hydrogen, a hydrocarbon group of 1 to 50 carbon atoms, or a hydrocarbon group of 1 to 50 carbon atoms containing hydroxyl group or an alkoxyl group. The reference character n denotes an integer of 1 or higher. Herein, the hydrocarbon group may include alicyclic structure such as cyclohexyl, branched structure, and aromatic ring structure such as phenyl and naphthyl.)

Examples of the above-mentioned R¹ may be phenyl, 1-naphthyl, 2-naphthyl, 9-anthryl, 4-biphenyl, and 2-biphenyl. Examples of the above-mentioned R² may be hydrogen, methyl, ethyl, propyl, isopropyl, n-butyl, sec-butyl, tert-butyl, along chain aliphatic group, phenyl, naphthyl, substituted phenyl and naphthyl, and a group defined as —CH₂CH₂OH.

Use of compounds having aromatic ring structure among these phosphorus compounds is preferable, since the effect of the effect of the catalytic activity improvement become significant.

Examples of phosphorus compounds having at least one P—OH bond may be ethyl (1-naphthyl)methylphosphonate, (1-naphthyl)methylphosphonic acid, ethyl (2-naphthyl)methylphosphonate, ethyl benzylphosphonate, benzylphosphonic acid, ethyl (9-anthryl)methylphosphonate, ethyl 4-hydroxybenzylphosphonate, ethyl 2-methylbenzylphosphonate, phenyl 4-chlorobenzylphosphonate, methyl 4-aminobenzylphosphonate, and ethyl 4-methoxybenzylphosphonate. Among them are ethyl (1-naphthyl)methylphosphonate and ethyl benzylphosphonate particularly preferable.

Among the above-mentioned phosphorus compounds, a specified phosphorus compound having at least one P—OH bond is particularly preferable used as the phosphorus compound in the present invention. The specified phosphorus compound having at least one P—OH bond is at least one compound selected from compounds defined by a following general formula (28).

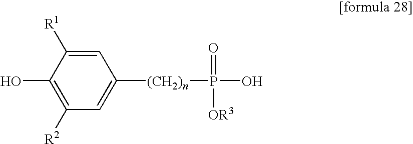

(In the formula (Formula 28), R¹ and R² independently denote hydrogen or a hydrocarbon group of 1 to 30 carbon atoms. R³ denotes hydrogen, a hydrocarbon group of 1 to 50 carbon atoms, or a hydrocarbon group of 1 to 50 carbon atoms containing hydroxyl group or an alkoxyl group. The reference character n denotes an integer of 1 or higher. The hydrocarbon group may include alicyclic structure such as cyclohexyl, branched structure, and aromatic ring structure such as phenyl and naphthyl.)

At least one compound selected from compounds defined by the following general formula (Formula 29) is particularly preferable among these compounds.

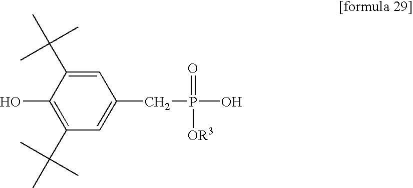

(In the formula (29), R³ denotes hydrogen, a hydrocarbon group of 1 to 50 carbon atoms, or a hydrocarbon group of 1 to 50 carbon atoms containing hydroxyl or alkoxyl group; the hydrocarbon group may include an alicyclic structure such as cyclohexyl, a branched structure, and an aromatic cyclic structure such as phenyl and naphthyl).

Examples of the above-mentioned R³ may be hydrogen, methyl, ethyl, propyl, isopropyl, n-butyl, sec-butyl, tert-butyl, a long chain aliphatic, phenyl, naphthyl, substituted phenyl and naphthyl, and —CH₂CH₂OH groups.

Examples of the specified phosphorus compound having at least one P—OH bond used in the present invention are ethyl 3,5-di-tert-butyl-4-hydroxybenzylphosphonate, methyl 3,5-di-tert-butyl-4-hydroxybenzylphosphonate, isopropyl 3,5-di-tert-butyl-4-hydroxybenzylphosphonate, phenyl 3,5-di-tert-butyl-4-hydroxybenzylphosphonate, octadecyl 3,5-di-tert-butyl-4-hydroxybenzylphosphonate, and 3,5-di-tert-butyl-4-hydroxybenzylphosphonnic acid. Among them, ethyl 3,5-di-tert-butyl-4-hydroxybenzylphosphonate and methyl 3,5-di-tert-butyl-4-hydroxybenzylphosphonate are particularly preferable.

Phosphorus compounds defined by the following chemical formula (Formula 30) are exemplified as preferable phosphorus compounds of the present inventions.

R¹—CH₂—P(═O)(OR²)(OR³) [Formula 30]

(In the formula (Formula 30), R¹ denotes a hydrocarbon group of 1 to 49 carbon atoms, or a hydrocarbon group of 1 to 49 carbon atoms containing hydroxyl group, a halogen group, an alkoxyl group, or an amino group. R² and R³ independently denote hydrogen, a hydrocarbon group of 1 to 50 carbon atoms, or a hydrocarbon group of 1 to 50 carbon atoms containing hydroxyl group or an alkoxyl group. The hydrocarbon group may include alicyclic structure, branched structure, and aromatic ring structure.)

Further preferable compounds are those having aromatic ring structure for at least one of R¹, R², and R³ in the chemical formula (Formula 30).

Practical examples of the phosphorus compounds are as follows.

Further preferably, at least one of R¹, R², and R³ in the chemical formula (30) is a compound having an aromatic ring structure.

Practical examples of these phosphorus compounds will be shown below.

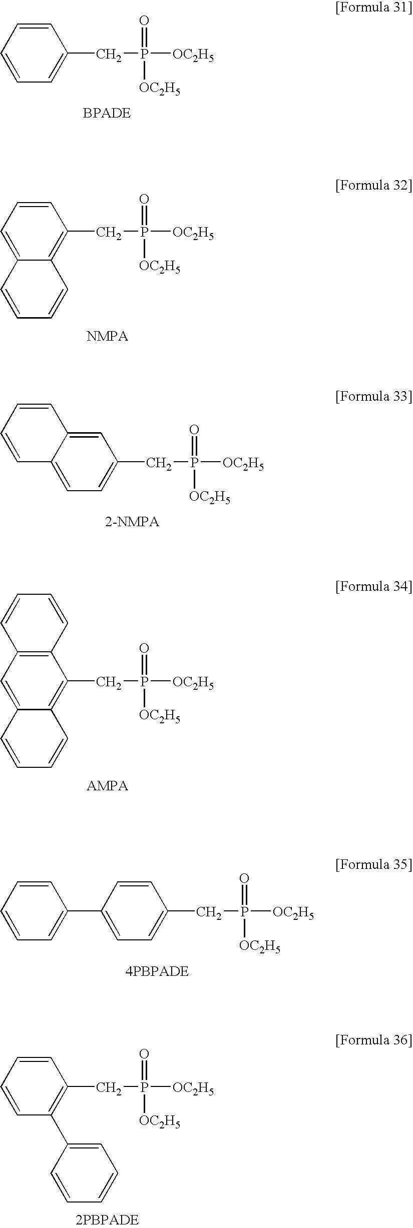

Also, the phosphorus compounds of the present inventions are preferably those having a high molecular weight as they are hard to be distilled in polymerization and thus effective.

In the invention, among the above-mentioned phosphorus compounds, it is preferable to use at least one phosphorus compound selected from the specified phosphorus compounds defined by a following general formula (37).

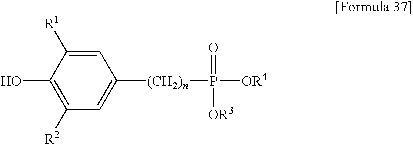

(In the formula (Formula 37), R¹ and R² independently denote hydrogen or a hydrocarbon group of 1 to 30 carbon atoms. R³ and R⁴ independently denote hydrogen, a hydrocarbon group of 1 to carbon atoms, or a hydrocarbon group of 1 to 50 carbon atoms containing hydroxyl group or an alkoxyl group. The reference character n denotes an integer of 1 or higher. The hydrocarbon group may include alicyclic structure such as cyclohexyl, branched structure, and aromatic ring structure such as phenyl and naphthyl.)

Use of at least one compound selected from compounds defined by the following general formula (Formula 38) among those compounds defined by the formula (Formula 37) is preferable, since the effect of the catalytic activity improvement become considerably significant.

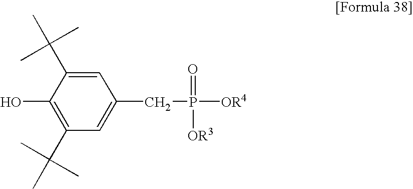

(In the formula (Formula 38), R³ and R⁴ independently denote hydrogen, a hydrocarbon group of 1 to 50 carbon atoms, or a hydrocarbon group of 1 to 50 carbon atoms containing hydroxyl group or an alkoxyl group. The hydrocarbon group may include alicyclic structure such as cyclohexyl, branched structure, and aromatic ring structure such as phenyl and naphthyl.)

Examples of groups denoted by R³ and R⁴ are hydrogen, short chain aliphatic groups such as methyl and butyl; long chain aliphatic groups such as octadecyl; aromatic groups such as phenyl and naphthyl, substituted phenyl and naphthyl, and a group defined as —CH₂CH₂OH.

Examples of the specified phosphorus compounds used in the present inventions may include diisopropyl 3,5-di-tert-butyl-4-hydroxybenzylphosphonate, di-n-butyl 3,5-di-tert-butyl-4-hydroxybenzylphosphonate, dioctadecyl 3,5-di-tert-butyl-4-hydroxybenzylphosphonate, and diphenyl 3,5-di-tert-butyl-4-hydroxybenzylphosphonate. Among them dioctadecyl 3,5-di-tert-butyl-4-hydroxybenzylphosphonate and diphenyl 3,5-di-tert-butyl-4-hydroxybenzylphosphonate particularly are preferable.

At least one phosphorus compound selected from compounds defined by the following general formulas (Formula 39) and (Formula 40) is particularly preferable among the phosphorus compounds having phenol portion within molecule of the present inventions.

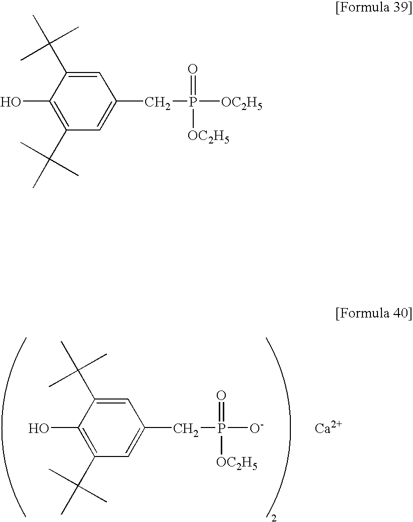

Irganox 1222 (manufactured by Ciba Specialty Chemicals K.K.) is commercialized as a compound defined by the above-mentioned chemical formula (Formula 39) and Irganox 1425 (manufactured by Ciba Specialty Chemicals K.K.) is commercialized as a compound defined by the above-mentioned chemical formula (Formula 40) and both are usable.

As the aluminum compound or phosphorus compound used in the invention, it is preferable to use at least one compound selected from aluminum salts of phosphorus compounds.

The aluminum salts of phosphorus compounds are not particularly limited as long as they are phosphorus compounds having an aluminum part, however, if aluminum salts of phosphonic acid-containing compounds are used, the effect of improving the catalytic activity is significant and therefore, these compounds are preferable. The aluminum salts of phosphorus compounds may include mono-aluminum salts, di-aluminum salts, and tri-aluminum salts.

If compounds having an aromatic ring structure among the above-mentioned aluminum salts of phosphorus compounds are used, the effect of improving the catalytic activity is significant and therefore, these compounds are preferable.

As the aluminum salts of phosphorus compounds used in the present invention, if at least one phosphorus compound selected from compounds defined by a following general formula (41) is used, the effect of improving the catalytic activity is significant and therefore, it is preferable.

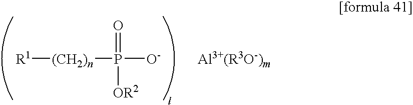

(In the formula (48), R¹ represents hydrogen, a C1-50 hydrocarbon group, or a C1-50 hydrocarbon group containing a hydroxyl group, halogen group, alkoxyl group or amino group; R² represents hydrogen, a C1-50 hydrocarbon group, or a C1-50 hydrocarbon group containing a hydroxyl group or alkoxyl group; R³ represents hydrogen, a C1-50 hydrocarbon group, or a C1-50 hydrocarbon group containing a hydroxyl group, alkoxyl group or carbonyl; l is an integer of 1 or more, m is 0 or an integer of 1 or more, and l+m is 3; n is an integer of 1 or more; and the hydrocarbon group may contain an alicyclic structure or branched structure such as cyclohexyl and an aromatic ring structure such as phenyl and naphthyl.)

In the above general formula, R¹ includes e.g. phenyl, 1-naphthyl, 2-naphthyl, 9-anthryl, 4-biphenyl, 2-biphenyl etc. In the above general formula, R² includes e.g. hydrogen, a methyl group, ethyl group, propyl group, isopropyl group, n-butyl group, sec-butyl group, tert-butyl group, long aliphatic group, phenyl group, naphthyl group, substituted phenyl group and naphthyl group, and the group —CH₂CH₂OH. The above R³O⁻ includes e.g. a hydroxide ion, alcoholate ion, ethylene glycolate ion, acetate ion and acetyl acetone ion.

The aluminum salt of a phosphorus compound in this invention includes an aluminum salt of ethyl (1-naphthyl)methylphosphonate, an aluminum salt of (1-naphthyl)methylphosphonic acid, an aluminum salt of ethyl (2-naphthyl)methylphosphonate, an aluminum salt of ethyl benzyl benzylphosphonate, an aluminum salt of benzylphosphonic acid, an aluminum salt of ethyl (9-anthryl)methylphosphonate, an aluminum salt of ethyl 4-hydroxybenzylphosphonate, an aluminum salt of ethyl 2-methylbenzylphosphonate, an aluminum salt of phenyl 4-chlorobenzylphosphonate, an aluminum salt of methyl 4-aminobenzylphosphonate, an aluminum salt of ethyl 4-methoxybenzylphosphonate and an aluminum salt of ethyl phenylphosphonate. Among these, an aluminum salt of ethyl (1-naphthyl)methylphosphonate and an aluminum salt of ethyl benzylphosphonate are particularly preferable.

As the aluminum salts of phosphorus compounds used in the present invention, it is particularly preferable to use one phosphorus compound selected from compounds defined by a following general formula (42).

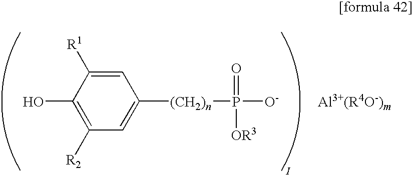

(In the formula (42), R¹ and R² independently represent hydrogen or a C1-30 hydrocarbon group; R³ represents hydrogen, a C1-50 hydrocarbon group, or a C1-50 hydrocarbon group containing a hydroxyl group or alkoxyl group; R⁴ represents hydrogen, a C1-50 hydrocarbon group, or a C1-50 hydrocarbon group containing a hydroxyl group, alkoxyl group or carbonyl; l is an integer of 1 or more, m is 0 or an integer of 1 or more, and l+m is 3; n is an integer of 1 or more; and the hydrocarbon group may contain an alicyclic structure or branched structure such as cyclohexyl and an aromatic ring structure such as phenyl and naphthyl.)

Among these, at least one member selected from the compounds represented by the general formula (43) below is preferably used.

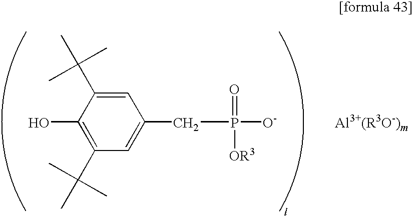

(In the above formula (43), R³ represents hydrogen, a C1-50 hydrocarbon group, or a C1-50 hydrocarbon group containing a hydroxyl group or alkoxyl group; R⁴ represents hydrogen, a C1-50 hydrocarbon group, or a C1-50 hydrocarbon group containing a hydroxyl group, alkoxyl group or carbonyl; l is an integer of 1 or more, m is 0 or an integer of 1 or more, and l+m is 3; and the hydrocarbon group may contain an alicyclic structure or branched structure such as cyclohexyl and an aromatic ring structure such as phenyl and naphthyl.)

In the above general formula, R³ includes e.g. hydrogen, a methyl group, ethyl group, propyl group, isopropyl group, n-butyl group, sec-butyl group, tert-butyl group, long aliphatic group, phenyl group, naphthyl group, substituted phenyl group and naphthyl group, and the group —CH2CH2OH. The above R4O— includes e.g. a hydroxide ion, alcoholate ion, ethylene glycolate ion, acetate ion and acetyl acetone ion.

The aluminum salt of a specific phosphorus compound in this invention includes an aluminum salt of ethyl 3,5-di-tert-butyl-4-hydroxybenzylphosphonate, an aluminum salt of methyl 3,5-di-tert-butyl-4-hydroxybenzylphosphonate, an aluminum salt of isopropyl 3,5-di-tert-butyl-4-hydroxybenzylphosphonate, an aluminum salt of phenyl 3,5-di-tert-butyl-4-hydroxybenzylphosphonate, and an aluminum salt of 3,5-di-tert-butyl-4-hydroxybenzylphosphonic acid. Among these, an aluminum salt of ethyl 3,5-di-tert-butyl-4-hydroxybenzylphosphonate and an aluminum salt of methyl 3,5-di-tert-butyl-4-hydroxybenzylphosphonate are particularly preferable.

A second metal compound usable for producing the polyester resin (2) of the present invention includes lithium, sodium, magnesium, calcium, antimony, germanium, tin, cobalt, manganese, zinc, niobium, tantalum, indium, zirconium, hafnium, silicon, iron, nickel, gallium and their compounds.

Use of these compounds for co-existence in a range of the addition amount to the extent that the addition does not cause any problems described above of a product such as characteristics, processability, and color tone of the polyester resin (2) is effective to improve the productivity by shortening the polycondensation time and therefore, it is preferable.

Practical examples of the Sb compounds are antimony trioxide, antimony acetate, antimony tartarate, antimony potassium tartarate, antimony oxychloride, antimony glycolate, diantimony pentoxide, and triphenyl antimony. The Sb compounds are preferable added in a proper amount to adjust the remaining Sb element amount in the polyester resin (2) obtained by polymerization to be preferably in a range of 150 ppm or lower, more preferably 100 ppm or lower, and even more preferably 50 ppm or lower. If the remaining Sb element amount exceeds 150 ppm, the transparency of the obtained molded article is worsened and therefore, it is not preferable.

Practical examples of Ge compounds are amorphous germanium dioxide, crystalline germanium dioxide, germanium tetraoxide, germanium hydroxide, germanium oxalate, germanium chloride, germanium tetraethoxide, germanium tetra-n-butoxide, and germanium phosphite. The Ge compounds are preferable added in a proper amount to adjust the remaining Ge element amount in the polyester resin (2) obtained by polymerization to be preferably in a range of 30 ppm or lower, more preferably 20 ppm or lower, and even more preferably 10 ppm. If the remaining amount of Ge element exceeds 30 ppm, it results in disadvantage in terms of the cost and therefore, it is not preferable.

The melted polycondensed polyester obtained in the above-mentioned manner is formed into chips with a column-like, spherical, block-like, or plate-like shape by a method of extruding the melt polyester through a dice fine pore into water and cutting it in water or a method of extruding it in strand shape in air through a dice fine pore and chipping the strand while cooling it with cooling water.

Further, it is preferable to use cooling water satisfying at least one of the above-mentioned (1) to (4) as the cooling water used for chipping the above-mentioned melted polycondensed polyester and more preferable to use water satisfying all of the (1) to (4).

The intrinsic viscosity of the polyester resin (2) of the present invention, particularly the polyester resin (2) composed of ethylene terephthalate as a main repeating unit, is desirable to be in a range of 0.55 to 1.50 dl/g, preferably 0.60 to 1.30 dl/g, more preferably 0.65 to 1.00 dl/g, and even more preferably 0.70 to 0.85 dl/g. If the intrinsic viscosity of the polyester resin is less than 0.55 dl/g, the mechanical characteristics of the obtained molded article are worsened. Further, if the intrinsic viscosity of the polyester resin exceeds 1.50 dl/g, the resin temperature is increased at melting stage by a molding apparatus and thermal decomposition is intensified to increase free low molecular weight compounds which cause an effect on the smell preservation or problems such as yellowing discoloration of the molded article.

Further, the intrinsic viscosity of the polyester resin (2) of the present invention, particularly the polyester resin (2) composed of 1,3-propylene terephthalate as a main repeating unit, is desirable to be in a range of 0.50 to 1.30 dl/g, preferably 0.55 to 1.20 dl/g, and more preferably 0.60 to 1.00 dl/g. If the intrinsic viscosity of the polyester resin is less than 0.50 dl/g, the elastic recovery and durability the obtained molded article are worsened to result in problems. On the other hand, the upper limit of the intrinsic viscosity is 1.30 dl/g and in the case it exceeds the upper limit, the resin temperature is increased upon producing the molded article, thermal decomposition is intensified to considerably decrease the molecular weight, and problems such as yellowing discoloration may be caused.

Further, the intrinsic viscosity of the polyester resin (2) of the present invention, particularly the polyester resin (2) composed of ethylene-2,6-naphthalate as a main repeating unit, is desirable to be in a range of 0.40 to 1.00 dl/g, preferably 0.42 to 0.90 dl/g, and more preferably 0.45 to 0.80 dl/g. If the IV is less than 0.40 dl/g, the mechanical characteristics of the obtained molded article are worsened. Further, if it exceeds 1.00 dl/g, it is required to increase the resin temperature at melting stage by a molding apparatus and it is accompanied with thermal decomposition to increase free low molecular weight compounds which cause an effect on the smell preservation or problems such as yellowing discoloration of the molded article.

The content of cyclic ester oligomers of the polyester resin (2) of the present invention is 70% or lower, preferably 60% or lower, more preferably 50% or lower, and even more preferably 35% or lower relative to the content of the cyclic ester oligomers in the melted polycondensate of the above-mentioned polyester. The lower limit of the content of cyclic ester oligomers is 20% or higher, preferably 22% or higher, and more preferably 25% or higher relative to the content of the cyclic ester oligomers contained in the melted polycondensate in terms of economical production. The content of the cyclic ester oligomers in the melted polycondensate of the polyester resin (2) means the highest content of the cyclic oligomers of n monomer units among several types of free cyclic ester oligomers existing in the melted polycondensate of polyester resin (2) having a number average molecular weight of about 5000 or higher.

In the case the polyester resin (2) of the present invention is PET, which is a representative polyester containing ethylene terephthalate as a main component unit, the cyclic oligomer of n monomer units means a cyclic trimer and since the content of the cyclic trimer in the melted and polycondensed polyester is about 1.0% by weight, the content of the cyclic trimer is preferably 0.70% by weight, more preferably 0.50% by weight, and even more preferably 0.40% by weight. In the case a heat resistant hollow molded article is produced from the polyester resin composition of the present invention, heat treatment is carried out in a heated mold, and in the case the content of the cyclic trimer is 0.70% by weight or higher, oligomer adhesion to the heated mold surface is sharply increased and the transparency of the obtained hollow molded article is very much worsened.

The polyester resin (2) of the present invention is a polyester resin in which the increase amount of the cyclic ester oligomer content upon injection molding is 100 ppm or higher and it means, in the case of a polyester resin produced in commercialized production scale, the polycondensation catalyst exists in the polyester in a state that it is scarcely deactivated without being contact treatment with water.

The content of dialkylene glycol copolymerized in the polyester resin (2) of the present invention is desirable to be 0.5 to 7.0% by mole, preferably 1.0 to 6.0% by mole, and more preferably 1.0 to 5.0% by mole relative to the glycol component composing the above-mentioned polyester. In the case the dialkylene glycol amount exceeds 7.0% by mole, the heat stability is worsened and the molecular weight is decreased at molding stage and the content of aldehydes is increased and therefore, it is not preferable. In the case of producing a polyester with a dialkylene glycol content of 0.5% by mole, it is required to select non-economical production conditions as transesterification reaction conditions, esterification conditions, or polymerization conditions and therefore, it is not profitable in terms of the cost. Herein, in the case of the polyester in which the main component unit is ethylene terephthalate, the dialkylene glycol copolymerized in the polyester is diethyleneglycol (hereinafter, referred to as DEG) copolymerized in the above-mentioned polyester among diethylene glycols produced by side reaction upon producing the polyester from ethylene glycol, which is a glycol, and in the case of the polyester in which the main components unit is 1,3-propylene terephthalate, the dialkylene glycol copolymerized in the polyester is di(1,3-propylene glycol) (hereinafter, referred to as DPG) copolymerized in the above-mentioned polyester among di(1,3-propylene glycol) (or bis(3-hydroxypropyl)ether) produced by side reaction upon producing the polyester from 1,3-propylene glycol, which is a glycol.

The content of the diethylene glycol copolymerized in the polyester resin (2) of the present invention, particularly the polyester comprising ethylene terephthalate as a main repeating unit, is 1.0 to 5.0% by mole, preferably 1.3 to 4.5% by mole, and more preferably 1.5 to 4.0% by mole relative to the glycol component composing the above-mentioned polyester resin. If the diethylene glycol content exceeds 5.0% by mole, the heat stability is worsened and the molecular weight is decreased significantly at molding stage and the content of aldehydes is increased high and therefore, it is not preferable. In the case the diethylene glycol content is less than 1.0% by mole, the transparency of the obtained molded article is worsened.

The content of aldehydes, such as acetaldehyde, of the polyester resin (2) of the present invention is desirable to be 50 ppm or lower, preferably 30 ppm or lower, and more preferably 10 ppm or lower. Particularly, in the polyester resin composition of the present invention is used as a material of containers for low flavor beverages such as mineral water, the content of aldehydes of the polyester is desirably 8 ppm or lower, preferably 6 ppm or lower, and more preferably 5 ppm or lower. If the content of aldehydes exceeds 50 ppm, the effect of taste preservation of the molded article produced from the polyester resin composition for the contents in the molded article is worsened. Further, their lower limit is preferable to be 0.1 ppb in terms of production. Herein, the aldehydes may be acetaldehyde in the case the polyester comprises ethylene terephthalate as a main component unit and allyl aldehyde in the case the polyester comprises 1,3-propylene terephthalate as a main component.

For taste preservation of the molded article produced from the polyester resin composition of the present invention, the polyester resin (2) of the present invention is preferably a polyester resin which a free aromatic dicarboxylic acid content derived from the above-mentioned polyester is 20 ppm or lower, a free glycol content is 50 ppm or lower, the content of free aromatic dicarboxylic acid monoglycol ester is 70 ppm or lower, and the content of free aromatic dicarboxylic acid diglycol ester is 100 ppm or lower.

As a method for producing such a polyester resin (2), the following methods can be employed. That is, a method of carrying out solid-phase polymerization of a polyester prepolymer, which is obtained by solution polymerization, having IV of 0.40 to 0.60 can be employed. Further, a method of heat treating the polyester with a prescribed IV under reduced pressure and inert gas atmosphere in condition in which IV is not substantially changed can be employed. Further, a method of carrying out heat treatment of the polyester resin with an organic solvent such as chloroform can be employed.

The content of fines in the polyester resin (2) of the present invention is desirable to be 0.1 to 5000 ppm, preferably 0.1 to 3000 ppm, more preferably 0.1 to 1000 ppm, furthermore preferably 0.1 to 500 ppm, and even more preferably 0.1 to 100 ppm. If the mixing amount is less than 0.1 ppm, the crystallization speed is very slow and the crystallization of a mouth part of a hollow molded container becomes insufficient and the shrinkage degree of the mouth part cannot be within a range of a defined value to make capping impossible or the stains of a stretching and thermally fixing mold for molding a heat resistant hollow molded container are very awful and the mold has to be wiped frequently in order to obtain a transparent hollow molded container. On the other hand, if it exceeds 5000 ppm, the crystallization speed is increased beyond necessity and the speed is fluctuated significantly. Accordingly, the crystallization degree of the mouth part of the hollow molded article becomes excess and is fluctuated significantly and therefore, the shrinkage degree of the mouth part cannot be within a defined range and capping of the mouth part becomes defective to cause leakage of the contents out of the container or the preliminarily molded article for the hollow molded article is whitened to make normal stretching impossible. Particularly if the polyester resin (2) is used for the polyester resin for the hollow molded article, the fine content is preferably 0.1 to 500 ppm.

If the polyester resin (2) of the present invention is a polyester resin containing ethylene terephthalate as a main repeating unit, it is preferable that the haze of a molded article with a thickness of 5 mm obtained by injection molding the resin is 30% or lower, preferably 20% or lower, and more preferably 10% or lower and the crystallization temperature (Tc1) upon increasing the temperature is 140 to 180° C., preferably 145 to 175° C., and more preferably 150 to 170° C.

The shape of chips of the polyester resin (2) of the present invention may by cylinder type, block type, spherical, or flat plate-like shape. Their average particle diameter is generally in a range of 1.0 to 4 mm, preferably 1.0 to 3.5 mm, and more preferably 1.0 to 3.0 mm. For example, in the case of the cylinder type, those with a length of 1.0 to 4 mm and a diameter of 1.0 to 4 mm are practically usable. In the case of spherical particles, those with the maximum particle diameter 1.1 to 2.0 times as large as the average particle diameter and the minimum particle diameter at least 0.7 times as large as the average particle diameter are practically usable. The average weight of the chips is in a range of 2 to 40 mg per a chip for practical use. Further, if it is required to improve the solid-phase polymerization speed or efficiently decrease the content of aldehydes, it is also preferable to adjust the average weight of chips to be 1 to 5 mg per a chip.

### (Polyester Resin Composition)

The polyester resin composition of the present invention is a polyester resin composition containing the above-mentioned polyester resin (1) and the above-mentioned polyester resin (2) as main components. The mixing ratio of the above-mentioned polyester resin (1) and the above-mentioned polyester resin (2) composing the polyester resin composition of the present invention is preferably 0.01 parts by weight to 10 parts by weight of the above-mentioned polyester resin (1) relative to 100 parts by weight of the above-mentioned polyester resin (2). If the addition amount of the above-mentioned polyester resin (1) is less than 0.01 parts by weight, the polycondensation catalyst contained in the polyester resin (2) cannot be sufficiently deactivated, and the content of aldehydes in the obtained molded article is considerably increased and it causes an effect on the taste preservation to result in a problem. Further, the content of cyclic ester oligomers in the obtained molded article is considerably increased to awfully stain a mold at continuous molding stage. Consequently, there occurs a problem that it becomes impossible to obtain a molded article with excellent transparency. Further, if the addition amount of the above-mentioned polyester resin (1) exceeds 10 parts by weight, the heat resistance of the obtained molded article is worsened and the yellowing discoloration occurs to result in a problem of reduction of commodity value.

Preferable combinations of catalysts used mainly for the polyester resin composition of the present invention are as follows.

| polyester resin (1) | polyester resin (2) |
|---|---|
| Ge | Al |
| Ge | Ti |
| Sb | Al |
| Sb | Ti |

The polyester resin (1) and the polyester resin (2) are preferable to have resin compositions consisting of same main components to an extent that the compatibility does not become a matter.

In the case of using a polyester resin composition for a hollow molded article whose transparency is regarded to be important, the polyester resin (1) and the polyester resin (2) are preferable to have substantially the same resin compositions. Herein, the phrase “substantially the same resin compositions” means that the difference of the compositions is 10% by mole or less, preferably 8% by mole or less, more preferably 6% by mole or less, further preferably 4% by mole or less, furthermore preferably 3% by mole or less, and even more preferably 2% by mole or less. In the case of dialkylene glycol derived from alkylene glycol used in the polyester resin (1) and the polyester resin (2), the difference of the compositions may be 15% by mole or less, preferably 12% by mole or less, more preferably 10% by mole or less, further preferably 8% by mole or less, furthermore preferably 6% by mole or less, and even more preferably 5% by mole or less.

Further, in the case the content of a cyclic ester oligomer of a molded article obtained by injection molding of the polyester resin composition of the present invention is defined as Aₜ ppm and the content of a cyclic ester oligomer of the polyester resin composition before the injection molding is defined as A₀ ppm, Aₜ−A₀ is preferably less than 300 ppm, more preferably less than 200 ppm, and even more preferably 100 ppm or less. The lower limit value of Aₜ−A₀ is 5 ppm in terms of the economic productivity.

Further, in the case the content of a cyclic trimer of a molded article obtained by injection molding of the polyester resin composition of the present invention is defined as Aₜ ppm and the content of a cyclic trimer of the polyester resin composition before the injection molding is defined as A₀ ppm, Aₜ−A₀ is preferably less than 300 ppm and more preferably less than 200 ppm.

If Aₜ−A₀ is less than 500 ppm, long time molding is made possible without causing problems of staining and clogging of gas discharge port of a molded apparatus, a melted resin discharge port, and a molding mold, and a polyester molded article with good transparency can be obtained. However, if Aₜ−A₀ exceeds 500 ppm, staining and clogging of gas discharge port of a molded apparatus become intense and it becomes difficult to carryout long time molding. In the case of a hollow molding article, the transparency is significantly worsened to be a problem.

The content of aldehyde in the polyester resin composition of the present invention is 50 ppm or lower, preferably 30 ppm or lower, more preferably 10 ppm or lower, and even more preferably 5 ppm or lower. If the content of aldehydes is 50 ppm or higher, the taste and smell of the contents in a container produced by molding the polyester resin composition are worsened. Particularly, in the case the polyester resin (2) of the present invention is a polyester resin containing ethylene terephthalate as a main repeating unit and the above-mentioned polyester resin composition composed of the resin is used as a material for containers for low flavor beverages such as mineral water, the content of aldehyde in the polyester resin composition of the present invention is 10 ppm or lower, preferably 8 ppm or lower, more preferably 6 ppm or lower, and even more preferably 5 ppm or lower. The lower limit is 1 ppm and even if it is lowered further, the effect is not caused.

In the case the content of acetaldehyde of a molded article obtained by injection molding of the above-mentioned polyester resin composition is defined as Bₜ ppm and the content of acetaldehyde of the polyester resin composition before the injection molding is defined as B₀ ppm, Bₜ−B₀ is 30 ppm or lower, preferably 20 ppm or lower, more preferably 10 ppm or lower, and even more preferably 5 ppm or lower. If Bₜ−B₀ exceeds 30 ppm, the content of aldehyde in a obtained molded article cannot be lowered to 50 ppm or less and it is a problem.

Further, it is made possible to obtain a molded article which does not change the taste and small of the contents by using a polyester resin composition of the present invention having the Bₜ−B₀ value of 30 ppm or less. If the Bₜ−B₀ value exceeds 30 ppm, malodorous smell becomes significant, the taste preservation is worsened, and the characteristics of taste and small of the contents are also worsened to result in a problem. The lower limit value of Bₜ−B₀ is 1 ppm and even if the value is decreased less than this value, it is found that the taste preservation is scarcely changed and therefore it is meaningless.

The cylinder temperature of an injection molding apparatus for molding a polyester resin composition of the present invention is required to change in accordance with the melting point of the polyester resin (2) used. Practically, for the polyester resin composition containing the above-mentioned polyester resin (2) such as PET type polyesters, PBT type polyester resins, PTT type polyester resins or the polyester resin composition containing the above-mentioned polyester resin (2) such as the above-mentioned PEN type polyester resin, the temperature is described in the measurement method (14) and the set cylinder temperature value for others are 290° C. or 300° C. It is the same in the case of injection molding of the polyester resin composition of the present invention, as explained below.

The polyester resin composition of the present invention can be obtained by properly adjusting the content of phosphorus element contained in the polyester resin (1), the type of a polycondensation catalyst metal element contained in the polyester resin (2), the remaining amount of the polycondensation catalyst metal element, and the mixing ratio of the polyester resin (1) and the polyester resin (2). For example, the polyester resin composition can be obtained by a method of mixing the polyester resin (1) and a polyester resin (2) in a manner that the mole ratio (P/Me) of the remaining amount (Me) of metal elements derived from a polycondensation catalyst excluding the Ge metal element remaining amount and Sb metal element remaining amount in the polyester resin composition relative to the phosphorus element remaining amount (P) is 0.3 to 20, preferably 0.5 to 15, and more preferably 1.0 to 10 and that the phosphorus element remaining amount is 0.5 to 200 ppm, preferably 1 to 150 ppm, and more preferably 5 to 100 ppm; or a method of using a Ge compound as a polycondensation catalyst for the polyester resin (1) and using at least one compound selected from a group consisting of aluminum compounds and titanium compounds as the polycondensation catalyst for the polyester resin (2); or a method by combining the above-mentioned methods; but not at all limited to these.

The content of fines in the polyester resin composition of the present invention is desirable to be 0.1 to 5000 ppm, preferably 0.1 to 3000 ppm, more preferably 0.1 to 1000 ppm, furthermore preferably 0.1 to 500 ppm, and even more preferably 0.1 to 100 ppm. If the content of fines in the polyester resin composition of the present invention is less than 0.1 ppm, the crystallization speed is very slow and, for example, the crystallization of a mouth part of a hollow molded container becomes insufficient and thus it is undesirable. On the other hand, if the content of fines in the polyester resin composition exceeds 5000 ppm, the crystallization speed is increased beyond necessity and the speed is fluctuated significantly. Accordingly, in the case of a sheet-like material, the transparency and the surface state are worsened and, in the case of a stretched material, the thickness becomes uneven. Further, the crystallization degree of the mouth part of the hollow molded article increases significantly and is fluctuated considerably and therefore, the shrinkage degree of the mouth part cannot be within a defined range and capping of the mouth part becomes defective to cause leakage of the contents out of the container or the preliminarily molded article for the hollow molded article is whitened to make normal stretching impossible. Particularly, if the polyester resin composition is used for heat resistant hollow molded articles, the fine content is preferably 0.1 to 500 ppm.

A method of adjusting the content of the fines in the polyester resin composition of the present invention to be 0.1 to 5000 ppm may be various methods such as a method of using the polyester resin (1) and polyester resin (2) containing fines in the above-mentioned range or a method of adjusting the fine removal efficiency by sieving speed in a sieving step or air current in a fine removal step.

The content of a cyclic ester oligomer of a molded article obtained by injection-molding the polyester resin composition of the present invention is desirable to be 70% or less, preferably 60% or less, more preferably 50% or less, and even more preferably 35% or less relative to the content of the cyclic ester oligomer contained in a melt polycondensed polymer of the polyester resin. The lower limit of the cyclic ester oligomer content is 20% or more, preferably 22% or more, and more preferably 25% or more relative to the content of the cyclic ester oligomer contained in the melt polycondensed polymer in terms of economical productivity.

Further, in the case the polyester resin (2) of the present invention is a polyester resin containing ethylene terephthalate as a main repeating unit, the content of the cyclic trimer in a molded article obtained by injection-molding of the polyester resin composition of the present invention is preferably 0.70% by weight or less, more preferably 0.60% by weight or less, and even more preferably 0.50% by weight or less. If a heat resistant molded article is produced from the polyester resin composition of the present invention, heat treatment is carried out by a heated mold, and if the content of the cyclic trimer exceeds 0.70% by weight, the oligomer adhesion to the heated mold surface is sharply increased and the transparency of the obtained molded article is significantly worsened. Particularly, in the case of a heat resistant hollow molded article, the content of the cyclic trimer is desirably 40% by weight or less.

It is desirable that the haze of a molded article with a thickness of 5 mm obtained by injection-molding of the polyester resin composition of the present invention is 30% or lower, preferably 25% or lower, and more preferably 20% or lower. Particularly, in the case the polyester resin composition of the present invention is used for hollow molded article, it is preferable that the haze is 15% or lower, and in the case the polyester resin composition of the present invention is used for heat resistant hollow molded article, it is preferable that the haze is 10% or lower. If the haze of the molded article exceeds 30%, the transparency of the obtained molded article is worsened to result in a problem and the commodity value is lost.

If the above-mentioned polyester is a polyester containing ethylene terephthalate as a main component, upon increasing the temperature of a specimen of a molded article with a thickness of 2 mm obtained by injection molding of the polyester resin composition of the present invention, crystallization temperature (hereinafter, referred to as Tc1) is desirable to be in a range of 140 to 180° C., preferably 142 to 175° C., and more preferably 145 to 170° C. If Tc1 exceeds 180° C., the crystallization speed becomes very slow and the crystallization of a mouth part of a hollow molded article becomes insufficient to cause a problem of leakage of the contents. Further, if Tc1 is less than 140° C., the transparency of a hollow molded article is decreased to cause a problem.

The polyester resin composition of the present invention can be obtained by mixing the above-mentioned polyester resin (1) and polyester resin (2) in conventionally known methods. Examples of the methods may be a method of dry blending the above-mentioned polyester resin (1) and the above-mentioned polyester resin (2) by a tumbler, a V-type blender, a Henshel mixer, or the like; a method of melting and mixing a dry blended mixture once or more times by a uniaxial extruder, a biaxial extruder, a kneader, or the like; a method of further optionally solid-phase polymerizing the melted mixture under highly vacuum or inert gas atmosphere.

To suppress the fluctuation of the mixed ratio at mixing and molding stage, the chip shapes and granular states of the polyester resin (1) and the polyester resin (2) have to be same.

The polyester resin composition of the present invention may be mixed with 0.1 ppb to 1000 ppm of at least one selected from a group consisting of polyolefin resins, polyamide resins, polyacetal resins, and polybutylene terephthalate. The mixing ratio of thermoplastic resin, such as the above-mentioned polyolefin resins, in the polyester resin composition of the present invention is 0.1 ppb to 1000 ppm, preferably 0.3 ppb to 100 ppm, more preferably 0.5 ppb to 1 ppm, and even more preferably 0.5 ppb to 45 ppb. If the mixing ratio is less than 0.1 ppb, the crystallization speed is very slow and the crystallization of a mouth part of a hollow molded container becomes insufficient and therefore, if a cycle time is shortened, the shrinkage degree of the mouth part cannot be within a range of a defined value to make capping impossible or the stains of a stretching and thermally fixing mold for molding a heat resistant hollow molded container become very awful and the mold has to be wiped frequently in order to obtain a transparent hollow molded container. On the other hand, if it exceeds 1000 ppm, the crystallization speed is increased and the crystallization degree of the mouth part of the hollow molded article increases significantly and therefore, the shrinkage degree of the mouth part cannot be within a defined range and capping of the mouth part becomes defective to cause leakage of the contents out of the container or the preliminarily molded article for the hollow molded article is whitened to make normal stretching impossible. In the case of a sheet-like material, if it exceeds 1000 ppm, the transparency is considerably worsened and stretching property is also worsened to make normal stretching impossible and give merely a stretched film with unevenness of the thickness and inferior transparency.

Examples of the polyolefin resin mixed with the polyester resin composition of the present invention may be polyethylene containing resins, polypropylene containing resins, and α-olefin containing resins and these resins may be crystalline or amorphous.

Examples of the polyamide resins mixed with the polyester resin composition of the present invention may be nylon 4, nylon 6, nylon 7, nylon 8, nylon 9, nylon 11, nylon 12, nylon 66, nylon 69, nylon 610, nylon 611, nylon 612, nylon 6T, nylon 6I, nylon MXD6, nylon 6/MXD 6, nylon MXD6/MXD1, nylon 6/66, nylon 6/60, nylon 6/12, nylon 6/6T, and nylon 6I/6T. These resins may be crystalline or amorphous.

Production of a polyester resin composition mixed with a thermoplastic resin such as the above-mentioned polyolefin resin is carried out by a method of directly adding the thermoplastic resin to the above-mentioned polyester resin (2), and melting and kneading in the content within the above-mentioned range, and in addition; conventional methods such as a method of either directly adding, melting, and kneading in a master batch manner; and a method of directly adding the above-mentioned thermoplastic resin in form of a powder in a production process of the above-mentioned polyester resin (2), for example, in any step, e.g. during the melt polycondensation, immediately after the melt polycondensation, immediately after preliminary crystallization, during solid-phase polymerization, immediately after solid-phase polymerization, in a period from the production process to the molding process or mixing by bringing parts made of the above-mentioned thermoplastic resin into contact with the chips of the polyester resin in fluidizing condition, and then melting and kneading the mixture.

The polyester resin composition of the present invention may be mixed with polyamides, polyester amides, low molecular weight amino group-containing compounds, and hydroxyl-containing compounds as an aldehyde reducing agent.

Examples of the polyamides added as the aldehyde reducing agent are at least one polyamide selected from aliphatic amides and partially aromatic polyamides.

Examples of the aliphatic polyamides are substantially nylon 6, nylon 11, nylon 12, nylon 66, nylon 69, nylon 610, nylon 6/66, and nylon 6/610.

Preferable examples of the partially aromatic polyamides are m-xylylene-containing polyamides containing at least 20% by mole, more preferably 30% by mole or more, and even more preferably 40% by mole or more of component units derived from m-xylylene diamine or a mixture of m-xylylene diamine and p-xylylene diamine in a ratio of 30% or lower in the total amount with aliphatic dicarboxylic acids, in the molecular chains.

Further, the partially aromatic polyamides may contain component units derived from tri- or more-basic polycarboxylic acids such as trimellitic acid and pyromellitic acid to an extent that the component units are substantially in linear state.

Examples of the polyamides are homopolymers such as poly-m-xylylene adipamide, poly-m-xylylene sebacamide, and poly-m-xylylene speramide; and copolymers such as m-xylylene diamine/adipic acid/isophthalic acid copolymer, m-xylylene/p-xylylene adipamide copolymer, m-xylylene/p-xylylene piperamide copolymer, m-xylylene/p-xylylene azeramide copolymer, m-xylylenediamine/adipic acid/isophthalic acid/ε-caprolactam copolymer, and m-xylylenediamine/adipic acid/isophthalic acid/ε-aminocaproic acid copolymer.

Examples of other preferable partial aromatic polyamides are polyamides containing at least 20% by mole, more preferably 30% by mole or more, and even more preferably 40% by mole or more of component units derived from aliphatic diamines and at least one acid selected from aliphatic diamines and terephthalic acid and isophthalic acid.

Examples of the polyamides are polyhexamethylene terephthalamide, polyhexamethylene isophthalamide, hexamethylenediamine/terephthalic acid/isophthalic acid copolymer, polynonamethylene terephthalamide, polynonamethylene isophthalamide, nonamethylenediamine/terephthalic acid/isophthalic acid copolymer, and nonamethylenediamine/terephthalic acid/adipic acid copolymer.

Examples of other preferable partial aromatic polyamides are polyamides containing at least 20% by mole, more preferably 30% by mole or more, and even more preferably 40% by mole or more of component units derived from aliphatic diamines and at least one acid selected from terephthalic acid and isophthalic acid and obtained using, as polymerization components, aliphatic diamines and at least one acid selected from terephthalic acid and isophthalic acid and besides there acids, lactams such as ε-caprolactam and laurolactam; aminocarboxylic acids such as aminocaproic acid; and aromatic aminocarboxylic acid such as p-aminomethylbenzoic acid.

Examples of the polyamides are hexamethylenediamine/terephthalic acid/ε-caprolactam copolymer, hexamethylenediamine/isophthalic acid/ε-caprolactam copolymer, and hexamethylenediamine/adipic acid/ε-caprolactam copolymer.

Examples of the polyester amides are polyester amides produced from terephthalic acid, 1,4-cyclohexanedimethanol, and polyethyleneimine; polyester amides produced from isophthalic acid, 1,4-cyclohexanedimethanol, and hexamethylenediamine; polyester amides produced from terephthalic acid, adipic acid, 1,4-cyclohexanedimethanol, and hexamethylenediamine; and polyester amides produced from terephthalic acid, 1,4-cyclohexanedimethanol, and bis(p-aminocyclohexyl)methane.

The polyamides and polyester amides used are preferable to have a secondary transition point of 50 to 120° C. measured by DSC (differential scanning calorimetry). If the secondary transition point is lower than 50° C., they are melt-deposited in a drying step or upon extrusion with a polyester resin composition or they cannot be quantitatively extruded and therefore, it is not preferable. Further, if it exceeds 120° C., a molded article of an un-stretched polyester cannot be evenly stretched and the thickness undesirably becomes uneven.

Examples of the low molecular weight amino group-containing compounds are aliphatic amine compounds such as stearylamine, aromatic amine compounds such as 1,8-diaminonaphthalate, 3,4-diaminobenzoic acid, 2-aminobenzamide, N,N′-1,6-hexandyl bis(2-aminobenzamide), 4,4′-diaminodiphenylmethane; and triazine compounds such as melamine and benzoguanamine; and amino acids.

Examples of the hydroxyl-containing compounds are polyvinyl alcohol, ethylene vinyl alcohol copolymer, sugar alcohol, and trimethylolpropane.

These polyamide compounds, low molecular weight amino group-containing compounds, and hydroxyl-containing compounds may be used alone or may be mixed at a proper ratio.

The aldehyde reducing agent may be added in an amount of 0.001 to 5 parts by weight, preferably 0.01 to 3 parts by weight, and more preferably 0.1 to 2 parts by weight relative to 100 parts by weight of the polyester resin composition of the present invention.

The aldehyde reducing agent can be mixed by adding a prescribed amount of the aldehyde reducing agent in an arbitrary reaction stage in the polyester polymer production from oligomers of polyesters with low polymerization degree. For example, the mixing can be carried out by adding the above-mentioned aldehyde reducing agent in a proper form such as fine granules, powders, or melt to a reactor such as an esterification reactor and polycondensation reactor or by adding the above-mentioned aldehyde reducing agent or a mixture of the aldehyde reducing agent and the above-mentioned polyester in melted state to a transportation pipe for a reaction product of the above-mentioned polyester from a prior reactor to another reactor for the next step. Further, it can be carried by solid-phase polymerization of chips optionally obtained under high vacuum atmosphere or inert gas atmosphere.

Further, it can be carried out by a method of mixing the polyester resin composition and the aldehyde reducing agent in conventionally known manner or by a method of mixing the aldehyde reducing agent with a mixture of two or more kinds of polyesters. For example, polyamide chips and two kinds of polyester chips having different IV values are dry blended by a tumbler, a V-shape blender, or a Henshel mixer; further the mixture obtained by the dry mixing is melted and kneaded once or more times by a uniaxial extruder, a biaxial extruder, or a kneader; and further, if necessary, the chips obtained from the melted mixture are polymerized by solid-phase polymerization under high vacuum atmosphere or inert gas atmosphere.

Further, examples of the method may include a method of depositing a solution obtained by dissolving the above-mentioned polyamide in a solvent such as hexafluoroisopropanol on the surface of chips of the polyester and a method of depositing the polyamide to the surface of the polyester chips by hitting and causing collision of the polyester against a member made of the polyamide in a space.

Besides the thermoplastic resin and aldehyde reducing agent in the above-mentioned addition amounts, the polyester resin composition of the present invention may contain a proper amount of another thermoplastic resin, for example, a gas barrier type polyester, an ultraviolet absorbable polyester, and a gas barrier type polyamide resin, if necessary, to an extent that the effects of the present invention are not deteriorated.

The polyester resin composition of the present invention may contain, if necessary, conventionally known various kinds of additives such as an ultraviolet ray absorbent, an antioxidant, an oxygen trapping agent, a lubricant added additionally from outside and a lubricant internally precipitated during the reaction, a release agent, a nucleating agent, a stabilizer, an antistatic agent, a bluing agent, a dye, a pigment and so forth.

In the case the polyester resin composition of the present invention is used for uses as films, to improve the hading properties such as a slipping property, a rolling property, and an anti-blocking property, the polyester resin composition may contain inorganic particles of calcium carbonate, magnesium carbonate, barium carbonate, calcium sulfate, barium sulfate, lithium phosphate, calcium phosphate, and magnesium phosphate; organic salt particles such as calcium oxalate and terephthalic acid salts of calcium, barium, zinc, manganese, and magnesium; inactive particles such as crosslinking high molecular weight particles of homopolymers or copolymers of vinyl type monomers such as divinylbenzene, styrene, acrylic acid, methacrylic acid, acrylic acid, and methacrylic acid.

### (Uses of Polyester Molded Article)

The polyester resin composition of the present invention can be used by molding a sheet-like materials, stretched films, hollow molded articles, trays, wrapping materials such as a biaxially stretched films, films for coating metal cans by commonly employed melt molding methods, or forming fibers containing monofilaments, or forming coated materials obtained by coating other substrates with the composition by melt extrusion methods. The polyester resin composition of the present invention can be also used as one component layer of a multi-layer molded article or a multi-layer film.

The aldehyde content in a molded article (hereinafter, simply referred to as molded article) or the like produced from the polyester resin composition of the present invention is 70 ppm or lower, preferably 50 ppm or lower, more preferably 30 ppm or lower, furthermore preferably 15 ppm or lower, and even more preferably 10 ppm or lower. If the aldehyde content exceeds 70 ppm, the taste preservation of the contents in the molded article is worsened to cause a problem.

If the polyester resin (2) of the present invention is a polyester resin composed of ethylene terephthalate as a main repeating unit, the aldehyde content in the molded article produced from the polyester resin composition of the present invention is 30 ppm or lower, preferably 25 ppm or lower, more preferably 20 ppm or lower, furthermore preferably 15 ppm or lower, and even more preferably 10 ppm or lower. Particularly in the case of a container for low flavor beverages such as mineral water, it is desirable to be 20 ppm or lower, preferably 15 ppm or lower, and more preferably 10 ppm or lower.

The cyclic ester oligomer content in the molded article produced from the polyester resin composition of the present invention is 70% or lower, preferably 60% or lower, more preferably 50% or lower, and even more preferably 40% or lower relative to the content of the cyclic ester oligomers in the melted polycondensate polyester prepolymer of the above-mentioned polyester resin (2).

If the polyester resin (2) of the present invention is a polyester resin composed of ethylene terephthalate as a main repeating unit, the cyclic trimer content in the molded article produced from the polyester resin composition of the present invention is 0.5% or lower, preferably 0.4% or lower, and more preferably 0.35% or lower. If it exceeds 0.5%, the staining of the mold at molding stage becomes awful and it is a problem.

The increase amount of the cyclic ester oligomers upon melting the molded article of the polyester resin composition of the present invention at a temperature of X° C. for 60 minutes is 0.40% by weight or lower, preferably 0.30% by weight or lower, furthermore preferably 0.20% or lower, and even more preferably 0.01% or lower. The temperature X° C. is 290° C. for the above-mentioned polyester resin (2) in the case of the polyester resin composition containing the polyester resin (2) such as the above-mentioned PET type polyester, PBT type polyester resin, or PPT type polyester resin, or 300° C. in the case of the polyester resin composition containing the above-mentioned PEN type polyester resin as the polyester resin (2).

In the case the polyester resin (2) of the present invention is a polyester resin composed of ethylene terephthalate as a main repeating unit, the increase amount of the cyclic trimer upon melting the molded article of the polyester resin composition of the present invention at a temperature of 290° C. for 60 minutes is 0.40% by weight or lower, preferably 0.30% by weight or lower, more preferably 0.20% or lower, and even more preferably 0.10% by weight or lower. That the increase amount of the cyclic trimer upon melting at a temperature of 290° C. for 60 minutes exceeds 0.40% by weight means that the polycondensation catalyst of the polyester resin (2) is not completely deactivated and the cyclic trimer is regenerated upon molding and melting and therefore, oligomer adhesion to the surface of a heated mold upon continuous molding is sharply increased to cause a problem that the transparency of the obtained molded article such as a hollow molded article is considerably deteriorated and much effort and more times are expended to clean the mold. The lower limit of the cyclic trimer increase amount is about 0.01% by weight and even if the lower limit value is further decreased, the economical effect on the above-mentioned problem is very slight. Herein, the cyclic trimer increase amount upon melting at a temperature of 290° C. for 60 minutes is a value calculated for a specimen of a 3 mm-thick stepped and molded plate obtained by a molding method, which will be described in the following “measurement method”.

The sheet-like material made of a polyester resin composition of the present invention can be produced by well known means. For example, it can be produced by a common sheet-molding apparatus equipped with an extruder and a die.

Further, the sheet-like material can be formed in a cup-like or tray-like shape by pneumatic molding or vacuum molding. Further, the polyester molded article produced from the polyester resin composition of the present invention can be used also for uses as tray-like containers for cooking food by a microwave oven and/or oven or heating frozen food. In this case, the sheet-like material is thermally crystallized to improve the heat resistance after being molded into the tray-like shape.

Further, the polyester resin composition of the present invention can be used as on component layer in form of a film or a coating in a composite molded article such as a laminate molded article and a layered film. Particularly, it can be used for producing containers in form of a laminate article with PET. Examples of the laminate molded article may be molded articles having a double-layer structure consisting of an inner layer of the polyester resin composition of the present invention and an outer layer of PET; molded articles having a tri-layer structure consisting of an interlayer containing the polyester resin composition of the present invention and an outer layer and an innermost layer of PET and molded articles having a tri-layered structure consisting of an outer layer and an innermost layer respectively containing the polyester resin composition of the present invention and an interlayer of PET; and molded articles having a pent-layered structure consisting of inter-layers containing the polyester resin composition of the present invention, an innermost layer, a center layer, and an innermost layer of PET. The PET layer may contain other gas barrier resins, ultraviolet shutting resins, heat resistant resins, and recovered articles from used polyethylene terephthalate bottles at proper mixing ratios.

Further, examples of other laminate molded articles may be laminate molded articles of the polyester resin composition with resins other than polyesters such as polyolefins, and laminate molded articles of the polyester resin composition with different type substrates of such as paper and metal plates.

The thickness of the above-mentioned laminate molded article and the thickness of the respective layers are not particularly limited. The above-mentioned laminate molded articles can be used in various kinds of forms such as a sheet-like material, a film-like material, a plate-like material, a hollow body, and a container.

Production of the above-mentioned laminate article can be carried out by co-extrusion using extruders in a number corresponding to the types of the resin layers and multilayer multi-type dies and by co-injection using injectors in a number corresponding to the types of the resin layers and co-injection runners.

Another use of the polyester resin composition of the present invention is a film laminated on one face or both faces of a laminate metal plate. The metal plate used may be a tin plate, a tin-free steel, and aluminum.

A laminate method may be conventionally known methods and is not particularly limited, however, a thermal laminate method is preferable since the method can be carried out in organic solvent-free manner, and bad effects of remaining solvent on taste and smell of food products can be avoided. Especially, a thermal laminate method by electric processing of a metal plate is recommended. Further, in the case of a both-sided laminate, lamination may be carried out simultaneously or successively.

No need to say, a film may be laminated on a metal plate by using an adhesive.

A metal container can be obtained by molding the laminate metal plate. A molding method of the above-mentioned metal container is not particularly limited. The shape of the metal container is not particularly limited either, however, it is preferable to be two-piece cans produced by mold processing by area reduction molding, area reduction and squeezing molding, and stretch and draw molding and also, for example, three-piece cans produced by rolling and fastening a top and a bottom covers suitable for filling food products such as retort food and coffee beverages, and filling the contents in the resulting cans.

Hereinafter, specific production methods for various uses in the case of PET will be briefly described.

In the case of producing a stretched film, the stretching temperature is generally 80 to 130° C. The stretching may be carried out uniaxially or diaxially, however in terms of practically usable physical properties of the film, biaxial stretching is preferable. The draw ratio is generally 1.1 to 10 times and preferably 1.5 to 8 times in the case of uniaxial stretching, and generally 1.1 to 8 times and preferably 1.5 to 5 times in both vertical and transverse directions in the case of biaxial stretching. The vertical direction draw ratio/transverse direction draw ratio is generally 0.5 to 2 and preferably 0.7 to 1.3. The obtained stretched film may be further thermally fixed to improve the heat resistance and mechanical strength. The heat fixation is generally carried out at 120 to 240° C. and preferably at 150 to 230° C. for several seconds to several hours and preferably several tens to several minutes under tension.

In production of a hollow molded article, a preform obtained by molding the polyester resin composition of the present invention is stretched and blow-molded using an apparatus conventionally used for PET blow molding. Practically, the preform is once molded by injection molding or extrusion molding and as it is, or after processing of a mouth part and a bottom part, the preform is heated again and subjected to biaxial blow molding method such as a hot parison method or a cold parison method. In this case, molding temperature, specifically the temperatures of the respective cylinder parts and nozzles of the molding apparatus, is generally in a range of 260 to 300° C. The stretching temperature is generally 70 to 120° C. and preferably 90 to 110° C., and the stretching ratio is generally 1.5 to 3.5 times in the vertical direction and 2 to 5 times in the circumferential direction. The obtained hollow molded article can be used as it is, however particularly in the case of beverages such as juice beverages and oolong tea which require heat packing, generally further heat fixation treatment may be carried out in a blow mold to provide heat resistance for use. The heat fixation is generally at 100 to 200° C. and preferably 120 to 180° C. for several seconds to several hours and preferably several seconds and several minutes under tension of compressed air.

To provide the mouth part with heat resistance, the mouth part of the preform obtained by injection molding or extrusion molding is crystallized in an oven in which a far infrared ray or near infrared ray heater is installed, or is crystallized by the heater after molding of a bottle.

Further, the polyester resin composition of the present invention can be used for producing a stretched and hollow molded article by so-called compression molding method involving melt extruding the composition, cutting it into a melt ingot, compression molding the ingot to obtain a preform and stretching and blow-molding the preform.

### EXAMPLES

Hereinafter, the invention will be more substantially described along with Examples, however the invention should not be limited to these Examples.

Measurement methods of main characteristic values will be described below.

The compositions and respective characteristics of polyesters will be measured by freezing and pulverizing chips, mixing the pulverized chips, and then carrying out measurement.

### (1) Intrinsic Viscosity (Hereinafter, Referred to as “IV”) of Polyester

It is measured on the basis of solution viscosity at 30° C. in a mixed solvent of 1,1,2,2-tetrachloroethane/phenol (2:3 by weight)

Samples of polyester chips for measuring the intrinsic viscosity were prepared by freezing and pulverizing polyester chips and then the samples were subjected to measurement.

### (2) Acetaldehyde Content (Hereinafter, Referred to as “AA”) of Polyester

Each sample/distilled water=0.2 to 1 g/2 cc was packed in a glass ample purged with nitrogen, the upper part was sealed by welding, extraction treatment was carried out at 160° C. for 2 hours, after being cooled, acetaldehyde in the extraction solution was measured by high sensitivity gas chromatography, and the concentration was displayed by ppm. The above-mentioned process was repeated 5 times and the average value was defined as AA content.

### (3) Diethylene Glycol Content (Hereinafter, Referred to as “DEG”) and Triethylene Glycol Content (Hereinafter, Referred to as “TEG”) of Polyester

Polyester was dissolved in heavy hydrogenated trifluoroacetic acid/heavy hydrogenated chloroform (volume ration 1/9), ¹H-NMR was measured by AVANCE-500 model NMR apparatus manufactured by Burka Biospin, and those contents were calculated from the integrated intensity of peaks of protons of the respective copolymerized components in the obtained charts.

### (4) Free Glycol Content (Hereinafter, Free Glycol Content is Referred to as Free “GL”) of Polyester

Each sample was frozen and pulverized or made into fine pieces, 1.000 g of the resulting sample was dissolved in 8 ml of mixed solution of hexafluoroisopropanol/chloroform in a conical flask and next, 5 ml of distilled water was added to make the contents uniform. The mixture was heated at about 60° C. in water bath to remove the mixed solvent and then cooled. The remaining water phase was filtered using a glass fiber filter. The filtrate was diluted with water to be 10 ml and free ethylene glycol content and free diethylene glycol content were quantitatively measured by gas chromatography.

The total amount of the measured free ethylene glycol content and free diethylene glycol content was defined as free glycol content (free ethylene glycol content is referred to as “free EG” and free diethylene glycol content is referred to as “free DEG”).

(5) Free Aromatic Dicarboxylic Acid Content, Monomer Content and Oligomer Contents Consisting of Aromatic Dicarboxylic Acid and Glycol (in the Case of PET, Free Terephthalic Acid Content (Hereinafter, Referred to as “Free TPA”), Free Monohydroxyethyl Terephthalate Content (Hereinafter, Referred to as “Free MHET”), Free Bishydroxyethyl Terephthalate Content (Hereinafter, Referred to as “Free BHET”), and Cyclic Trimer Content (Hereinafter, Referred to as “Free CT”)) of Each Polyester

Each sample was frozen and pulverized or made into fine pieces, 100 mg of the resulting sample was dissolved in 3 ml of mixed solution of hexafluoroisopropanol/chloroform (volume ratio=2/3) and next, 30 ml of chloroform was added for dilution. After 15 ml of methanol was added to precipitate polymer, the solution was filtered. The filtrate was evaporated and dried, the remaining was diluted with dimethylformamide to be 10 ml and the contents were quantitatively measured by high performance liquid chromatography.

### (6) Cyclic Trimer Increase Amount (ΔCT Amount) Upon Melting Polyester

Hereinafter, polyester resin compositions from PET type polyester will be described.

Each sample was sampled from a 3 mm-thick plate obtained by molding at 290° C. in the method described in (14), dried at 140° C. and 0.1 mmHg for 16 hours under reduced pressure, and 3 g of the sample was put in a glass test tube and melted by immersing the glass tube in an oil bath at 290° C. for 60 minutes in nitrogen atmosphere. The cyclic trimer increase amount upon melting was calculated according to the following equation.

As the cyclic trimer content before melting was employed the above-mentioned cyclic trimer content of the plate.

Cyclic trimer increase amount (ΔCT amount) (% by weight) upon melting=cyclic trimer content after melting (% by weight)−cyclic trimer content before melting (% by weight)

In the case of a polyester resin composition containing PEN type polyester, a 3 mm-thick plate produced form a stepped molded plate obtained by molding at 300° C. was used and melting treatment was carried out in an oil bath at 300° C.

### (7) Cyclic Trimer Increase Amount (Aₜ−A₀) by Molding and Acetaldehyde Content Increase Amount (Bₜ−B₀) by Molding

Cyclic trimer increase (Aₜ−A₀) was calculated from CT content Aₜ of each sample obtained from the center part of a 3 mm-thick stepped plate produced from each polyester resin composition by the method (14) and CT content A₀ of the above-mentioned polyester resin composition before injection molding according to the following formula (n=5).

Increase amount of cyclic trimer content by molding=Aₜ−A₀

Cyclic trimer increase (Bₜ−B₀) was calculated from AA content Bₜ of each sample obtained from the center part of a 2 mm-thick stepped plate produced from each polyester resin composition by the method (14) and AA content B₀ of the above-mentioned polyester resin composition before injection molding according to the following formula (n=5).

Increase amount of AA content by molding=Bₜ−B₀

In this connection, A₀ and B₀ were calculated from the component ratios of the CT content and AA content of respective polyester resins composing the composition.

### (8) Analysis of Cr, Fe, Ni, Zn Metal Contents in Polyester

After 1.2 g of each sample was put in a platinum crucible and carbonized by an electric heater, the sample was heated over night at 550° C. by an electric furnace to carry out ashing. Next, a measurement solution was obtained by dissolving the ash in a 1.2 M hydrochloric acid solution to subject to measurement of Cr, Fe, Ni, and Zn elements by IPC emission spectrometry.

If the content was 0.1 ppm or lower, the amount of the sample was increased 10 times.

### (9) Measurement of Fine Content

After about 0.5 kg of each resin was put on a set of 2 sieves (diameter 20 cm) composed of sieve (A) equipped with metal mesh of nominal size of 5.6 mm and sieve (B) equipped with metal mesh of nominal size of 1.7 mm according to JIS-Z8801, and the resin was sieved at 1800 rpm for 1 minute by a vibration type sieving and shaking apparatus SNF-7. This operation was repeated to sieve the resin in total of 20 kg. However, if the fine content was slight, the amount of the sample was properly changed.

The fines sieved under the above-mentioned sieve (B) were washed with an aqueous 0.1% cationic surfactant solution and successively with ion-exchanged water, and filtered by a G1 glass filter manufactured by Iwaki Glass Company Ltd. The collected fines together with the glass filter were dried at 100° C. for 2 hours in a drier, cooled, and weighed. Again washing with ion-exchanged water and drying were repeated in the same manner and after it was confirmed that the weight became constant, the weight of the fines was calculated by subtracting the weight of the glass filter from the constant weight. The fine content was defined as fine weight/total weight of sieved resin.

### (10) Water Content of Polyester

The water content was measured by Karl Fischer (CA-100 model and VA-100 model) manufactured by Mitsubishi Chemical Corporation.

The water content of each polyester resin composition was calculated from the mixing ratio of respective component polyester, and its water content.

### (11) Haze (%)

Each sample was cut out of a molded article described in (14) (polyester resin (1) was a 4 mm-thick plate and polyester resin (2) was a 5 mm-thick plate) and a trunk body of a hollow molded article of (15), and the haze was measured by a haze meter manufactured by a model NDH2000 manufactured by Nippon Denshoku.

### (12) Crystallization Temperature (Tc1) of Molded Article Upon Heating

The measurement was carried out by RDC-220, manufactured by differential scanning calorimetry (DSC) manufactured by Seiko Instruments Inc. The crystallization temperature (Tc1) upon heating was measured using 10 mg of each sample obtained from the center part of a 2 mm-thick plate of the molded plate described in (14) by measuring the peak temperature of the crystallization peak observed during heating at 20° C./minute.

### (13) Color b Value of Polyester Chip and Molded Article

Measurement was carried out for crystallized polyester chips and the molded articles (thickness 4 mm) described in (14) according to JIS-Z8722 (Hunter-system color difference) by a calorimeter TC-1500MC-88 manufactured by Tokyo Denshoku. As the color b is higher, the discoloration degree is higher.

### (14) Molding Stepped Molded Plates of Polyester Resin (1), Polyester Resin (2) and Polyester Resin Composition

### 1) Molding Stepped Molded Plates

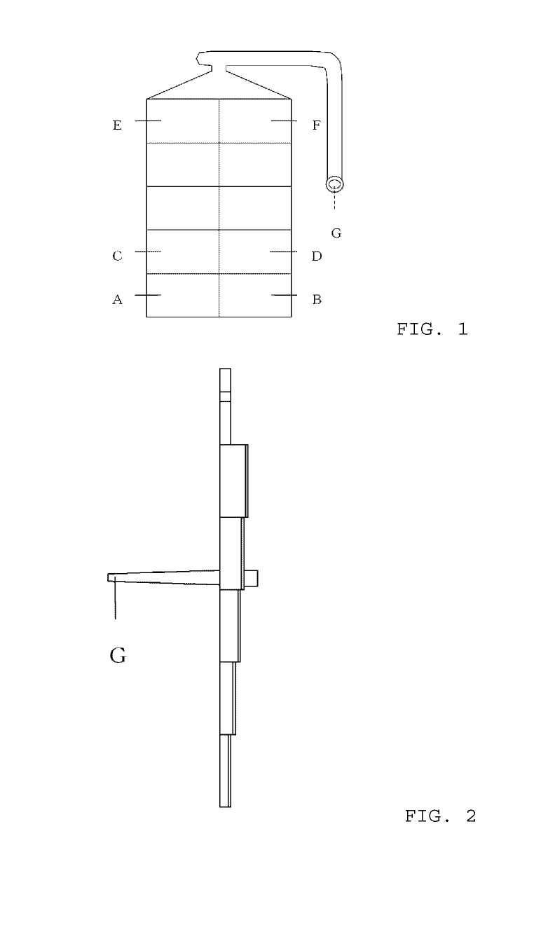

In molding stepped molded plates in the present invention, stepped molded plates with thickness of 2 mm to 11 mm (thickness of A part=2 mm, thickness of B part=3 mm, thickness of C part=4 mm, thickness of D part=5 mm, thickness of E part=10 mm, and thickness of F part=11 mm) having a gate part (G) as shown in FIG. 1 and FIG. 2 were produced from samples as described in the following 2), 3), and 4) by injection molding by an injection molding apparatus M-150C-DM manufactured by Meiki Seisakusho.

To prevent moisture absorption of chips during the molding, a hopper for molding materials was purged with dry inert gas (nitrogen gas).

The plasticization conditions by M-150C-DM injection molding apparatus were set as follows: feeding screw rotation speed=70%, screw rotation speed=120 rpm, back pressure 0.5 MPa, cylinder temperature 45° C. and 250° C. in this order immediately below the hopper, 290° C. including nozzles and thereafter. Injection conditions were as follows: the injection speed and pressure dwell speed were 20%, the injection pressure and pressure dwell were adjusted to give molded product weight of 146±0.2 g, and the pressure dwell was adjusted to be lower by 0.5 MPa than the injection pressure.

The injection time and pressure dwell time were set to be respectively 10 seconds and 7 seconds at maximum, the cooling time was set to be 50 seconds, and the entire cycle time including the molded product discharge time was about 75 seconds.

Cooling water at 10° C. was introduced constantly to the mold to adjust the temperature and the mold surface temperature was around 22° C. when the molding was stable.

Test plates for evaluation of characteristics of molded products were selected arbitrarily among stable molded products at 11 to 18th shot from starting molding after molding materials were introduced and resin replacement was carried out.

In the case of the polyester resin (1), polyester resin (2) and polyester resin composition from PEN type polyesters, the cylinder temperature of the injection molding apparatus was adjusted as 45° C. and 250° C. for cylinders in this order immediately below the hopper and 300° C. for other cylinders including nozzles thereafter, and cooling water at 30° C. was circulated to the mold.

The 2 mm-thick plates (A part in FIG. 1) were used for measurement of crystallization temperature (Tc1) and acetaldehyde content measurement upon heating; the 3 mm-thick plates (B part in FIG. 1) for cyclic trimer content measurement (CT content); the 4 mm-thick plates of the polyester resin (1) (C part in FIG. 1) and the 5 mm-thick plates of the polyester resin composition (D part in FIG. 1) for haze (%) measurement; and the 4 mm-thick plates of the polyester resin composition (C part in FIG. 1) for color measurement.

### 2) Polyester Resin (1)

Using chips of the polyester resin (1) vacuum dried to water content about 50 ppm or lower by a vacuum drier PD 61 model manufactured by Yamato Scientific Co., Ltd., molding was carried out by the method described in 1). Particularly, it was required to dry the polyester resins (1)-(G) to (M) which were moisturized before molding.

### 3) Polyester Resin (2)

Using chips of the polyester resin (1) vacuum dried to water content about 50 ppm or lower by a vacuum drier in the same manner for those of polyester resin (1), molding was carried out in the method described in 1).

### 4) Polyester Resin Composition

In Examples 1 to 5, Comparative Examples 1 to 3, Examples 1N to 9N, and Comparative Examples 1N to 3N, mixed polyester resin compositions were vacuum dried and molded. In Examples 6 to 13 and Comparative Examples 4 to 8, the polyester resin compositions so quickly mixed as not to change the water content of the polyester resins shown in Table 3 were subjected to molding as they were.

### (15) Molding of Hollow Molded Article (in the Case of PET Type Polyester)

Excluding Examples 6 to 13 and Comparative Examples 4 to 8, preforms were produced by molding dried polyester resins and polyester resin compositions at a resin temperature of 290° C. by M-150C-DM injection molding apparatus manufactured by Meiki Seisakusho. The mouth parts of preforms were heated and crystallized by a mouth part crystallization apparatus produced by our company. Next, the preliminarily molded articles were stretched and blown biaxially by a LB-OLE molding apparatus manufactured by CORPOPLAST, and successively thermally fixed in a mold set at about 150° C. to mold containers (thickness of trunk part: 0.45 mm) with a capacity of 2000 cc. The stretching temperature was controlled to be 100° C.

Further, in Examples 6 to 13 and Comparative Examples 4 to 8, preforms were produced from polyester resin compositions so quickly mixed as not to change the water content of the polyester resins shown in Table 3 as they were at a resin temperature of 290° C. by M-150C-DM injection molding apparatus manufactured by Meiki Seisakusho and the hollow molded containers were obtained in the same manner as described above.

However, in a continuous molding accelerating test, in the above-mentioned molding, 1000 pieces were continuously molded in the same manner as described above, except that, as heat fixation conditions, the mold set temperature was changed to be at about 160° C. and the heat fixation time was changed to be for about 2 minute, and outer appearance of 10th and 1000th bottles were observed. Further, before the accelerating test was started, the stains on the mold surface of a blow mold were completely washed out by previously using a gauze impregnated with hexafluoroisopropanol/chloroform mixed solvent.

### (Bottle Outer Appearance Evaluation)

\textcircled{}: very good transparency
∘: good transparency
Δ: slightly inferior transparency
x: inferior transparency

### (16) Sensory Test

Each hollow container obtained in the above (15) was filled with boiled distilled water, tightly plugged, kept for 30 minutes, left for 1 week at 55° C. and unplugged and thereafter, a test for smell was carried out. As a blank for comparison, distilled water was used. The sensory test was carried out by 10 panelists based on the following standard and the average values were employed for comparison.

### (Evaluation Standard)

\textcircled{}: feeling no irregular taste and smell
∘: feeling slight difference from blank
Δ: feeling difference from blank
x: feeling much difference from blank
xx: feeling rather significant difference from blank

### (17) Appearance of Stepped Molded Article

The appearance of each stepped molded article as described in (14) was judged by eye observation.

x: silver streaks were formed
∘: good appearance

### (18) Ultraviolet Ray Shutting Property (%)

The shutting property of ultraviolet rays with wavelength of 380 nm was measured for each molded article (thickness 5 mm) as described in (14) by an absorptiometer manufactured by Hitachi Corporation. Good ultraviolet ray shutting property was defined to be 90% or higher.

### (Polyester Resin (1)-A)

A heat medium-circulation type esterification reactor equipped with a stirrer made of Hastelloy was loaded with 1162 kg of highly pure terephthalic acid, ethylene glycol in a mole amount 2 times as much, and triethylamine in an amount of 0.3% by mole relative to the acid component, and while water was removed outside, esterification reaction was carried out at 240° C. and 0.25 MPa pressure for 2 hours to obtain a mixture (hereinafter, referred to as BHET mixture) of bis(2-hydroxyethyl) terephthalate with 95% esterification ratio and oligomer. The BHET mixture was transported to a polycondensation apparatus equipped with a stirrer made of Hastelloy and as polycondensation catalyst, a solution obtained by heat treating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 250° C. and the pressure was gradually decreased to 13.3 Pa (0.1 Torr), the first stage initial polycondensation was carried out for 50 minutes and further polycondensation reaction was carried out at 270° C. and 13.3 Pa until the IV became about 0.65 dl/g. Pressure was released, and successively the resin in slightly pressurized state was led to a water cutter and chipped to obtain cylinder type chips. Upon chipping, the resin temperature from the outlet of the polycondensation apparatus to the nozzle fine pore was kept about 265° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.65 dl/g, the acetaldehyde content was 45 ppm, DEG content was 4.8% by mole, TEG content was 0.2% by mole, cyclic trimer content was 7100 ppm, color b value was 1.3, haze of a 4-mm thick molded article was 18.5%, Cr element content, Fe element content, Ni element content, and Zn element content were all 0.1 ppm. The characteristics are shown in Table 1. The fine content was about 800 ppm.

### (Polyester Resin (1)-B)

Melt polycondensation reaction was carried out in the same conditions as those for obtaining the above-mentioned polyester resin (1)-A until IV became about 0.56 dl/g, except that a heat medium-circulation type esterification reactor equipped with a stirrer made of SUS 316L was used and the polycondensation time was shortened.

After the chipped polyester obtained by the above-mentioned melt polycondensation reaction was heated to crystallize the polyester, they were dried at about 100 to 130° C. and successively at 150° C. in nitrogen flowing condition in a static solid-phase polycondensation tower and successively polymerized at 185° C. by solid-phase polymerization. IV was 0.72 dl/g, the acetaldehyde content was 26 ppm, DEG content was 5.2% by mole, TEG content was 0.3 ppm, cyclic trimer content was 6000 ppm, color b value was 1.4, haze of a 4-mm thick molded article was 5.7%, Cr element content, Fe element content, Ni element content, and Zn element content were 4 ppm, 10 ppm, 2 ppm, and 2 ppm, respectively. The characteristics are shown in Table 1. The fine content was about the same as that of the polyester resin (1)-A.

### (Polyester Resin (1)-C)

Polycondensation was carried out in the same conditions as those for obtaining the above-mentioned polyester resin (1)-B, except that a heat medium-circulation type esterification reactor equipped with a stirrer made of SUS 316 was used and antimony trioxide was used in place of crystalline germanium dioxide in an amount to adjust the Sb remaining amount of 180 ppm, to obtain a polyester resin having IV=0.65 dl/g.

The obtained resin was dried and crystallized in the same manner as the polyester resin (1)-A. IV was 0.65 dl/g, the acetaldehyde content was 50 ppm, DEG content was 6.3% by mole, TEG content was 0.4% by mole, cyclic trimer content was 6600 ppm, color b value was 1.9, haze of a 4-mm thick molded article was 21.9%, Cr element content, Fe element content, Ni element content, and Zn element content were 8 ppm, 25 ppm, 3 ppm, and 4 ppm, respectively. The characteristics are shown in Table 1. The fine content was about the same as that of the polyester resin (1)-A.

### (Polyester Resin (1)-D)

A heat medium-circulation type esterification reactor equipped with a stirrer made of SUS 304 was loaded with 1162 kg of highly pure terephthalic acid, ethylene glycol in a mole amount 2 times as much, and triethylamine in an amount of 0.1% by mole relative to the acid component, and while water was removed outside, esterification reaction was carried out at 250° C. and 0.25 MPa pressure for 2 hours to obtain a mixture (hereinafter, referred to as BHET mixture) of bis(2-hydroxyethyl) terephthalate and oligomer. The BHET mixture was transported to a polycondensation apparatus and as polycondensation catalyst, a solution obtained by heating a crystalline antimony trioxide/ethylene glycol solution, phosphoric acid, and ethylene glycol was added in a proper amount to adjust the Sb remaining amount to be about 350 ppm and P remaining amount to be about 2000 ppm relative to the obtained polyester. Next, the resulting mixture was stirred at 250° C. and normal pressure for 10 minutes in nitrogen atmosphere. Thereafter, while the resulting reaction system was gradually heated to 260° C. and the pressure was gradually decreased to 13.3 Pa (0.1 Torr), the first stage initial polycondensation was carried out for 50 minutes and further polycondensation reaction was carried out at 290° C. and 13.3 Pa until the IV became about 0.65 dl/g. Pressure was released, and successively the resin in slightly pressurized state was quenched in strand-like form in cold water and chipped by a strand cutter to obtain cylinder type chips. Upon chipping, the resin temperature from the outlet of the polycondensation apparatus to the nozzle fine pore was kept about 290° C. and the entire amount was chipped within 30 minutes.

Next, the chips were immediately heated at about 50 to 120° C. by vacuum drier and treated in vibration type sieving process and air blow classifying process. IV was 0.65 dl/g, the acetaldehyde content was 230 ppm, DEG content was 13.6% by mole, TEG content was 2.4% by mole, cyclic trimer content was 9100 ppm, color b value was 6.5, haze of a 4-mm thick molded article was 53.0%, Cr element content, Fe element content, Ni element content, and Zn element content were 18 ppm, 35 ppm, 8 ppm, and 12 ppm, respectively. The characteristics are shown in Table 1. The fine content was about 2.3% by weight.

TABLE 1
Characteristics of polyester resin (1) used for Examples and
Comparative Examples and polyester resin (2) used for Examples
and Comparative Examples

| | | | | | | | | | | | | Haze of |
|---|---|---|---|---|---|---|---|---|---|---|---|---|
| | | | | DEG | TEG | | | | | | Color b | molded |
| | | IV | AA | (mol | (mol | CT | Metal content (ppm) | | | | value of | plate |
| | | (dl/g) | (ppm) | %) | %) | (ppm) | Cr | Fe | Ni | Zn | chips | (%) |
| Polyester | A | 0.65 | 45 | 4.8 | 0.2 | 7100 | 0.1 | 0.1 | 0.1 | 0.1 | 1.3 | 18.5 |
| resin (1) | B | 0.72 | 26 | 5.2 | 0.3 | 6000 | 4 | 10 | 2 | 2 | 1.4 | 5.7 |
| | C | 0.65 | 50 | 6.3 | 0.4 | 6600 | 8 | 25 | 3 | 4 | 1.9 | 21.9 |
| | D | 0.65 | 230 | 13.6 | 2.4 | 9100 | 18 | 35 | 8 | 12 | 6.5 | 53.0 |
| Polyester | a | 0.74 | 3.2 | 2.6 | 0.1 | 3300 | ND | ND | ND | ND | 1.0 | 5.1 |
| resin (2) | b | 0.75 | 4.5 | 2.6 | 0.1 | 3500 | ND | ND | ND | ND | 1.0 | 5.3 |
| | c | 0.75 | 6.5 | 2.6 | 0.1 | 7300 | ND | ND | ND | ND | 1.2 | 32.0 |

Haze of molded plate:
polyester resin (1) = haze of 4 mm-thick molded plate
polyester resin (2) = haze of 5 mm-thick molded plate

### (Polyester Resin (1)-E)

A heat medium-circulation type esterification reactor equipped with a stirrer made of SUS 316L was loaded with 1162 kg of highly pure terephthalic acid, ethylene glycol in a mole amount 2 times as much, and triethylamine in an amount of 0.3% by mole relative to the acid component, and while water was removed outside, esterification reaction was carried out at 245° C. and 0.25 MPa pressure for 2 hours to obtain a mixture (hereinafter, referred to as BHET mixture) of bis(2-hydroxyethyl) terephthalate with 95% esterification ratio and oligomer. The BHET mixture was transported to a polycondensation apparatus equipped with a stirrer made of SUS 316L and as polycondensation catalyst, a solution obtained by heating a crystalline germanium dioxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 245° C. and the pressure was gradually decreased to 13.3 Pa (0.1 Torr), the first stage initial polycondensation was carried out for 50 minutes and further polycondensation reaction was carried out at 275° C. and 13.3 Pa until the IV became about 0.56 dl/g. Pressure was released, and successively the resin in slightly pressurized state was quenched in strand-like form in cold water and chipped by a strand cutter to obtain cylinder type chips. Upon chipping, the resin temperature from the outlet of the polycondensation apparatus to the nozzle fine pore was kept about 265° C. and the entire amount was chipped within 30 minutes.

After the chipped polyester obtained by the above-mentioned melt polycondensation reaction was heated to crystallize the polyester, they were dried at about 100 to 130° C. and successively at 150° C. in nitrogen flowing condition in a static solid-phase polycondensation tower and successively polymerized at 205° C. by solid-phase polymerization. Consequently, the obtained resin was solid-phase polycondensed polyester resin with IV of 0.72 dl/g, the acetaldehyde content of 25 ppm, DEG content of 5.0% by mole, TEG content of 2.0% by mole, free TPA content of 1 ppm, free glycol content of 530 ppm, free MHET content of 12 ppm, free BHET content of 22 ppm, and cyclic trimer content of 4600 ppm. The above-mentioned solid-phase polymerized chips were treated in vibration type sieving process and air blow classifying process to adjust the fine content to be about 100 ppm.

The metal contents such as Cr were about the same as those of polyester (1)-B. The characteristics are shown in Table 2.

### (Polyester Resin (1)-F)

Polycondensation was carried out in the same manner as that for obtaining the above-mentioned polyester resin (1)-E, except that as a polycondensation catalyst, antimony trioxide was used in place of crystalline germanium dioxide in an amount to adjust the Sb remaining amount of 380 ppm and the final polycondensation temperature was adjusted to be 290° C., to obtain a polyester resin having IV=0.68 dl/g. Upon chipping, the resin temperature from the outlet of the polycondensation apparatus to the nozzle fine pore was kept about 285° C. and the entire amount was chipped within 60 minutes.

After being left for about 1 month in atmospheric air, the chipped polyester was dried and crystallized in the same manner as described. The acetaldehyde content was 200 ppm; DEG content was 5.5% by mole; TEG content was 0.3% by mole; free TPA content was 12 ppm; free glycol content was 1800 ppm; free MHET content was 80 ppm; free BHET content was 130 ppm; cyclic trimer content was 9900 ppm; and the fine content was about 1.5% by weight. The metal contents such as Cr were about the same as those of polyester (1)-B. The characteristics are shown in Table 2.

TABLE 2
Characteristics of polyester resin (1) used for Examples and
Comparative Examples

| | | | | | | | | | | | | Haze of |
|---|---|---|---|---|---|---|---|---|---|---|---|---|
| | | | | | | | Free | Free | Free | Free | Color b | molded |
| | | IV | AA | DEG | TEG | CT | TPA | GL | MHET | BHET | vaule of | plate |
| | | (dl/g) | (ppm) | (mol %) | (mol %) | (ppm) | (ppm) | (ppm) | (ppm) | (ppm) | chips | (%) |
| Polyester | E | 0.72 | 25 | 5.0 | 0.2 | 4600 | 1 | 530 | 12 | 22 | 1.4 | 5.5 |
| resin (1) | F | 0.68 | 200 | 5.5 | 0.3 | 9900 | 12 | 1800 | 80 | 130 | 1.7 | 57.5 |

Haze of molded plate: polyester resin (1) = haze of 4 mm-thick molded plate

### (Polyester Resin (1)-G)

A heat medium-circulation type esterification reactor equipped with a stirrer made of SUS 316L was loaded with 1162 kg of highly pure terephthalic acid, ethylene glycol in a mole amount 2 times as much, and triethylamine in an amount of 0.3% by mole relative to the acid component and while water was removed outside, esterification reaction was carried out at 245° C. and 0.25 MPa pressure for 2 hours to obtain a mixture (hereinafter, referred to as BHET mixture) of bis(2-hydroxyethyl) terephthalate with 95% esterification ratio and oligomer. The BHET mixture was transported to a polycondensation apparatus equipped with a stirrer made of SUS 316L and as polycondensation catalyst, a solution obtained by heating a crystalline germanium dioxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 245° C. and the pressure was gradually decreased to 13.3 Pa (0.1 Torr), the first stage initial polycondensation was carried out for 50 minutes and further polycondensation reaction was carried out at 275° C. and 13.3 Pa until the IV became about 0.65 dl/g. Pressure was released, and successively the resin in slightly pressurized state was quenched in strand-like form in cold water and chipped by a strand cutter to obtain cylinder type chips. Upon chipping, the resin temperature from the outlet of the polycondensation apparatus to the nozzle fine pore was kept about 265° C. and the entire amount was chipped within 30 minutes.

Next, the chips were immediately heated at about 50 to 150° C. by vacuum drier and treated in vibration type sieving process and air blow classifying process to obtain crystallized polymer. The drying condition was adjusted to control water content to be 3500 ppm. The characteristics are shown in Table 3.

### (Polyester Resin (1)-H)

Melt polycondensation reaction was carried out in the same conditions as those for obtaining the above-mentioned polyester resin (1)-G until IV became about 0.56 dl/g, except that the polycondensation time was shortened.

After the chipped polyester obtained by the above-mentioned melt polycondensation reaction was heated to crystallize the polyester, they were dried at about 100 to 130° C. and successively at 150° C. in nitrogen flowing condition in a static solid-phase polycondensation tower and successively polymerized at 205° C. by solid-phase polymerization. The obtained polyester was left in a room to control water content to be 700 ppm. The characteristics are shown in Table 3.

### (Polyester Resin (1)-I)

Polycondensation was carried out to obtain a polyester resin having IV=0.68 dl/g in the same manner as that for obtaining the above-mentioned polyester resin (1)-G, except that as a polycondensation catalyst, antimony trioxide was used in place of crystalline germanium dioxide in an amount to adjust the Sb remaining amount of 180 ppm and the P remaining amount was adjusted to be about 500 ppm. The obtained polyester was dried and crystallized in the same manner, except that the final treatment temperature was changed to be 180° C. The drying condition was adjusted to control the water content to be 3500 ppm. The characteristics are shown in Table 3.

### (Polyester Resin (1)-J)

Polycondensation was carried out to obtain a polyester resin having IV=0.55 dl/g in the same manner as that for obtaining the above-mentioned polyester resin (1)-G, except that as a polycondensation catalyst, antimony trioxide was used in place of crystalline germanium dioxide in an amount to adjust the Sb remaining amount of 170 ppm and the P remaining amount was adjusted to be about 9000 ppm. The obtained polyester was subjected to solid-phase polymerization in the same manner as for the polyester resin (1)-H. The drying condition was adjusted to control the water content to be 3500 ppm. The characteristics are shown in Table 3.

### (Polyester Resin (1)-K, L)

The above-mentioned drying condition for the polyester resin (1)-H was adjusted to obtain polyester resin (1)-K with a water content of 46 ppm, and to moisturize and obtain the polyester resin (1)-L with a water content of 12000 ppm. The characteristics are shown in Table 3.

### (Polyester Resin (1)-M)

Polycondensation was carried out to obtain a polyester resin having IV=0.55 dl/g in the same manner as that for obtaining the above-mentioned polyester resin (1)-G, except that as a polycondensation catalyst, antimony trioxide was used in place of crystalline germanium dioxide in an amount to adjust the Sb remaining amount of 380 ppm and the P remaining amount was adjusted to be about 40 ppm. The obtained polyester was subjected to solid-phase polymerization in the same manner as for the polyester resin (1)-H. The drying condition was adjusted to control the water content to be 3500 ppm. The characteristics are shown in Table 3.

### (Polyester Resin (1)-N)

A heat medium-circulation type esterification reactor equipped with a stirrer made of SUS 316L was loaded with 1512 kg of highly pure terephthalic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHET mixture) of bis(2-hydroxyethyl) terephthalate with 95% esterification ratio and oligomer. The BHET mixture was transported to a polycondensation apparatus equipped with a stirrer made of SUS 316L and as polycondensation catalyst, a solution obtained by heating a crystalline germanium dioxide/ethylene glycol solution, phosphoric acid, and ethylene glycol was added in a proper amount to adjust the Ge remaining amount to be about 20 ppm and triethylphosphoric acid as P remaining amount to be about 16000 ppm relative to the obtained polyester. Next, the resulting mixture was stirred at 255° C. and normal pressure for 10 minutes in nitrogen atmosphere. Thereafter, while the resulting reaction system was gradually heated to 260° C. and the pressure was gradually decreased to 13.3 Pa (0.1 Torr), the first stage initial polycondensation was carried out for 50 minutes and further polycondensation reaction was carried out at 285° C. and 13.3 Pa, however gelation occurred to make polymerization impossible.

TABLE 3
Characteristics of polyester resin (1) and polyester resin (2)
used for Examples and Comparative Examples

| | | | | | | | | | | Haze |
|---|---|---|---|---|---|---|---|---|---|---|
| | | | | | | | | | Color b | of |
| | | | | | | | P | Water | value | molded |
| | | IV | AA | DEG | TEG | CT | content | content | of | plate |
| | | (dl/g) | (ppm) | (mol %) | (mol %) | (ppm) | (ppm) | (ppm) | chips | (%) |
| Polyester | G | 0.65 | 43 | 4.7 | 0.2 | 8300 | 2000 | 3500 | 1.2 | 17.0 |
| resin (1) | H | 0.72 | 25 | 5.0 | 0.2 | 4600 | 2000 | 700 | 1.3 | 5.3 |
| | I | 0.68 | 45 | 4.3 | 0.3 | 4600 | 500 | 3500 | 1.5 | 20.2 |
| | J | 0.72 | 23 | 4.7 | 0.2 | 4300 | 9000 | 3500 | 1.5 | 15.4 |
| | K | 0.72 | 25 | 5.0 | 0.2 | 4600 | 2000 | 46 | 1.3 | 5.3 |
| | L | 0.72 | 25 | 5.0 | 0.2 | 4600 | 2000 | 12000 | 1.3 | 5.3 |
| | M | 0.73 | 15 | 2.8 | 0.2 | 3300 | 40 | 3500 | 1.5 | 63.0 |
| | N | Polymerization | — | — | — | — | 16000 | — | — | — |
| | | was impossible | | | | | | | | |
| (2) | d | 0.74 | 3.2 | 2.6 | 0.1 | 3200 | 35 | 35 | 1.0 | 5.1 |
| | e | 0.73 | 5.0 | 2.6 | 0.1 | 3300 | 7 | 35 | 1.0 | 5.3 |
| | f | 0.75 | 5.1 | 2.6 | 0.1 | 3100 | 12 | 30 | 1.3 | 27.8 |

Haze of molded plate:
polyester resin (1) = haze of 4 mm-thick molded plate
polyester resin (2) = haze of 5 mm-thick molded plate

### (Polyester Resin (1N)-A)

A heat medium-circulation type esterification reactor equipped with a stirrer made of Hastelloy was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of Hastelloy and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 255° C. and normal pressure for 10 minutes in nitrogen atmosphere. Thereafter, while the resulting reaction system was gradually heated to 280° C. and the pressure was gradually decreased to 13.3 Pa (0.1 Torr), the first stage initial polycondensation was carried out for 50 minutes and further polycondensation reaction was carried out at 295° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 295° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.65 dl/g, the acetaldehyde content was 43 ppm, DEG content was 4.7% by mole, Cr element content, Fe element content, Ni element content, and Zn element content were all 0.1 ppm. The characteristics are shown in Table 4.

### (Polyester Resin (1N)-B)

Melt polycondensation reaction was carried out in the same conditions as those for obtaining the above-mentioned polyester resin (1N)-A until IV became about 0.56 dl/g, except that a heat medium-circulation type esterification reactor equipped with a stirrer made of SUS 316L was used and the polycondensation time was shortened.

After the chipped polyester obtained by the above-mentioned melt polycondensation reaction was heated to crystallize the polyester, they were dried at about 100 to 130° C. and successively at 150° C. in nitrogen flowing condition in a static solid-phase polycondensation tower and successively polymerized at 205° C. by solid-phase polymerization. IV was 0.72 dl/g, the acetaldehyde content was 25 ppm, and DEG content was 5.0% by mole. The characteristics are shown in Table 4.

### (Polyester Resin (1N)-C)

Polycondensation was carried out in the same conditions as those for obtaining the above-mentioned polyester resin (1N)-A to obtain a polyester resin having IV=0.68 dl/g, except that a heat medium-circulation type esterification reactor equipped with a stirrer made of SUS 316 was used and antimony trioxide was used in place of crystalline germanium dioxide in an amount to adjust the Sb remaining amount of 180 ppm. The obtained resin was dried and crystallized in the same manner as described above. The acetaldehyde content was 50 ppm and DEG content was 5.5% by mole. The characteristics are shown in Table 4.

### (Polyester Resin (1N)-D)

A heat medium-circulation type esterification reactor equipped with a stirrer made of SUS 316L was loaded with 756 kg of naphthalenedicarboxylic acid, 983 g of highly pure terephthalic acid, ethylene glycol in a mole amount 2 times as much, and triethylamine in an amount of 0.3% by mole relative to the acid component and while water was removed outside, esterification reaction was carried out at 245° C. and 0.25 MPa pressure for 2 hours to obtain a mixture (hereinafter, referred to as BHEN mixture) of bis(2-hydroxyethyl) naphthalate and bis(2-hydroxyethyl) terephthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 250° C. and the pressure was gradually decreased to 13.3 Pa (0.1 Torr), the first stage initial polycondensation was carried out for 50 minutes and further polycondensation reaction was carried out at 275° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 270° C. and the entire amount was chipped within 30 minutes.

Next, the chips were immediately heated at about 50 to 150° C. by vacuum drier and treated in vibration type sieving process and air blow classifying process to obtain a crystallized polymer. The resin composition consisted of 50% by mole of naphthalenedicarboxylic acid and 50% by mole of terephthalic acid; and IV was 0.65 dl/g, the acetaldehyde content was 45 ppm, and DEG content was 4.7% by mole. The characteristics are shown in Table 4.

### (Polyester Resin (1N)-E)

A heat medium-circulation type esterification reactor equipped with a stirrer made of SUS 316L was loaded with 590 kg of naphthalenedicarboxylic acid, 1058 kg of highly pure terephthalic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate and bis(2-hydroxyethyl) terephthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 250° C. and the pressure was gradually decreased to 13.3 Pa (0.1 Torr), the first stage initial polycondensation was carried out for 50 minutes and further polycondensation reaction was carried out at 275° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 270° C. and the entire amount was chipped within 30 minutes.

Next, the chips were immediately heated at about 50 to 150° C. by vacuum drier and treated in vibration type sieving process and air blow classifying process to obtain a crystallized polymer. The resin composition consisted of 30% by mole of naphthalenedicarboxylic acid and 70% by mole of terephthalic acid; and IV was 0.65 dl/g, the acetaldehyde content was 45 ppm, and DEG content was 4.7% by mole. The characteristics are shown in Table 4.

### (Polyester Resin (1N)-F)

A heat medium-circulation type esterification reactor equipped with a stirrer made of SUS 316L was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of Hastelloy and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 200 ppm relative to the obtained polyester. Next, the resulting mixture was stirred at 255° C. and normal pressure for 10 minutes in nitrogen atmosphere. Thereafter, while the resulting reaction system was gradually heated to 265° C. and the reaction system pressure was gradually decreased to 13.3 Pa (0.1 Torr), the first stage initial polycondensation was carried out for 50 minutes and further polycondensation reaction was carried out at 280° C. and 13.3 Pa until the IV became about 0.65 dl/g. Pressure was released and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 280° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.63 dl/g, the acetaldehyde content was 28 ppm, and DEG content was 3.7% by mole. The characteristics are shown in Table 4.

### (Polyester Resin (1N)-G)

A heat medium-circulation type esterification reactor made of SUS 316L was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 9000 ppm relative to the obtained polyester. Next, the resulting mixture was stirred at 255° C. and normal pressure for 10 minutes in nitrogen atmosphere. Thereafter, while the resulting reaction system was gradually heated to 280° C. and the reaction system pressure was gradually decreased to 13.3 Pa (0.1 Torr), the first stage initial polycondensation was carried out for 50 minutes and further polycondensation reaction was carried out at 295° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 295° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.65 dl/g, the acetaldehyde content was 46 ppm, and DEG content was 6.8% by mole. The characteristics are shown in Table 4.

### (Polyester Resin (1N)-H) (Production Method of Polyester of Comparative Example)

A heat medium-circulation type esterification reactor made of SUS 304 was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of SUS 304 and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 255° C. and normal pressure for 10 minutes in nitrogen atmosphere. Thereafter, while the resulting reaction system was gradually heated to 280° C. and the reaction system pressure was gradually decreased to 13.3 Pa (0.1 Torr), the first stage initial polycondensation was carried out for 50 minutes and further polycondensation reaction was carried out at 295° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 295° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.65 dl/g, the acetaldehyde content was 43 ppm, and DEG content was 4.7% by mole. The characteristics are shown in Table 4.

### (Polyester Resin (1N)-I) (Production Method of Polyester of Comparative Example)

A heat medium-circulation type esterification reactor made of SUS 316L was loaded with 295 kg of naphthalenedicarboxylic acid, 1285 kg of highly pure terephthalic acid, ethylene glycol in a mole amount 2 times as much, and triethylamine in an amount of 0.3% by mole relative to the acid component and while water was removed outside, esterification reaction was carried out at 245° C. and 0.25 MPa pressure for 2 hours to obtain a mixture (hereinafter, referred to as BHEN mixture) of bis(2-hydroxyethyl) naphthalate and bis(2-hydroxyethyl) terephthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 2000 ppm relative to the obtained polyester. Next, the resulting mixture was stirred at 245° C. and normal pressure for 10 minutes in nitrogen atmosphere. Thereafter, while the resulting reaction system was gradually heated to 250° C. and the reaction system pressure was gradually decreased to 13.3 Pa (0.1 Torr), the first stage initial polycondensation was carried out for 50 minutes and further polycondensation reaction was carried out at 275° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 270° C. and the entire amount was chipped within 30 minutes.

Next, the chips were immediately heated at about 50 to 150° C. by vacuum drier and treated in vibration type sieving process and air blow classifying process to obtain a crystallized polymer. The resin composition consisted of 15% by mole of naphthalenedicarboxylic acid and 85% by mole of terephthalic acid; and IV was 0.65 dl/g, the acetaldehyde content was 45 ppm, and DEG content was 4.7% by mole. The characteristics are shown in Table 4.

### (Polyester Resin (1N)-J) (Production Method of Polyester of Comparative Example)

A heat medium-circulation type esterification reactor made of SUS 316L was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 60 ppm relative to the obtained polyester. Next, the resulting mixture was stirred at 255° C. and normal pressure for 10 minutes in nitrogen atmosphere. Thereafter, while the resulting reaction system was gradually heated to 280° C. and the reaction system pressure was gradually decreased to 13.3 Pa (0.1 Torr), the first stage initial polycondensation was carried out for 50 minutes and further polycondensation reaction was carried out at 295° C. and 13.3 Pa until the IV became about 0.65 dl/g. Pressure was released, and successively the resin in slightly pressurized state was discharged to cold water, quenched in strand-like state, and chipped by a strand cutter to obtain cylinder type chips. Upon chipping, the resin temperature from the outlet of the polycondensation apparatus to the nozzle fine pore was kept about 295° C. and the entire amount was chipped within 30 minutes.

Next, the chips were immediately heated at about 50 to 150° C. by vacuum drier and treated in vibration type sieving process and air blow classifying process to obtain a crystallized polymer. IV was 0.65 dl/g, the acetaldehyde content was 18 ppm, and DEG content was 2.0% by mole. The characteristics are shown in Table 4.

### (Polyester Resin (1N)-K) (Production Method of Polyester of Comparative Example)

A heat medium-circulation type esterification reactor made of SUS 316L was loaded with 1512 kg of naphthalenedicarboxylic acid, ethylene glycol in a mole amount 2 times as much, and triethylamine in an amount of 0.3% by mole relative to the acid component and while water was removed outside, esterification reaction was carried out at 255° C. and 0.25 MPa pressure for 2 hours to obtain a mixture (hereinafter, referred to as BHEN mixture) of bis(2-hydroxyethyl) naphthalate with 95% esterification ratio and oligomer. The BHEN mixture was transported to a polycondensation apparatus equipped with a stirrer made of SUS 316L and as polycondensation catalyst, a solution obtained by heating a crystalline germanium oxide/ethylene glycol solution, phosphoric acid, and ethylene glycol was added in a proper amount to adjust the Ge remaining amount to be about 20 ppm and P remaining amount to be about 16000 ppm relative to the obtained polyester. Next, the resulting mixture was stirred at 255° C. and normal pressure for 10 minutes in nitrogen atmosphere. Thereafter, while the resulting reaction system was gradually heated to 280° C. and the reaction system pressure was gradually decreased to 13.3 Pa (0.1 Torr), the first stage initial polycondensation was carried out for 50 minutes and further polymerization was carried out at 295° C. and 13.3 Pa, however gelation occurred to make polymerization impossible. The characteristics are shown in Table 4.

TABLE 4
Polyester resin (1N) used for Examples and Comparative Examples

| | | | | | | | | | | | | | Color b | Material |
|---|---|---|---|---|---|---|---|---|---|---|---|---|---|---|
| | | | | | | P | | | | | | | value | of |
| | | Composition (% by mole) | | | | content | Metal content (ppm) | | | | IV | AA | of | reaction |
| | | ND | TPA | EG | DEG | (ppm) | Fe | Cr | Ni | Zn | (dl/g) | (ppm) | chips | container |
| Polyester | A | 100 | 0 | 95.3 | 4.7 | 2000 | 0.1 | 0.1 | 0.1 | 0.1 | 0.65 | 43 | 1.8 | Hastelloy |
| resin (1N) | B | 100 | 0 | 95.0 | 5.0 | 2000 | 8 | 3 | 2 | 1 | 0.72 | 25 | 2.0 | SUS316L |
| | C | 100 | 0 | 94.5 | 5.5 | 2000 | 22 | 6 | 3 | 2 | 0.68 | 50 | 2.2 | SUS316 |
| | D | 50 | 50 | 95.3 | 4.7 | 2000 | 7 | 3 | 2 | 1 | 0.65 | 45 | 1.5 | SUS316L |
| | E | 30 | 70 | 95.3 | 4.7 | 2000 | 7 | 3 | 1 | 1 | 0.65 | 45 | 1.3 | SUS316L |
| | F | 100 | 0 | 96.3 | 3.7 | 200 | 1.6 | 0.6 | 0.2 | 0.1 | 0.63 | 28 | 1.9 | SUS316L |
| | G | 100 | 0 | 93.2 | 6.8 | 9000 | 27 | 8 | 3 | 3 | 0.65 | 46 | 2.4 | SUS316L |
| | H | 100 | 0 | 95.3 | 4.7 | 2000 | 35 | 19 | 8 | 7 | 0.65 | 43 | 8.9 | SUS304 |
| | I | 15 | 85 | 95.3 | 4.7 | 2000 | 7 | 3 | 2 | 2 | 0.65 | 45 | 1.4 | SUS316L |
| | J | 100 | 0 | 98.0 | 2.0 | 60 | 3.2 | 1.1 | 0.2 | 0.2 | 0.65 | 18 | 2.0 | SUS316L |

| | | | | | | |
|---|---|---|---|---|---|---|
| K | 100 | 0 | 98.0 | 2.0 | 16000 | Polymerization was impossible |

**) ND = 2,6-naphthalenedicarboxylic acid; TPA = highly pure terephthalic acid; EG = ethylene glycol; DEG = diethylene glycol

### (Polyester Resin (2)-a)

Slurries containing highly pure terephthalic acid and ethyl glycol were continuously supplied to a first esterification reactor previously containing a reaction product, and under a stirring condition, reaction was carried out in average retention period for 3 hours at about 250° C. and 0.5 kg/cm² G. The reaction product was sent to the second esterification reactor and under a stirring condition, reaction was carried out at about 260° C. and 0.05 kg/cm² G to an extent of a prescribed reaction degree. Further, an ethylene glycol solution of basic aluminum acetate and an ethylene glycol solution previously containing heated Irganox 1222 (manufactured by Ciba Specialty Chemicals Inc.) and ethylene glycol were continuously supplied to the second esterification reactor. The esterification reaction product was continuously supplied to a first polycondensation reactor and under a stirring condition, reaction was carried out at about 265° C. and 25 torr for 1 hour; successively reaction was carried out at about 265° C. and 3 torr for 1 hour in a second polycondensation reactor; and further reaction was carried out at about 275° C. and 0.3 to 1 torr in a final polycondensation reactor. The intrinsic viscosity of the melt polycondensed PET was 0.55 dl/g. The polycondensed product was chipped to obtain cylinder type chips and successively crystallized at about 155° C. in nitrogen atmosphere and after being preheated at about 200° C. in nitrogen atmosphere, the crystallized chips were sent to a continuous solid-phase polymerization reactor and polymerized at about 207° C. After the solid-phase polymerization, sieving process and fine removal process were continuously carried out to remove fines.

The intrinsic viscosity of obtained PET was 0.74 dl/g, the acetaldehyde content was 3.2 ppm, DEG content was 2.6% by mole, cyclic trimer content was 0.33% by mole, and density was 1.400 g/cm³. The Al remaining amount was 20 ppm, P remaining amount was 35 ppm, and fine content was about 50 ppm. The characteristics are shown in Table 1.

### (Polyester Resin (2)-b)

A melt polycondensed PET was obtained in the same method as the case for the above-mentioned polyester resin (2)-a, except that an ethylene glycol solution of titanium tetrabutoxide and an ethylene glycol solution of magnesium acetate tetrahydrate were used as polycondensation catalyst, and an ethylene glycol solution of phosphoric acid was used as a stabilizer. The intrinsic viscosity of obtained melt-polycondensed PET was 0.58 dl/g.

Next, solid-phase polymerization was carried out in the same manner as the case of the above-mentioned polyester resin (2)-a. The intrinsic viscosity of obtained PET was 0.75 dl/g, the acetaldehyde content was 4.5 ppm, DEG content was 2.6% by mole, cyclic trimer content was 3500 ppm, and density was 1.399 g/cm³. The Ti remaining amount was 3.5 ppm, Mg remaining amount was 2 ppm, P remaining amount was 7 ppm, and fine content was about 50 ppm. The characteristics are shown in Table 1.

### (Polyester Resin (2)-c)

A melt polycondensed PET was obtained in the same method as the case for the above-mentioned polyester resin (2)-a, except that an ethylene glycol solution of antimony trioxide was used as polycondensation catalyst and an ethylene glycol solution of phosphoric acid was used as a stabilizer. The intrinsic viscosity of obtained melt-polycondensed PET was 0.61 dl/g. Next, solid-phase polymerization was carried out in the same manner as the case of the above-mentioned polyester resin (2)-a except that it was carried out at 290° C.

The intrinsic viscosity of obtained PET was 0.75 dl/g, the acetaldehyde content was 6.5 ppm, DEG content was 2.6% by mole, cyclic trimer content was 7300 ppm, and density was 1.392 g/cm³. The Sb remaining amount was 350 ppm, P remaining amount was 15 ppm, and fine content was about 50 ppm. The characteristics are shown in Table 1.

### (Polyester Resin (2)-d)

A slurry containing highly pure terephthalic acid and ethyl glycol were continuously supplied to a first esterification reactor previously containing a reaction product and under a stirring condition, reaction was carried out in average retention period for 3 hours at about 250° C. and 0.5 kg/cm² G. The reaction product was sent to a second esterification reactor and under a stirring condition, reaction was carried out at about 260° C. and 0.05 kg/cm² G to an extent of a prescribed reaction degree. Further, an ethylene glycol solution of basic aluminum acetate and an ethylene glycol solution previously containing heated Irganox 1222 (manufactured by Ciba Specialty Chemicals Inc.) and ethylene glycol were continuously supplied to the second esterification reactor. The esterification reaction product was continuously supplied to a first polycondensation reactor under a stirring condition, reaction was carried out at about 265° C. and 25 torr for 1 hour; successively reaction was carried out at about 265° C. and 3 torr for 1 hour in a second polycondensation reactor; and further reaction was carried out at about 275° C. and 0.3 to 1 torr in a final polycondensation reactor. The intrinsic viscosity of the melt polycondensed PET was 0.55 dl/g. The polycondensed product was chipped to obtain cylinder type chips and successively crystallized at about 155° C. in nitrogen atmosphere and after being preheated at about 200° C. in nitrogen atmosphere, the crystallized chips were sent to a continuous solid-phase polymerization reactor and polymerized at about 207° C. After the solid-phase polymerization, sieving process and fine removal process were continuously carried out to remove fines.

The intrinsic viscosity of obtained PET was 0.74 dl/g, the acetaldehyde content was 3.2 ppm, DEG content was 2.6% by mole, and cyclic trimer content was 0.32% by mole. The Al remaining amount was 20 ppm and P remaining amount was 35 ppm. The water content was adjusted to be 35 ppm by vacuum drying. The characteristics are shown in Table 3. The fine content was about 50 ppm.

### (Polyester Resin (2)-e)

A melt polycondensed PET was obtained in the same method as the case for the above-mentioned polyester resin (2)-a, except that an ethylene glycol solution of titanium tetrabutoxide and an ethylene glycol solution of magnesium acetate tetrahydrate were used as polycondensation catalyst, and an ethylene glycol solution of phosphoric acid was used as a stabilizer. The intrinsic viscosity of obtained melt-polycondensed PET was 0.58 dl/g.

Next, solid-phase polymerization was carried out in the same manner as the case of the above-mentioned polyester resin (2)-d. The intrinsic viscosity of obtained PET was 0.73 dl/g, the acetaldehyde content was 5 ppm, DEG content was 2.6% by mole, and cyclic trimer content was 3300 ppm. The Ti remaining amount was 3.5 ppm, Mg remaining amount was 2 ppm, P remaining amount was 7 ppm, fine content was about 50 ppm, and water content was 35 ppm. The characteristics are shown in Table 3.

### (Polyester Resin (2)-f)

A melt polycondensed PET was obtained in the same method as the case for the above-mentioned polyester resin (2)-d, except that an ethylene glycol solution of antimony trioxide was used as polycondensation catalyst and an ethylene glycol solution of phosphoric acid was used as a stabilizer. The intrinsic viscosity of obtained melt-polycondensed PET was 0.57 dl/g. Next, solid-phase polymerization was carried out in the same manner as the case of the above-mentioned polyester resin (2)-d.

The intrinsic viscosity of obtained PET was 0.75 dl/g, the acetaldehyde content was 5.1 ppm, DEG content was 2.6% by mole, and cyclic trimer content was 3100 ppm. The Sb remaining amount was 290 ppm, P remaining amount was 12 ppm, and water content was 30 ppm. The characteristics are shown in Table 3. The fine content was about 50 ppm.

### Example 1

The above-mentioned polyester resin (2)-a in an amount of 98 parts by weight and polyester resin (1)-A for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 60 ppm, Bₜ−B₀ was 10.1 ppm, the haze of the molded plate was 6.0%, color b value was 0.3, and the sensory test evaluation was \textcircled{•}, and accordingly, there was no problem. The Tc1 of the molded plate was 167° C. and thus good with no problem.

The cyclic trimer increase amount (ΔCT) calculated by the method described in (5) was 0.10% by weight without any problem. Results are shown in Table 5.

### Example 2

The above-mentioned polyester resin (2)-a in an amount of 98 parts by weight and polyester resin (1)-B for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 70 ppm, Bₜ−B₀ was 10.3 ppm, the haze of the molded plate was 6.1%, color b value was 0.5, and the sensory test evaluation was \textcircled{•}, and accordingly, there was no problem. The Tc1 of the molded plate was 165° C. and ΔCT was 0.11% by weight and they were thus good with no problem. Results are shown in Table 5.

### Example 3

The above-mentioned polyester resin (2)-b in an amount of 98 parts by weight and polyester resin (1)-B for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 100 ppm, Bₜ−B₀ was 11.0 ppm, the haze of the molded plate was 6.3%, color b value was 0.9, and the sensory test evaluation was ∘, and accordingly, there was no problem. The Tc1 of the molded plate was 169° C. and ΔCT was 0.12% by weight and thus they were good with no problem. Results are shown in Table 5.

### Example 4

The above-mentioned polyester resin (2)-b in an amount of 98 parts by weight and polyester resin (1)-C for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 90 ppm, Bₜ−B₀ was 11.3 ppm, the haze of the molded plate was 9.5%, color b value was 1.2, and the sensory test evaluation was ∘, and accordingly, there was no problem. The Tc1 of the molded plate was 164° C. and ΔCT was 0.12% by weight and thus they were good with no problem. Results are shown in Table 5.

### Comparative Example 1

The above-mentioned polyester resin (2)-a in an amount of 98 parts by weight and polyester resin (1)-D for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 100 ppm, Bₜ−B₀ was 31.0 ppm, the haze of the molded plate was 31.0%, Tc1 was 154° C., ΔCT was 0.28% by weight, and color b value was 1.2, and thus they were bad. The sensory test evaluation was x and accordingly it was bad. Results are shown in Table 5.

### Comparative Example 2

The above-mentioned polyester resin (2)-c in an amount of 98 parts by weight and polyester resin (1)-D for catalyst deactivation in an amount of 2 parts by weight were mixed by a blender. Thereafter, a stepped molded plate was produced by the method described in (14) and a bottle, which was a hollow molded article, was produced by the method described in (15).

The Aₜ−A₀ of the molded plate was 800 ppm, Bₜ−B₀ was 48.3 ppm, the haze of the molded plate was 51.7%, Tc1 was 133° C., and color b value was 6.2, and thus they were bad. The sensory test evaluation was xx and accordingly it was bad. Further, ΔCT was as high as 0.53% by weight. Results are shown in Table 5.

TABLE 5
Examples and Comparative Examples (1)

| | | | Component | | | | | | | | |
|---|---|---|---|---|---|---|---|---|---|---|---|
| | | | (calculated | | | | | | | | |
| | | | value) | | Molded article | | | | | | |
| | Composition | | AA | CT | | | | | | ΔCT | |
| | Polyester | Polyester | content | content | | | | | | (% | Bottle |
| | resin | resin | B₀ | A₀ | Aₜ − Aₒ | Bₜ − Bₒ | Haze | Color b | Tcl | by | Sensory |
| | (1) | (2) | (ppm) | (ppm) | (ppm) | (ppm) | (%) | value | (° C.) | weight) | test |
| Example 1 | A | a | 4.0 | 3380 | 60 | 10.1 | 6.0 | 0.3 | 167 | 0.10 | ⊙ |
| Example 2 | B | a | 3.7 | 3350 | 70 | 10.3 | 6.1 | 0.5 | 165 | 0.11 | ⊙ |
| Example 3 | B | b | 4.9 | 3550 | 100 | 11.0 | 6.3 | 0.9 | 169 | 0.12 | |
| Example 4 | C | b | 5.4 | 3560 | 90 | 11.3 | 9.5 | 1.2 | 164 | 0.12 | |
| Comparative | D | a | 7.7 | 3420 | 100 | 31.0 | 31.0 | 4.8 | 154 | 0.28 | X |
| Example 1 | | | | | | | | | | | |
| Comparative | D | c | 11.0 | 7340 | 800 | 48.3 | 51.7 | 6.2 | 133 | 0.53 | XX |
| Example 2 | | | | | | | | | | | |

### Example 5

The above-mentioned polyester resin (2)-a in an amount of 98 parts by weight and polyester resin (1)-E in an amount of 2 parts by weight were mixed by a blender. Thereafter, a stepped molded plate was produced by the method described in (14) and a bottle, which was a hollow molded article, was produced by the method described in (15).

The haze of the stepped molded plate (5 mm thickness) was 6.0%, acetaldehyde content was 12.0 ppm, and the sensory test evaluation was \textcircled{•} and accordingly, there was no problem. The Tc1 of the molded plate was 169° C. and transparency of the bottle was 1.0% and thus they were good with no problem. Results are shown in Table 6.

### Comparative Example 3

The above-mentioned polyester resin (2)-c in an amount of 98 parts by weight and polyester resin (1)-F in an amount of 2 parts by weight were mixed by a blender. Thereafter, a stepped molded plate was produced by the method described in (14) and a bottle, which was a hollow molded article, was produced by the method described in (15).

The haze of the stepped molded plate (5 mm thickness) was 44.0%, Tc1 was 135° C., acetaldehyde content was 55 ppm, and the sensory test evaluation was xx, and accordingly it was a problem. The transparency of the bottle was 5.8%. Results are shown in Table 6.

TABLE 6
Examples and Comparative Examples (2)

| | | | Component | | | | | |
|---|---|---|---|---|---|---|---|---|
| | | | (calculated value) | | | | | |
| | Composition | | AA | CT | Molded article | | | Bottle |
| | Polyester | Polyester | content | content | AA | Haze | Tcl | Sensory |
| | resin (1) | resin (2) | B₀ (ppm) | A₀ (ppm) | (ppm) | (%) | (° C.) | test |
| Example 5 | E | a | 3.6 | 3330 | 12.0 | 6.0 | 169 | ⊙ |
| Comparative | F | c | 8.8 | 3530 | 55.0 | 44.0 | 135 | XX |
| Example 3 | | | | | | | | |

### Example 6

The above-mentioned polyester resin (2)-d in an amount of 98 parts by weight and polyester resin (1)-G for catalyst deactivation in an amount of 2 parts by weight were mixed by a blender. Thereafter, a stepped molded plate was produced by the method described in (14) and a bottle was produced by the method described in (15).

The CT content of the polyester resin composition was 3300 ppm, the CT content of the molded plate was 3200 ppm, the cyclic trimer increase amount by molding was −100 ppm, the acetaldehyde content increase amount Bₜ−B₀ was 9.0 ppm, IV retention ratio was 95%, the appearance of the molded product was ∘ and thus good, the sensory test evaluation was ∘ and thus good, and further, the bottle appearance evaluation by a continuous molding accelerated test was also ∘ and accordingly, there was no problem. Results are shown in Table 7.

### Examples 7 to 12

Tests were carried out for Examples 7 to 12 similarly to those for Example 6 and all of the evaluation items had no problem. Results are shown in Table 7.

### Comparative Example 4

The above-mentioned polyester resin (2)-d in an amount of 98 parts by weight and polyester resin (1)-K for catalyst deactivation in an amount of 2 parts by weight were mixed by a blender. Thereafter, a stepped molded plate was produced by the method described in (14) and a bottle was produced by the method described in (15).

Although IV retention ratio was 98%, the appearance of the molded product was ∘ and thus good, and the sensory test evaluation was ∘; the CT content of the polyester resin composition was 3230 ppm, the CT content of the molded plate was 3340 ppm, the cyclic trimer increase by molding was 110 ppm, Bₜ−B₀ was 11.6 ppm, and further, the bottle appearance evaluation by a continuous molding accelerated test was also bad as x. Results are shown in Table 7.

### Comparative Examples 5 to 7

Tests were carried out for Comparative Examples 5 to 7 similarly to those for Example 6 and there were some characteristics where are unsatisfactory and therefore evaluation results were unsatisfactory. Results are shown in Table 7.

### Comparative Example 8

The above-mentioned polyester resin (2)-e in an amount of 100 parts by weight was molded to give a stepped molded plate by the method described in (14) and a bottle by the method described in (15).

Although IV retention ratio was 98% and the appearance of the molded product was ∘ and thus good; the CT content of the polyester resin composition was 3200 ppm, the CT content of the molded plate was 4000 ppm, the cyclic trimer increase by molding was 800 ppm, Bₜ−B₀ was 20.0 ppm, the sensory test evaluation was Δ, and further, the bottle appearance evaluation by a continuous molding accelerated test was also bad as x. Results are shown in Table 7.

### Comparative Example 9

The composition of Comparative Example 9 in Table 7 was evaluated in the same manner as described above. Although IV retention ratio was 95% and the appearance of the molded product was ∘ and thus good; the CT content of the molded plate was 4200 ppm, the cyclic trimer increase by molding was 1000 ppm, Bₜ−B₀ was 35.4 ppm, the sensory test evaluation was xx, and the bottle appearance evaluation by a continuous molding accelerated test was also bad as x. Results are shown in Table 7.

### Example 1N

The above-mentioned polyester resin (2)-d in an amount of 98 parts by weight and polyester resin (1N)-A for catalyst deactivation in an amount of 2 parts by weight were mixed by a blender. Thereafter, a stepped molded plate was produced by the method described in (14) and a bottle, which was a hollow molded article, was produced by the method described in (15).

The haze of the stepped molded plate (5 mm thickness) was 6.5%, ultraviolet ray shutting property was 99%, acetaldehyde content was 14.5 ppm, color b value was 0, and the sensory test evaluation was \textcircled{} and accordingly, there was no problem. The Tc1 of the molded plate was 165° C. thus there was no problem. Results are shown in Table 8.

### Example 2N

The above-mentioned polyester resin (2)-e in an amount of 98 parts by weight and polyester resin (1N)-A for catalyst deactivation in an amount of 2 parts by weight were mixed by a blender. Thereafter, a stepped molded plate was produced by the method described in (14) and a bottle, which was a hollow molded article, was produced by the method described in (15).

The haze of the stepped molded plate (5 mm thickness) was 6.8%, ultraviolet ray shutting property was 99%, acetaldehyde content was 15.8 ppm, color b value was 0, and the sensory test evaluation was ∘ and accordingly, there was no problem. The Tc1 of the molded plate was 165° C. thus there was no problem. Results are shown in Table 8.

### Examples 3N to 8N

Tests were carried out for Examples 3N to 8N similarly to those for Example 1N and there was no problem. Results are shown in Table 8.

### Comparative Example 1N

The above-mentioned polyester resin (2)-d in an amount of 98 parts by weight and polyester resin (1N)-H in an amount of 2 parts by weight were mixed by a blender. Thereafter, a stepped molded plate was produced by the method described in (14) and a bottle, which was a hollow molded article, was produced by the method described in (15).

Although the ultraviolet ray shutting property was 98% and acetaldehyde content was 13.0 ppm and thus there was no problem, the haze of the stepped molded plate (5 mm thickness) was 21.0%, Tc1 was 148° C., and color b value was 3.0, and they were thus bad. Results are shown in Table 8.

### Comparative Example 2N

The above-mentioned polyester resin (2)-d in an amount of 98 parts by weight and polyester resin (1N)-I in an amount of 2 parts by weight were mixed by a blender. Thereafter, a stepped molded plate was produced by the method described in (14) and a bottle, which was a hollow molded article, was produced by the method described in (15).

Although the haze of the stepped molded plate (5 mm thickness) was 3.5%, Tc1 was 165° C., acetaldehyde content was 12.9 ppm, color b value was 0, the sensory test evaluation was \textcircled{} and accordingly, they were normal, the ultraviolet ray shutting property was as bad as 38%. Results are shown in Table 8.

### Comparative Example 3N

The above-mentioned polyester resin (2)-d in an amount of 98 parts by weight and polyester resin (1N)-J in an amount of 2 parts by weight were mixed by a blender. Thereafter, a stepped molded plate was produced by the method described in (14) and a bottle, which was a hollow molded article, was produced by the method described in (15).

Although the ultraviolet ray shutting property was 98%, Tc1 was 165° C., color b value was 0, and thus they were no problem, the polycondensation catalyst was not deactivated and the compatibility was inferior, and therefore the haze of the stepped molded plate (5 mm thickness) was 46.0%, acetaldehyde content was 38.0 ppm, and they were thus bad. Results are shown in Table 8.

### Comparative Example 4N

The above-mentioned polyester resin (2)-f in an amount of 98 parts by weight and polyester resin (1N)-A in an amount of 2 parts by weight were mixed by a blender. Thereafter, a stepped molded plate was produced by the method described in (14) and a bottle, which was a hollow molded article, was produced by the method described in (15).

Although the ultraviolet ray shutting property was as good as 99%, the haze of the stepped molded plate (5 mm thickness) was 59.8%, acetaldehyde content was 23.3 ppm, and the sensory test evaluation was x, and accordingly they were thus bad and problematic. The Tc1 was also as low as 138° C. Results are shown in Table 8.

TABLE 7
Examples and Comparative Examples (3)

| | | | | | | | | | | | Bottle | |
|---|---|---|---|---|---|---|---|---|---|---|---|---|
| | Upper side: | | | | | | | | | | appearance | |
| | polyester | | CT (ppm) | | | | | | | | at the | |
| | used; lower | | | | CT | | | | | | time of | |
| | side: mixing | | | | increased | AA (ppm) | | | | | accelerated | |
| | ratio (wt. %) | | Polyester | | amount | Polyester | | IV | | | test | |
| | Polyester | Polyester | resin | Molded | by | resin | | retention | Molded | Bottle | 10th | 1000th |
| | resin | resin | component | plate | molding | component | Bₜ − | ratio | product | sensory | molded | molded |
| | (2) | (1N) | A₀ | Aₜ | A₀ − Aₜ | B₀ | B₀ | (%) | appearance | test | product | product |
| Example 6 | d98 | G2 | 3300 | 3200 | −100 | 4.0 | 9.0 | 95 | | | ⊙ | |
| Example 7 | e98 | G2 | 3400 | 3200 | −200 | 5.8 | 9.2 | 95 | | | ⊙ | |
| Example 9 | d98 | H2 | 3230 | 3230 | 0 | 3.6 | 10.1 | 97 | | | ⊙ | |
| Example | d96 | I4 | 3230 | 3130 | −100 | 4.0 | 9.5 | 95 | | | ⊙ | |
| 10 | | | | | | | | | | | | |
| Example | d98 | J2 | 3220 | 3020 | −200 | 3.6 | 8.9 | 93 | | | ⊙ | |
| 11 | | | | | | | | | | | | |
| Example | d60 | H10 | 3340 | 3140 | −200 | 5.4 | 10.4 | 94 | | | ⊙ | |
| 12 | | | | | | | | | | | | |
| Example | d95 | H5 | 3270 | 3170 | −100 | 4.3 | 10.0 | 96 | | | ⊙ | |
| 13 | | | | | | | | | | | | |
| Comparative | d98 | K2 | 3230 | 3340 | 110 | 3.6 | 11.6 | 98 | | | ⊙ | X |
| Example 4 | | | | | | | | | | | | |
| Comparative | d98 | L2 | 3230 | 3030 | −200 | 3.6 | 10.2 | 80 | X | Δ | X | X |
| Example 5 | | | | | | | | | | | | |
| Comparative | d98 | M2 | 3200 | 4000 | 800 | 3.4 | 17.9 | 95 | | X | ⊙ | X |
| Example 6 | | | | | | | | | | | | |
| Comparative | d80 | I20 | 3480 | 3680 | 200 | 11.6 | 10.6 | 83 | X | Δ | ⊙ | X |
| Example 7 | | | | | | | | | | | | |
| Comparative | d100 | — | 3200 | 4000 | 800 | 3.2 | 20.0 | 98 | | Δ | ⊙ | X |
| Example 8 | | | | | | | | | | | | |
| Comparative | f98 | G2 | 3200 | 4200 | 1000 | 5.9 | 35.4 | 95 | | XX | | XX |
| Example 9 | | | | | | | | | | | | |

A₀ − Aₜ = cyclic trimer increase amount by molding
B₀ − Bₜ = AA increase amount by molding

TABLE 8
Examples and Comparative Examples (4)

| | Upper side: polyester | | | | | | | |
|---|---|---|---|---|---|---|---|---|
| | used; lower side: | | | Ultraviolet | | | | |
| | mixing ratio (wt. %) | | | ray | | | | |
| | | Polyester | | shutting | | | | |
| | Polyester | resin | Haze | property | AA | Color b | Tcl | Sensory |
| | resin (2) | (1N) | (%) | (%) | (ppm) | value | (° C.) | test |
| Example 1N | d98 | A2 | 6.5 | 99 | 14.5 | 0 | 165 | ⊙ |
| Example 2N | e98 | A2 | 6.8 | 99 | 15.8 | 0 | 165 | |
| Example 3N | d98 | B2 | 7.5 | 99 | 13.8 | 0.8 | 163 | ⊙ |
| Example 4N | d98 | C2 | 8.0 | 99 | 13.9 | 1.2 | 160 | |
| Example 5N | d98 | D2 | 3.5 | 98 | 13.7 | 0 | 168 | ⊙ |
| Example 6N | d98 | E2 | 3.2 | 96 | 14.0 | 0 | 168 | ⊙ |
| Example 7N | d90 | F10 | 8.8 | 98 | 12.9 | 0.5 | 168 | ⊙ |
| Example 8N | d98 | G2 | 3.5 | 98 | 12.9 | 1.0 | 155 | ⊙ |
| Comparative | d98 | H2 | 21.0 | 98 | 13.0 | 3.0 | 148 | |
| Example 1N | | | | | | | | |
| Comparative | d98 | I2 | 3.5 | 38 | 12.9 | 0 | 165 | ⊙ |
| Example 2N | | | | | | | | |
| Comparative | d98 | J2 | 46.0 | 98 | 38.0 | 0 | 165 | XX |
| Example 3N | | | | | | | | |
| Comparative | f98 | A2 | 59.8 | 99 | 23.3 | 0 | 138 | X |
| Example 4N | | | | | | | | |

### INDUSTRIAL APPLICABILITY

A polyester resin of the present invention is a polyester resin preferably usable for deactivating a polycondensation catalyst used at polyester production and usable for suppressing formation of aldehydes such as acetaldehyde and cyclic ester oligomers at molding stage. Particularly, the polyester resin composition of the invention is a polyester resin composition excellent in transparency and taste preservation, free from a problem of worsening of transparency due to mold stains at continuous molding stage, and usable for producing hollow molded articles excellent in heat resistant size stability at a high efficiency, and a molded article having the above-mentioned characteristics can be obtained and thus the invention is remarkably advantageous in industrial sphere.

1. A polyester resin mainly consisting of an aromatic dicarboxylic acid component and a glycol component and copolymerized or mixed with a phosphorus compound in an amount of 100 to 10000 ppm in terms of phosphorus element, wherein the contents of Zn element, Fe element, Ni element, and Cr element satisfy at least one of the following formulas (A) to (D);
Cr≦10 ppm (A),
Fe≦30 ppm (B),
Ni≦5 ppm (C), and
Zn≦5 ppm (D).

2. A polyester resin mainly consisting of an aromatic dicarboxylic acid component and a glycol component and copolymerized or mixed with a phosphorus compound in an amount of 100 to 10000 ppm in terms of phosphorus element, wherein the content of free aromatic dicarboxylic acid derived from the polyester is 10 ppm or lower, the content of free glycol is 1500 ppm or lower, the content of free aromatic dicarboxylic acid monoglycol ester is 50 ppm or lower, and the content of free aromatic dicarboxylic acid diglycol ester is 100 ppm or lower.

3. The polyester resin according to claim 1 or 2, wherein the content of aldehydes is 150 ppm or lower.

4. The polyester resin according to any one of claims 1 and 2, providing a molded article of a thickness of 4 mm with haze of 40% or lower by injection molding at 290° C.

5. The polyester resin according to any one of claims 1 and 2, wherein the phosphorus compound is at least one of compound selected from a group consisting of phosphoric acid-based compounds, phosphonic-based compounds, phosphinic acid-based compounds, phosphorous acid-based compounds, phosphonous acid-based compounds, phosphinous acid-based compounds.

6. The polyester resin according to any one of claims 1 and 2, wherein 85 to 100% by mole of the aromatic dicarboxylic acid component is terephthalic acid.

7. The polyester resin according to any one of claims 1 and 2, wherein 20 to 100% by mole of the aromatic dicarboxylic acid component is naphthalene dicarboxylic acid.

8. The polyester resin according to any one of claims 1 and 2, wherein the contents of copolymerized dialkylene glycol and trialkylene glycol are 10% by mole or lower and 2% by mole or lower, respectively, relative to the composing glycol component.

9. The polyester resin according to any one of claims 1 and 2, wherein the content of water is 500 to 10000 ppm.

10. The polyester resin according to any one of claims 1 and 2, wherein the polycondensation catalyst is at least one compound selected from a group consisting of antimony compounds and germanium compounds.

11. A polyester resin composition containing, as main components, the polyester resin (1) as described in any one of claims 1 and 2 and a polyester resin (2) mainly consisting of an aromatic dicarboxylic acid component and a glycol component, wherein in the case the content of a cyclic ester oligomer of a molded article obtained by injection molding of the composition is defined as Aₜ ppm and the content of a cyclic ester oligomer of the polyester resin composition before the injection molding is defined as A₀ ppm, Aₜ−A₀ is less than 500 ppm.

12. A polyester resin composition containing, as main components, the polyester resin (1) as described in any one of claims 1 and 2 and a polyester resin (2) mainly consisting of an aromatic dicarboxylic acid component and an ethylene glycol component, wherein in the case the content of a cyclic trimer of a molded article obtained by injection molding of the composition is defined as Aₜ ppm and the content of a cyclic trimer of the polyester resin composition before the injection molding is defined as A₀ ppm, Aₜ−A₀ is less than 500 ppm.

13. A polyester resin composition containing, as main components, the polyester resin (1) as described in any one of claims 1 and 2 and a polyester resin (2) mainly consisting of an aromatic dicarboxylic acid component and an ethylene glycol component, wherein in the case the content of acetaldehyde of a molded article obtained by injection molding of the composition is defined as Bₜ ppm and the content of acetaldehyde of the polyester resin composition before the injection molding is defined as B₀ ppm, Bₜ−B₀ is 1 to 30 ppm.

14. A polyester resin composition containing, as main components,
the polyester resin (1) as described in any one of claims 1 and 2, wherein the polycondensation catalyst is at least one compound selected from the group consisting of antimony compounds and germanium compounds; and
a polyester resin (2) mainly consisting of an aromatic dicarboxylic acid component and a glycol component and further containing a compound containing at least one element selected from a group consisting of Al element, Ti element, Mn element, Co element, Zn element, Sn element, and Pb element, and if necessary, an antimony compound and/or a germanium compound, wherein in the case the content of a cyclic ester oligomer of a molded article obtained by injection molding of the composition is defined as Aₜ ppm and the content of a cyclic ester oligomer of the polyester resin composition before the injection molding is defined as A₀ ppm, Aₜ−A₀ is less than 500 ppm.

15. The polyester resin composition according to claim 11, providing a molded article of a thickness of 5 mm-thick with haze of 30% or lower by injection molding.

16. A polyester resin composition containing, as main components, a polyester resin (1) mainly consisting of an aromatic dicarboxylic acid component and a glycol component and copolymerized or mixed with a phosphorus compound in an amount of 100 to 5000 ppm in terms of phosphorus element and a polyester resin (2) mainly consisting of an aromatic dicarboxylic acid component and an ethylene glycol component, wherein in the case the content of cyclic trimer of a molded article obtained by injection molding of the composition is defined as Aₜ ppm and the content of cyclic trimer of the polyester resin composition before the injection molding is defined as A₀ ppm, Aₜ−A₀ is less than 500 ppm.

17. A polyester resin composition containing, as main components, a polyester resin (1) mainly consisting of an aromatic dicarboxylic acid component and a glycol component and copolymerized or mixed with a phosphorus compound in an amount of 100 to 5000 ppm in terms of phosphorus element and a polyester resin (2) mainly consisting of an aromatic dicarboxylic acid component and an ethylene glycol component, wherein in the case the content of acetaldehyde of a molded article obtained by injection molding of the composition is defined as Bₜ ppm and the content of acetaldehyde of the polyester resin composition before the injection molding is defined as B₀ ppm, Bₜ−B₀ is 1 to 30 ppm.

18. A polyester resin composition containing, as main components, a polyester resin (1) mainly consisting of an aromatic dicarboxylic acid component and a glycol component, copolymerized or mixed with a phosphorus compound in an amount of 100 to 5000 ppm in terms of phosphorus element, and containing, as a polycondensation catalyst, at least one compound of Sb metal compounds and Ge metal compounds, and a polyester resin (2) mainly consisting of an aromatic dicarboxylic acid component and an ethylene glycol component and containing, as a polycondensation catalyst, at least one compound of Ti metal compounds and Al metal compounds.

19. A polyester molded article obtained by melt-molding the polyester resin composition as described in claim 11.

20. The polyester molded article, wherein the polyester molded article according to claim 19 is one of a hollow molded article, a sheet-like substance, or a stretched film obtained by stretching the sheet-like substance in at least one direction.

21. A coated substance obtained by melt-molding the polyester resin composition as described in claim 11 on a substrate.

22. A method for producing a polyester molded article by injection molding, compression molding, or extrusion molding of the polyester resin composition as described in claim 11.

23. A polyester resin composition containing, as main components,
the polyester resin (1) as described in any one of claims 1 and 2, wherein the polycondensation catalyst is at least one compound selected from the group consisting of antimony compounds and germanium compounds; and
a polyester resin (2) mainly consisting of an aromatic dicarboxylic acid component and an ethylene glycol component and further containing a compound containing at least one element selected from a group consisting of Al element, Ti element, Mn element, Co element, Zn element, Sn element, and Pb element, and if necessary, an antimony compound and/or a germanium compound, wherein in the case the content of a cyclic trimer of a molded article obtained by injection molding of the composition is defined as Aₜ ppm and the content of a cyclic trimer of the polyester resin composition before the injection molding is defined as A₀ ppm, Aₜ−A₀ is less than 500 ppm.

24. A polyester resin composition containing, as main components,
the polyester resin (1) as described in any one of claims 1 and 2, wherein the polycondensation catalyst is at least one compound selected from the group consisting of antimony compounds and germanium compounds; and
a polyester resin (2) mainly consisting of an aromatic dicarboxylic acid component and an ethylene glycol component and further containing a compound containing at least one element selected from a group consisting of Al element, Ti element, Mn element, Co element, Zn element, Sn element, and Pb element, and if necessary, an antimony compound and/or a germanium compound, wherein in the case the content of acetaldehyde of a molded article obtained by injection molding of the composition is defined as Bₜ ppm and the content of acetaldehyde of the polyester resin composition before the injection molding is defined as B₀ ppm, Bₜ−B₀ is 1 to 30 ppm.
